(19) United States
(12) Patent Application Publication
(10) Pub. No.: US 2007/0046408 A1
(43) Pub. Date: Mar. 1, 2007

(54) Magnet-shunted systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 11/213,686

(22) Filed: Aug. 30, 2005

(51) Int. Cl. H01F 3/00

(52) U.S. Cl. 335/296

(57) ABSTRACT

The present invention relates to a magnet-shunted system for shielding a target from magnetic fields and waves. More particularly, the present invention relates to a magnet system including a path member and a magnet member having a magnet at least partially shielded by a magnetically permeable shunt member. The path member forms a path through which the extrinsic magnetic fields and waves bypass the target, the magnet member serves as a termination point for the magnetic fields or waves, and the shunt member defines another path through which primary magnetic fields generated by the magnet member are confined very close to the shunt and/or magnet members. The present invention relates to various methods of forming the termination point, eliminating the extrinsic magnetic fields or waves by the magnet, and disposing the magnet member into the path member. The present invention also relates to various processes for providing such a magnet-shunted system including the foregoing magnet and path members along with the optional shunt member.

The present application claims a benefit of an earlier filing date of a U.S. Provisional Application which is entitled “Shunted Magnet Systems and Methods,” filed on Jul. 20, 2005 by the Applicant, and bears a U.S. Ser. No. 60/700,381, which is to be referred to as the “co-pending Application” hereinafter and an entire portion of which is to be incorporated herein by reference.

### FIELD OF THE INVENTION

The present invention generally relates to magnet-shunted systems which may be capable of shielding a target from extrinsic and intrinsic magnetic fields (or MFs) and magnetic waves or radiation (or MWs). More particularly, the present invention relates to various magnet-shunted systems each of which may include at least one path member and at least one magnet member, where the latter may in turn include at least one permanent magnet or electromagnet at least a portion of which is enclosed or covered by at least one shunt member. Both of the path and shunt members may be typically made of or include highly magnetically permeable materials such that those members may define paths through which MFs and MWs of various extrinsic electromagnetic waves (or EM waves) may propagate while bypassing the target, that the magnet or electromagnet of the magnet member may serve as a sink or a termination point in which such MFs and MWs complete their propagation, and that the shunt member may define another path through which intrinsic MFs generated by the magnet or electromagnet of the magnet member may be contained close to the shunt and/or magnet members and also prevented from penetrating the shunt member to the target. The present invention relates to various magnet-shunted systems including at least one path and/or shunt members which may be permanently magnetized by the magnet or electromagnet of the magnet member, to various systems each of which may include at least one movable magnet, path or shunt member which may change its orientation with respect to the other members in various arrangements, to various systems which may be disposed inside or outside an electric device so as to prevent or at least minimize secondary MFs and MWs generated by such a device from propagating out of such a device, and to various systems which may utilize a permanent magnet or electromagnet of the device as the sink for the extrinsic or secondary MFs and MWs.

The present invention also relates to various methods for forming at least one termination point or sink for the MFs and MWs of the extrinsic EM waves along (or on) the magnetically permeable path member, various methods for eliminating such MFs and MWs by at least one permanent magnet and/or electromagnet while containing intrinsic MFs generated by such a magnet and/or electromagnet close thereto, various methods for confining such intrinsic MFs close to the magnet and/or shunt members, various methods for incorporating the shunt member around the magnet member, various methods for magnetically coupling the magnet and/or electromagnet to the shunt and/or path members, and the like. The present invention also relates to various methods for permanently magnetizing at least a portion of the path and/or shunt members in order to attract more extrinsic and/or secondary MFs and MWs than otherwise, various methods for changing orientation of at least one of such members with respect to others, various methods for coupling preset portions of the path and/or shunt members with different poles of the above magnet and/or electromagnet, various methods for preventing or at least minimizing permanent magnetization of preset portions of such path and/or shunt members, various methods for preventing or at least minimizing saturation of such path and/or shunt members, various methods for preventing the secondary MFs and MWs generated by such an electric device from propagating away therefrom, and various methods for utilizing the magnet or electromagnet of the preexisting device for eliminating the extrinsic and/or secondary MFs and MWs.

The present invention further relates to various processes for fabricating the magnet member which may have at least one permanent magnet and/or electromagnet at least a portion of which may be covered and/or enclosed by at least one magnetically permeable shunt member, various processes for providing the magnet member shunted by the shunt member and capable of defining therearound intrinsic MFs of a preset strength on an exterior surface of the shunt member, various processes for magnetically coupling the magnet member to the path and/or shunt members, and various processes for providing the magnet-shunted system capable of eliminating the extrinsic MFs and MWs as well as confining the intrinsic MFs within a preset distance from its magnet and/or shunt members.

The present invention further relates to various processes for fabricating the magnet-shunted system including at least one movable magnet, path or shunt member, various processes for providing a movable magnet, path, and/or shunt members and coupling preset portions of the path and/or shunt members with different poles of the magnet member alternatingly, various processes for providing the path member of which different segments may magnetically couple with different poles of the magnet member, various processes for fabricating the path and/or shunt members at least portions of which may be permanently magnetized and more efficiently attract such extrinsic and/or secondary MFs and MWs, various processes for providing such path and/or shunt members which may be constructed to minimize saturation thereof, various processes for providing the magnet-shunted systems which may be incorporated inside and/or outside the electric device and prevent such secondary MFs and MWs from escaping the device, and various processes for providing the magnet-shunted systems which may utilize the magnet or electromagnet of the device as the termination point or sink for the extrinsic and/or secondary MFs and MWs.

### BACKGROUND OF THE INVENTION

Ever since the invention of electricity, humans have been using numerous electric equipment in their daily lives. From various home appliances to high-voltage power lines for supplying electricity to individual homes, almost all electrical devices depending upon electricity emit electromagnetic waves or radiation (to be abbreviated as the “EW waves” hereinafter) of various frequencies.

With the advent of wireless communication technologies, the globe is getting filled with various EM waves such as, e.g., radio waves with frequencies ranging from about 5×10² Hz to about 10⁸ Hz (to be referred to as the “radio frequency range” or “RF range” hereinafter, where the RF stands for the radio frequency), microwaves with frequencies ranging from about 10⁸ Hz to about 10¹² Hz (to be referred to as the “micro frequency range” hereinafter), and so on, where most AM radio waves and some TV waves fall within the RF range, while FM radio waves, other TV waves, and radar waves typically belong to the micro frequency range.

With the advent of semiconductor electric devices and mobile, cellular, wireless, GSM or PCS technologies, mobile, cellular, wireless, GSM or PCS communication phones (to be abbreviated as “cell phones” hereinafter) have been widely spread across the entire globe. Throughout the civilization as we know about, such cell phones are the only products sold to ordinary consumers which are placed against their heads intentionally while emitting thereto the EM waves of the micro frequency range. In addition to these microwaves, widespread use of wireless internet also fills air with microwaves with the similar frequency range. As a matter of fact, such cell phones and wireless internet terminals emit various EM waves as they “check in” with the base station every few minutes around the clock even when an user makes no call or contact in progress.

It has been well known that such EM waves may adversely affect humans, which finally leads many countries across the globe to legislate numerous regulations. The U.S. also followed the suit in 1996 to regulate microwave radiation exposure from the cell phones by FCC standards while citing recent studies indicating that some cell phones may exceed limits for Specific Absorption Rate (to be abbreviated as the “SAR” hereinafter) during peak output spikes. Some research claims to link such radio waves or microwaves with behavioral and/or cellular disturbances, while some people claim to actually sense differences in the levels of “mind noise” from the radio waves or microwaves.

Before one delves into wondering how much and which components of such EM waves may be harmful or hazardous to health, the nature of such EM waves and their characteristics should be clearly understood a priori. Only thereafter, one can consider a way to prevent or at least minimize such adverse effects of the EM waves on human health.

In the mid 19th century, James Maxwell learned that a magnetic field (to be abbreviated as a “MF” hereinafter) is produced in empty space if there is a changing electric field (to be abbreviated as an “EF” hereinafter). From this, Maxwell derived another conclusion that, if a changing MF produces an EF, that EF will itself be changing and will in turn produce a MF which itself will be changing and so will produce a changing EF, and so on. Accordingly, the net result is an EM wave which consists of a wave of EF (to be referred to as an electric wave and to be abbreviated as “EW” hereinafter) and a wave of MF (to be referred to as a magnetic wave and to be abbreviated as “MW” hereinafter). The EM waves are transverse waves; but because the EM waves are always the waves of fields, they can actually propagate (or travel) in empty space. The EFs and MFs of such EM waves are generally perpendicular to each other and to the direction of propagation at any point. In addition, the MFs and EFs of the EM waves alternate in direction and, accordingly, field strengths of the EFs and MFs vary from a maximum in one direction, to zero, to a minimum in the other direction. Moreover, the MFs and EFs of the EM waves are in phase, i.e., they are all zero at the same points and reach their maxima at the same points. Very far from a source of the EM waves, the EF field lines and MF field lines are all quite flat over a reasonably large region and, accordingly, such EM waves are typically referred to as plane waves.

As described above, the radio waves (in a frequency range from about 5×10² Hz to about 10⁸ Hz) and microwaves (in a frequency range from about 10⁸ Hz to 10¹² Hz) are a few examples of such EM waves. There are other waves in an electromagnetic spectrum of the EM waves (or EM radiation) such as, e.g., infrared waves (to be abbreviated as the “IR” waves hereinafter) in a frequency range from about 5×10¹⁰ Hz to about 4×10¹⁴ Hz, visible light waves or rays in a frequency range from about 4×10¹⁴ Hz to about 7.5×10¹⁴ Hz, ultraviolet waves (to be abbreviated as the “UV” waves hereinafter) in a frequency range from about 7.5×10¹⁴ Hz to about 10¹⁷ Hz, X-rays in a frequency range from about 7×10¹⁶ Hz to about 10¹⁹ Hz, gamma rays in a frequency range beyond 5×10¹⁶ Hz, and so on. Such EM waves also carry energy and it is well known that an energy density associated with the MF is equal to that associated with the EF, i.e., each field contributes one half to a total energy carried by such EM waves.

Numerous reports and raw data have been complied to assess adverse effects of EM waves on various functions of human bodies. For example, one book which is entitled, “Cell Phones: Invisible Hazards in the Wireless Age: An Insider's Alarming Discoveries about Cancer and Genetic Damage,” written by Dr. George Carlo and Martin Schram, and published by Carroll & Graf (ISBN 0-7867-0818-2), details alarming signs about dangers of such cell phones as they emerged, interference with heart pacemakers, deep penetration of developing skulls of children by the cell phone waves, deterioration of blood-brain barriers, and most importantly, creation of micronuclei (i.e., a type of genetic damages known to be a diagnostic marker for cancer) in human blood cells by such RF waves emitted from the cell phones. Another book which is entitled, “Warning: The Electricity around You may be Hazardous to Your Health,” 3rd ed. (original edition in 1992), written by Ellen Sugarman, and published by Simon & Schuster (ISBN 0-9661-1942-8), explains controversies revolving around EM fields, how to perform a survey on the EM fields, what the studies prove, managing the EM fields at work, and current litigation involving EM fields. Another book which is entitled, “Cellular Telephone Russian Roulette,” written by Robert Kane, and published by Vantage Press (ISBN 0-5331-3673-3) claims that, despite industry's safety assurances, there was much more information available indicating safety concerns than the industry has ever acknowledged. The author, a former top Motorola engineer, convincingly reviews foundations of RF radiation research, discoveries of “hot spots” in the brains of the cell phone users and biological hazards due to RF exposure by the 1970's, industry's influences on “safety exposure guidelines” so as to meet its own product needs, various ways research design may be manipulated in order to bias outcomes of lab studies, the “red-herring” requirement by the industry that research should identify a single “biological causation mechanism” to scientifically prove adverse health effects from the RF exposure, and so on.

Long before the controversy surrounding the adverse effects of the EM waves on the health, the electronic industry had already started on its own to protect its products against the EFs and EWs since the early 70's. More specifically, the industry had incorporated numerous technologies into their products in order to prevent electromagnetic interference from extrinsic EFs and EWs. For example, various shields made of electrically conductive substances have been used to cover delicate electric circuit and to absorb and/or reflect the EFs and EWs propagated thereto. These shielding techniques against the EFs and EWs have now evolved into conductive fabrics and cloths which claim to protect wearers from the EFs and EWs of specific frequency ranges, where details of these fabrics, cloths, and other accessories are available from Less EMF Inc. (or its web site at www.lessemf.com).

Contrary to rapid advances in those against the EFs and EWs, shielding technologies against the MFs and MWs have not yet been flourished, probably because of the very fact that the Earth itself generates its own MFs and humans have evolved with or lived under the MFs for thousands of years. Accordingly, there is a tendency to believe that the extrinsic MFs and MWs of the EM waves may not pose any health hazards at all. A more important reason, however, may be that, although there exist so many analogies between electricity and magnetism, there really is not an equivalent of the electric insulator in magnetism. That is, although there are so many different electric insulators for electricity, there is no such thing as magnetic insulator. Although positive and negative electric charges are very similar to the North and South poles, one major distinction between the electricity and magnetism may be that the positive or negative electric charges are easily isolated, while isolation of a single magnetic pole seems impossible. One of the Maxwell's equations recites that:
Del B=0
where B represent the MF in telsa (T, 1 T=1 N/amp/meter=1 Weber/m²) or in gauss (G, 1 G=10⁻⁴ T). This equation simply indicates that there are no magnetic monopoles and, accordingly, each and every magnetic field line must terminate on an opposite pole, e.g., the S pole. Because of this, it is impossible to isolate or stop the MFs and MWs. Nature must find a way to return such MFs and MWs back to the opposite pole. However, the MFs and MWs can be rerouted around a target which is to be protected through magnetic shielding or shunting, e.g., by enclosing the target with a material which has a very high magnetic permeability. Such a permeable material allows a lot of MF lines to pass therethrough, effectively concentrates or contains more MF lines therein than the target, and prevents the MF lines from penetrating outside the material, thereby channeling such MF lines away from the target. Many materials and/or alloys have been developed for rerouting the MFs or MWs, where examples of such materials may include, but not be limited to, iron, nickel, and stainless steel each of which has relative magnetic permeability of about 100, various nickel/iron based alloys, various cobalt based alloys, and the like. These alloys are commercially available in the trademark names of Mumetal Alloys™, Co-Netic Alloys™, and Netic Alloys™ provided by Magnetic Shield Corporation (Bensenville, Ill.), and other alloys such as Hipernom™, HyMu-80™, Permalloy™, and the like, and exhibit the relative magnetic permeability ranging from about several thousands to a million. These substances are commercially manufactured in various configurations and sold as MF- and MW-shielding garments, films, sheets, plates, adhesive tapes, and so on. It is to be understood that, since there is no one-to-one correspondence between electric conductivity and magnetic permeability, many electrically conductive substances may turn out to have poor magnetic permeability. For example, excellent electric conductors such as gold, platinum, silver, copper, aluminum, tin, and lead all have poor relative magnetic permeability of about 1.0, which implies that these electric conductors are merely as less effective in rerouting or shunting the MFs and MWs as air which has the relative magnetic permeability of 1.0 by definition.

While there are official standards for exposure to EM waves, they are based upon an amount of the EM waves needed to cause an immediate harm. And there seems to be a plenty of evidence to show that biological effects may occur at levels well below such standard limits. More importantly, it must be clearly understood that these standards were mainly formulated to regulate the EFs and EWs, while no guidelines have been put in effect to regulate the MFs and MWs. And it is worth while herein to revisit one of the physics fundamentals that an energy density associated with such MFs and MWs of the EM waves is equal to that associated with the EFs and EWs so that each field contributes one half to a total energy carried by the EM waves. In other words, without reasonable channeling of the MFs and MWs of the EM waves, successful insulation against the EFs and EWs of the EM waves only removes at most one half of the potentially hazardous energy carried by the EM waves.

As described hereinabove, possible adverse effects and biohazards of the MFs and MWs on health have been ignored by many with the perception that the MFs may be at worst benign, because we have evolved with and/or lived in the magnetic field generated by the Earth for tens of thousands of years and because strengths of the MFs and MWs of the EM waves may be less or at most on the same order of magnitude as a strength of the Earth's magnetic field which is about 0.5 G or 500 mG.

It is to be understood, however, that such perceptions are totally off the point and very likely to prove wrong, because the Earth's natural magnetic field is static but the MFs and MWs of the extrinsic EM waves are dynamic or oscillating. One cannot overemphasize the Maxwell's theory and it is worth while to revisit that changing MFs and MWs are to induce changing EFs and oscillating electric current in any conductor. Accordingly, the static MF of the Earth is neither dynamic nor oscillating and will not cause any induction when such static MF penetrates through the human body. However, as any MFs and MWs from the EM waves penetrate into a human body, they will induce oscillating electric current along any conductive organs, cells, microcellular structures, and/or genes inside the body, where it is very reasonable and logical to conclude that almost any of such organs, cells, structures, and genes are electric conductors for water constitutes a vast majority of such. Therefore, the MFs and MWs of the extrinsic oscillating EM waves are deemed to definitely induce electric current foreign to the body. Although the extrinsic MFs and MWs may be less than the Earth's static MF itself, the electric current induced by the extrinsic MFs and MWs inside one's body may be comparable or of greater amplitudes than a variety of physiologic electrical signals necessary for ordinary bodily functions. Such induced current may travel through a nervous system of a person and supply false signals to various organs of his or her body such as a brain, a spinal cord, and other nerves. Such induced current may disrupt electrical charge balances of various body fluids, ion channels, and receptors operating at least partly based on electrical signals. In addition, the induced current may also degrade or disrupt normal coding and decoding sequences and/or processes of gene transcriptions, leading to various gene disorders. Therefore, it is proposed in the present invention that the MFs and MWs of the extrinsic oscillating EM waves jeopardize, degrade, deteriorate, and/or mutate various organs, cells, microcellular structures, and/or genes of a normal person primarily through inducing the electric currents in those organs, cells, structures, and/or genes and secondarily through placing the organs, cells, structures, and/or genes under foreign magnetic fields. When considering that normal electrical signals running through nerves are in the range of 1 to 5 mA and other electrical signals of ion channels are a lot less than this range, it is very plausible that the induced currents may be of at least enough amplitude to intervene, disrupt or even destroy physiological electrical signal delivery and reception systems of the human body.

Various articles are circulated in commerce to protect a person from the hazardous EFs, EWs, MFs, and MWs and FIGS. 1A through 1C show schematic view of prior art configurations for shielding EM waves by electric conductors and/or magnetically permeable materials. For example, FIG. 1A is a schematic view of a prior art electric conductor to shield EFs and EWs. As described hereinabove, a typical EM wave consists of an electric wave 1E (or “EW” which is an alternating or oscillating electric field or “EF”) and an alternating magnetic wave 1M (or “MW” which is also an alternating or oscillating magnetic field or “MF”) propagating through space at right angles. When an electric conductor 2C is placed perpendicular to a direction of the EW waves, the EFs and EWs of such waves are absorbed by the conductor 2C, while inducing an electric current therein. Assuming that the conductor 2C may not have a high magnetic permeability such as, e.g., gold, silver, platinum, and copper, almost all of the MFs and MWs penetrate right through the conductor 2C. Although such an electric conductor 2C may absorb at most one half of a total energy of such EM waves, it is frequently said to shield a target (not shown in the figure) from the EM waves. In another example, FIG. 1B shows a schematic view of a prior art magnetically permeable shunt to shield MFs and MWs. When a permeable shunt 2S is placed perpendicular to a direction of the EW waves, the MFs and MWs of such waves are absorbed by the shunt 2S, while channeling the MF lines preferentially in a preset direction. Assuming that the shunt 2S may not have a high electric conductivity, almost all of the EFs and EWs may penetrate through the permeable shunt 2S. Therefore, the shunt 2C may reroute at most one half of the total energy of such EM waves and shield a target (not shown in the figure) only at an efficiency not exceeding 50%. In another example, FIG. 1C shows a schematic view of a prior art assembly with an electric conductor and a magnetically permeable shunt to shield EFs, EWs, MFs, and MWs. As described in the foregoing figures, an electric conductor 2C and a magnetically permeable shunt 2S are placed perpendicular to a direction of the EW waves, the EFs and EWs of the EM waves may be absorbed by the conductor 2C, while the MFs and MWs may penetrate the conductor 2C but are rerouted by the shunt 2S. Therefore, this assembly may theoretically be able to shield a target (not shown in the figure) better than those of FIGS. 1A and 1B.

Based on such illustrations as exemplified in FIGS. 1A to 1C, various prior art shielding devices tend to claim that they may protect a target from the EM waves, although such devices may marginally be effective in eliminating only portions of the EFs and EWs of such EM waves. Even if those prior art devices may use a theoretically perfect (and, therefore, practically impossible) electric conductor and a theoretically perfect (practically impossible as well) magnetically permeable shunts, there still are at least a few inherent pitfalls in those prior art approaches.

First of all, most prior art devices for shielding against the EFs and EWs of such EM waves are provided with ground cords or connectors while recommending an user to ground such a conductor. Because the EFs and EWs of such EW waves are dynamic and oscillatory in their nature, they tend to charge the conductor with opposite polarities during their ascending and descending cycles. As the conductor is grounded, electric currents will be induced along the conductor. Because such EFs and EWs alternate in opposite directions, it follows that any electric currents induced in the conductor will be dynamic and oscillatory as well. According to the Maxwell's principle, such alternating current will again generate a next generation of EM waves which will then propagate in every direction including one toward a target. Without such grounding, however, the EFs and EWs of the EM waves may tend to charge the conductor with opposite polarities during their ascending and descending cycles, where such charges may cancel each other in the long run.

Compared with such a pitfall as to the prior art EF and EW shielding devices, the inherent pitfall regarding the prior art MF and MW shielding devices is a little more complicated and, accordingly, best explained in reference to FIGS. 2A to 2C which show schematic views of a magnetic field generated near a conventional bar magnet and prior art configurations of shunting such magnetic field. FIG. 2A is a top view of magnetic field lines formed by a conventional bar magnet. As depicted in the figure, a MF generated by a permanent magnet 3M is conventionally shown by multiple MF lines 3ML which are drawn such that a direction of the MF is tangent to a MF line 3ML at any point therealong. According to this convention, a number of such MF lines 3ML per unit area becomes proportional to a strength of the MF generated by the magnet 3M. The figure indicates that the MF is generally concentrated close to the North pole (to be abbreviated as the “N” pole or simply “N” hereinafter) of the magnet 3M and to its South pole (to be abbreviated as the “S” pole or simply “S” hereinafter) and that the strength of the MF decreases in proportion to a distance from such a magnet 3M. Each MF line 3ML is conventionally defined to emanate from the N pole and to terminate at the S pole. FIG. 2B is a cross-sectional view of the magnet of FIG. 2A which is completely enclosed by a magnetically permeable shunt, where such a shunt 2S has a shape of a hollow cube and where the magnet 3M is disposed parallel to side edges of the shunt 2S. Because the shunt 2S is made of or include highly magnetically permeable materials, most or all of such MF lines 3ML emanating from the N pole hit a top edge of the shunt 2S, are rerouted therealong through each of side edges of the shunt 2S, and then return to the S pole through a bottom edge of the shunt 2S. The shunt 2S may also reroute the MF lines 3ML therein so that such lines 3ML may travel inside the shunt 2S but closer thereto than otherwise. Depending upon the strength of the MF of the magnet 3M and/or magnetic permeability of the shunt 2S, a small portion of the MF lines may penetrate the shunt 2S and travel outside of and around the shunt 2S. Such a leakage, however, may also be controlled by various means such as, e.g., using a weaker magnet, employing a thicker shunt, fortifying specific portions of the shunt facing or disposed close to such poles of the magnet 3M, and the like. In summary, the magnetically permeable shunt 2S neither eliminates nor destroys the MFs and MWs. Rather, such a shunt 2S provides an easy path for the MFs and MWs to complete their paths to the opposite magnetic pole, thereby serving as, e.g., a conductor for the MFs and MWs. Accordingly, the MF lines of the MFs and MWs tend to travel through the shunt 2S, while the shunt 2S reduces, not eliminates, what passes through a target to be protected from the MFs and MWs of the EM waves.

Although the example shown in FIG. 2B appears to be a near perfect solution to shield various targets from the MFs and MWs, it may probably not be applicable to protect a person from the MFs and MWs, unless such a person is to be encircled by and imprisoned inside the shunt indefinitely. Thus, a more realistic approach for shielding a person from the MFs and MWs will be to encircle or to cover as much as but not an entire portion of a person by a magnetically permeable shunt as exemplified in FIG. 2C which is a cross-sectional view of a magnetically permeable shunt of a prior art disposed around a target. In general, a magnetically permeable shunt 2S is shaped and sized to enclose at least three sides of a target 4A and to cover the target 4A against the MFs and MWs 1M of the EM waves, where the EFs and EWs 1E which may penetrate the shunt 2S depending on its electric conductivity are not included in the figure for simplicity of illustration. As the MFs and MWs of the EM waves propagates, they hit the shunt 2S and change their routes along such a shunt 2S. Once the MFs and MWs of the EM waves are concentrated inside the shunt 2S, their MF lines will somehow find a way to terminate at the S pole, for such MF lines accumulated inside the shunt 2S cannot form a magnetic monopole. In one example, the accumulated MF lines will propagate parallel to the surface of the Earth toward its S pole. However, the direction of such propagation may be through the target 4A or another target 4B placed adjacent to the shunt 2S. In another example, the target 4A may possess or carry an electric device generating a MF of which the strength may be on the same order of or slightly less than that of the Earth. In such a case, all the accumulated MF lines will propagate to the target 4A and terminate at the device he or she is carrying. More particularly, when the shunt 2S is larger than a cross-sectional area of the target 4A, 4B, the MF lines penetrating the target 4A, 4B partially enclosed by or disposed adjacent to the shunt 2S may be more than those the target 4A, 4B would have received without such a shunt 2S in either example. Therefore, such magnetically permeable conventional shunts alone may not be able to protect the target at all.

Similar to the EFs and EWs, the MFs and MWs of the EM waves are dynamic and oscillating in opposite directions. Therefore, the MFs and MWs during the ascending and descending cycles of the EM waves are attracted into the shunt 2S and accumulated inside the shunt 2S while being converted into the MF lines running in opposite directions along the shunt 2S. It is appreciated, however, that the opposite MF lines may not and can not cancel each other, for there is no magnetic monopole. In other words, the MF lines running in one direction along the shunt 2S will find their way to the opposite pole before the next MF lines running in an opposite direction may begin to accumulate inside the shunt 2S. In addition, being the EM waves, the MFs and MWs will travel at the speed of light, i.e., 3×10⁸ m/s, and will find their way to the opposite pole long before the MFs and MWs of the EM waves change their direction. It is again manifest that all conventional devices and methods for shielding or shunting the target from the MFs and MWs of the EM waves are ineffective or at best only marginally effective.

Other approaches have already been taken to protect not a human user but an electric circuit from spurious noises which are caused by the MFs and MWS of such EM waves. For example, U.S. Pat. No. 6,450,811 B2 issued to A. Hosoe et al. discloses composition and manufacturing methods for soft magnetic alloys of trivalent titanium and other metals, U.S. Pat. No. 6,850,182 B2 to A. Hosoe et al. describes composition of a soft magnetic material powder and a binder such as rubber or polymers, while U.S. Pat. No. 6,914,183 B2 to S. Inazawa et al. discusses multilayered boards for absorbing EM waves by including fine magnetic particles having an average diameter ranging from 1 to 150 nm and electrically insulated from each other by electric insulators such as polymers. This approach is based upon a property of magnet such as “magnetic loss,” i.e., converting such extrinsic MFs and MWs into induced electric currents which may encircle surfaces of the magnet, may be converted into heat and then dissipated. During these processes, the magnet loses a portion of its magnetic property due to another MF generated by the induced currents, heat, and the like. Although this approach may absorb the MFs and MWs propagating toward the magnet, it suffers from the fact that an entire portion of the target may have to be enclosed and that the magnet gradually loses its magnetic property and sooner or later becomes obsolete. Therefore, dissipation of the MFs and MWs through the magnetic loss may not be an optimum solution to the problem. In another example, Faraday's law of induction is utilized to ward off the MFs and MWs. For example, a thin, conductive shield defining low magnetic permeability may be placed in front of the target. As the extrinsic EM waves propagate to the shield and exert its MFs onto different portions of such a shield, electric currents such as Eddy currents may be induced inside the shield and generate another MF propagating along a direction to oppose the extrinsic MFs of such EM waves. The Eddy currents may be effective in opposing a motion of charged articles in the steady MFs. Because the extrinsic EM waves are typically oscillatory, however, the Eddy currents generate another alternating MF which are to oppose the MFs of the EM waves. However, because the induced currents are out of phase with the extrinsic MFs and MWs by 90°, the Eddy currents may not necessarily cancel the extrinsic MFs and MWs. As a matter of fact, the alternating MF generated by the Eddy currents inside the shield may be superposed to the extrinsic MFs and MWs only to define greater peaks and valleys.

In one perspective, humans are said to have been created with the static MFs of the Earth. In another perspective, humans seem to have been evolving with and/or adapted to the static MFs of the Earth. Whichever may turn out to be true, humans have been living with the static MFs of the Earth for more than at least tens of thousands of years. Accordingly, it is logical to assume that human bodies are immune to the static MFs of the Earth or that such static MFs are more likely than not benign to the human bodies. In another extreme, human bodies may be actually nourished by the static MFs of the Earth, which may then be followed that humans may not function without such static MFs. What we know now for sure is that science has not given us the answer regarding effects of the static MFs of the Earth on our bodily function. We do not know about the effects of other static MFs which may be stronger than the MFs of the Earth. We are enough ignorant not to know whether it would be safe to work in a laboratory running plasma reactors or operating superconducting facility which are known to generate the greatest MFs humans have ever generated.

Anyway, the human bodies which had been tuned to the Earth's static MFs have begun to be exposed to other MFs and MWs of the extrinsic EM waves. Such an exposure has begun less than a hundred years ago and has grown now to a rampant stage such that humans are radiated by the EM waves of various frequency ranges. We know that EFs and EWs of the EM waves of high intensity cause immediate injury to the body. We also presume that extended exposure to and/or accumulation of the EFs and EWs of low intensity would be harmful and that not only the intensity but also the range of frequencies of such waves is another important factor in assessing potential health hazard. Such adverse effects have long been corroborated in delicate electric devices and many devices are now equipped with various means to prevent or at least minimize interference from such EFs and EWs of the EM waves. However, we have not done much for the MFs and MWs of such EM waves, although the MFs and MWs of the EM waves carry one half of the total energy thereof.

Therefore, there is an urgent need for systems capable of and methods for accumulating and eliminating the MFs and MWs of the EM waves before such accumulated MFs and MWs may escape therefrom in undesirable directions. There also exists a need for systems capable of and methods for accumulating the MFs and MWs of the EM waves inside magnetically permeable paths and shunts and providing a sink for the accumulated MFs and MWs. There also is a need for systems capable of and methods for controlling strengths of MFs generated by such a sink below a preset level. There also is a need for systems capable of and methods for attracting and accumulating MFs and MWs at a higher efficiency per unit mass or volume of the paths and/or shunts, while helping or preventing permanent magnetization of at least portions of such paths and/or shunts. There further is a need for systems capable of being incorporated into and methods for incorporating such systems into electrical devices for preventing or at least minimizing the secondary MFs and MWs from propagating out of the devices and/or for utilizing the permanent magnet or electromagnet of such devices as the magnet member of such systems.

### SUMMARY OF THE INVENTION

The present invention generally relates to magnet-shunted systems which may be capable of shielding a target from extrinsic and intrinsic magnetic fields (or MFs) and magnetic waves or radiation (or MWs). More particularly, the present invention relates to various magnet-shunted systems each of which may include at least one path member and at least one magnet member, where the latter may in turn include at least one permanent magnet or electromagnet at least a portion of which is enclosed or covered by at least one shunt member. Both of the path and shunt members may be typically made of or include highly magnetically permeable materials such that those members may define paths through which MFs and MWs of various extrinsic electromagnetic waves (or EM waves) may propagate while bypassing the target, that the magnet or electromagnet of the magnet member may serve as a sink or a termination point in which such MFs and MWs complete their propagation, and that the shunt member may define another path through which intrinsic MFs generated by the magnet or electromagnet of the magnet member may be contained very close to the shunt and/or magnet members and also prevented from penetrating the shunt member toward the target. Therefore, the magnet-shunted systems of this invention may direct the extrinsic MFs and MWs through the path member toward the magnet member and eliminate the extrinsic MFs and MWs by the magnet or electromagnet of the magnet member, while containing at least a substantial portion of such intrinsic MFs within a preset distance from the shunt member, thereby effectively protecting the target from the extrinsic as well as intrinsic MFs and MWs. The present invention also relates to various magnet-shunted systems having at least one path and/or shunt members which may be permanently magnetized by the magnet or electromagnet of the magnet member. These arrangements may allow the path and/or shunt members to attract and contain more extrinsic and/or intrinsic MFs and MWs per unit area, mass or volume of such members. The present invention also relates to various magnet-shunted systems each including at least one movable magnet, path or shunt member which may change its orientation with respect to the other members in various arrangements. These movable arrangements may prevent or at least minimize the path and/or shunt members from being permanently magnetized and/or saturated. The present invention also relates to various magnet-shunted systems which may be disposed inside or outside an electric device so as to prevent or at least minimize secondary MFs and MWs generated by the device from propagating out of such a device. The present invention also relates to various magnet-shunted systems which may be arranged to utilize a permanent magnet or electromagnet of an electric device as their magnet member and to eliminate the extrinsic and/or secondary MFs and MWs using such a magnet or electromagnet.

The present invention also relates to various methods for forming at least one termination point or sink for the MFs and MWs of the extrinsic EM waves along (or on) the magnetically permeable path member, various methods for eliminating such MFs and MWs by at least one permanent magnet and/or electromagnet while containing intrinsic MFs generated by such a magnet and/or electromagnet close thereto, various methods for confining such intrinsic MFs close to the magnet and/or shunt members, various methods for incorporating the shunt member around the magnet member, various methods for magnetically coupling the magnet and/or electromagnet to the shunt and/or path members, and the like. The present invention also relates to various methods for permanently magnetizing at least a portion of the path and/or shunt members In order to attract more extrinsic and/or secondary MFs and MWs than otherwise, various methods for changing orientation of at least one of such members with respect to others, various methods for coupling preset portions of the path and/or shunt members with different poles of the above magnet and/or electromagnet, various methods for preventing or at least minimizing permanent magnetization of preset portions of such path and/or shunt members, various methods for preventing or at least minimizing saturation of such path and/or shunt members, various methods for preventing the secondary MFs and MWs generated by such an electric device from propagating away therefrom, and various methods for utilizing the magnet or electromagnet of the preexisting device for eliminating the extrinsic and/or secondary MFs and MWs.

The present invention further relates to various processes for fabricating the magnet member which may have at least one permanent magnet and/or electromagnet at least a portion of which may be covered and/or enclosed by at least one magnetically permeable shunt member, various processes for providing the magnet member shunted by the shunt member and capable of defining therearound intrinsic MFs of a preset strength on an exterior surface of the shunt member, various processes for magnetically coupling the magnet member to the path and/or shunt members, and various processes for providing the magnet-shunted system capable of eliminating the extrinsic MFs and MWs as well as confining the intrinsic MFs within a preset distance from its magnet and/or shunt members.

The present invention further relates to various processes for fabricating the magnet-shunted system including at least one movable magnet, path or shunt member, various processes for providing a movable magnet, path, and/or shunt members and coupling preset portions of the path and/or shunt members with different poles of the magnet member alternatingly, various processes for providing the path member of which different segments may magnetically couple with different poles of the magnet member, various processes for fabricating the path and/or shunt members at least portions of which may be permanently magnetized and more efficiently attract such extrinsic and/or secondary MFs and MWs, various processes for providing such path and/or shunt members which may be constructed to minimize saturation thereof, various processes for providing the magnet-shunted systems which may be incorporated inside and/or outside the electric device and prevent such secondary MFs and MWs from escaping the device, and various processes for providing the magnet-shunted systems which may utilize the magnet or electromagnet of the device as the termination point or sink for the extrinsic and/or secondary MFs and MWs.

Accordingly, one objective of the present invention is to include at least one permanent magnet and/or electromagnet in the magnet member along or at one end of the path member, thereby providing a termination point or sink for the extrinsic MFs and MWs of the EM waves and/or thereby preventing further propagation of the MFs and MWs accumulated in the path member along undesirable directions toward a target such as a person and an electric device to be protected therefrom. Another objective of this invention is to magnetically couple the path member with the magnet member and to temporarily magnetize at least a portion of the path member, thereby attracting and/or concentrating more MF lines of such MFs and MWs of the extrinsic EM waves inside the path member, increasing an efficiency of attracting or concentrating the MF lines per each path member, enhancing an efficiency of attracting or concentrating the MF lines per unit area of the path member, reducing a size and/or a volume of the path member per unit MFs and MWs concentrated therein, and/or preventing saturation of such a path member by removing or eliminating the accumulated MF lines of the extrinsic MFs and MWs away from the path member. Another objective of the present invention is to provide the magnet member capable of generating a new static MF having a strength similar or equal to that of the Earth, thereby replacing the static MF of the Earth by another static MF generated by the magnet member. Another objective of the present invention is to enclose at least a portion of any of the above magnet members with any of the above shunt members, thereby enabling such a system with the magnet and shunt members to be releasably and/or fixedly disposed inside, on or over an existing device and/or structure. Yet another objective of the present invention is to fabricate a magnet-shunted system which may include at least one of the above magnet, path, and/or shunt members.

In addition to these objectives, another objective of this invention is to attract and contain more MFs and MWs by permanently magnetizing at least a portion of the path and/or shunt members and/or incorporating at least one permanent magnet or electromagnet along the path and/or shunt members. Another objective of the present invention is to prevent permanent magnetization of the path and/or shunt members by coupling different portions of the path and/or shunt members with different poles of the magnet or electromagnet alternatingly. Another object of the present invention is to prevent or at least minimize propagation of the secondary MFs and MWs out of the electric devices by including the magnet, path, and/or shunt members inside or outside such devices. Yet another objective of this invention is to incorporate such systems into the devices while using the magnets or electromagnets of the devices as the magnet and/or path members of such systems.

The magnet-shunted systems of the present invention may be incorporated to protect a person or an user from various MFs and MWs of the extrinsic and/or secondary EM waves. For example, the magnet-shunted system may be incorporated into interior and/or exterior of various houses, buildings, and other structures to protect the person residing therein. Therefore, such a system may be fixedly or releasably retrofit over, below, into or between various parts of the existing houses, buildings, and structures, where typical examples of such parts may include, but not be limited to, exterior or interior walls, fillings between the walls, roofs, ceilings, partitions, doors, windows, floors, and so on. When desirable, the path member may instead be provided in the form of particles, powder, gel, sol, liquid or suspension of magnetically permeable materials into which small magnets may be mixed or into which the magnets of the similar form may be added. Mixtures of the permeable materials and magnets may then be applied onto various parts of the houses, buildings, and structures. The system may also be provided as carpets, mats, tiles, wall papers, stick-on papers, fabrics, curtains, and other articles of commerce which may be releasably or fixedly attached onto such parts of the houses, buildings, and structures. In another example, such a system may be incorporated into various raw materials and/or articles for such houses, buildings, and structures. Therefore, such a system or at least one member thereof may then be fixedly or releasably incorporated into such materials and/or articles examples of which may include, but not be limited to, bricks and/or mortars, tiles, glasses, woods, panels, plates or boards made of or including wood, plastics, metals or ceramics, pipes or tubings made of or including wood, plastics, metals or ceramics, and the like.

Still referring to the same purpose, the magnet-shunted systems of this invention may also be incorporated into various fabrics and/or garments to protect the person wearing clothing and/or other wearable articles made thereof. For example, such a system or at least one of its members may then be fabricated as or incorporated into a fiber, thread, and/or yarn. Accordingly, any article made of or including those fibers, threads or yarns may protect the wearer from various EM waves. In another example, such a system or at least one of its members may also be fabricated as or incorporated into a fabric and/or garment so that any clothings and other wearable articles made thereof may be able to accomplish protect a wearer from the extrinsic MFs and MWs, where examples of such clothings may include, but not be limited to, underware such as panties and braziers, innerware such as stockings, girdles, and undershirts, outerware such as various pants, shirts, skirts, and coats, and the like, while examples of the wearable articles may include, but not be limited to, various headware such as hats, caps, wigs, helmets, headbands, and nets, various eyeware such as glasses and goggles, various handware such as gloves and wristbands, various footware such as shoes, socks, and stockings, miscellaneous articles such as scarves, shawls, handkerchieves, belts, and ties, and other wearable articles which may be worn on, over or around a body of the wearer. When desirable, the clothings and articles may also be made of the fabric or garment which may include or may be woven from the above fibers, threads, and/or yarns. Depending upon applications described in this paragraph, such a system or at least one of its members may be fabricated to have a shape of a fiber, rod or wire, a net, mesh or screen, a sheet, foil or roll, a pad, a strip, and the like. Such a system or at least one member thereof may be incorporated into the cloths and/or articles during manufacturing processes thereof or may be releasably or fixedly retrofit into the existing cloths and/or articles.

The magnet-shunted systems of the present invention may also be incorporated into electric or optical devices not only to protect a person or user from various secondary MFs and MWs generated thereby but also to guard such devices from various MFs and MWs of the extrinsic MFs and MWs and to ensure their proper operation.

In one class of examples, such a system may be incorporated into various devices which may be designed to be used proximate to an user. Firstly, such a system may be incorporated into various heating devices examples of which may include, but not be limited to, electric blankets, electric heating pads, electric heater or stove, and so on. Secondly, such a system may be incorporated into various implantable devices example of which may include, but not be limited to, cardiac pacemakers, hearing aids and/or implants, drug delivery devices, sensors and monitors for monitoring various physiological signals or states of the user, and the like. Such a system may preferably be incorporated around the implantable devices in order to protect the devices as well as the wearer. Thirdly, such a system may be incorporated into various portable communication devices examples of which may include, but not be limited to, cellular phones, beepers, PDAs, palm- or hand-held devices, walkie-talkies, and the like. Fourthly, such a system may also be incorporated into various portable audiovisual devices examples of which may include, but not be limited to, walkmans, CD or MP3 players, DVD players, earphones, headphones, head sets, and so on. In addition, such a system may also be incorporated into various medical devices examples of which may include, but not be limited to, bedside medical equipment such as ventilators, drug and/or liquid delivery devices, sensors and monitors therefor, various diagnostic equipment, various imaging devices (e.g., X-rays, ultrasounds, NMRs, MRIs, PETs, and so on), various treatment devices, and the like. Such a system may also be incorporated into various beauty-related products examples of which may include, but not be limited to, hair-treatment devices (e.g., hair dryer, heater, and curler), body-treatment devices (e.g., massage tools, chairs, beds, and the like). Such a system may be incorporated into desktop and/or laptop computers, watches, and other miscellaneous devices which may be designed to be used proximate to various physiological parts of the user such as, e.g., heads, eyes, ears, hearts, spines, and the like.

In another class of examples, such a system may also be incorporated into various audio and visual devices, where examples of the audio devices may include, but not be limited to, radios, tape or CD players, turn tables, amplifiers therefor, equalizers therefor, speakers therefor, phones, handsets and bases of cordless phones, and the like, while examples of the visual devices may include, but not be limited to, TVs, VCR or DVD players, monitors (e.g., CRTs, LCDs, plasma display panels, overhead projectors, and the like). Such a system may also be incorporated into other electric or optical devices for audible signals and/or visual images and various remote controllers for these devices.

In another class of example, the system may be incorporated into various food-related devices examples of which may include, but not be limited to, various food storage devices (e.g., freezers and refrigerators), various food processing devices (e.g., food processors, blenders, grinders, choppers, juicers, mixers, and the like), various cooking devices (e.g., grills, ovens, ranges, burners, microwave ovens, toasters, toaster ovens, food steamers, and the like), various beverage devices (e.g., coffee makers, espresso makers, water boilers, and so on), and other electric devices to treat food or water such as can openers.

In other classes of examples, such systems may be incorporated into various electric heating and/or cooling devices, lighting and/or illumination devices, cleaning devices, and the like. Examples of the heating devices may include, but not be limited to, stationary or portable heaters and heat pumps, and where examples of the cooling devices may include, but not be limited to, wall-mount or portable air conditioners, ceiling or portable fans, and so on. Examples of the lighting devices may include, but not be limited to, lamps, stands, light fixtures, switches and/or controllers thereof, and incandescent or fluorescent bulbs therefor, while examples of the cleaning devices may include, but not be limited to, washers, dryers, dish washers, garbage disposals, garbage compactors, and vacuum cleaners. In addition, such systems may be incorporated into various office equipment such as, e.g., desktop or laptop computers, monitors, keyboards, tape or disk drivers, printers, and other peripheral devices, typewriters, photocopiers, scanners, slide or beam projectors, cash registers, intercoms, and the like. Such systems may also be incorporated into other household electric equipment such as, e.g., lawn mowers, edge trimmers, blowers, drills, saws, staple guns, glue guns, and the like.

Such magnet-shunted systems of the present invention may be incorporated into other electric or optical devices to protect the person or user from the secondary MFs and MWs generated thereby but also to guard such devices from the MFs and MWs of the extrinsic MFs and MWs while ensuring their proper operation.

For example, such systems may be incorporated into various laboratory devices such as, e.g., various qualitative and quantitative analyzers, sensors and monitors, controllers for regulating various intrinsic or extrinsic parameters or variables including temperature, pressure, voltages, currents, pHs, volumes, masses, flow rates, compositions or concentrations, brightness, magnetic fields, and so on.

Such systems may be incorporated into various manufacturing or factory equipment such as, e.g., industrial controllers or monitors, production equipment, conveyor lines, and the like. In addition, such systems may be incorporated into electricity generating and/or transmission equipment such as, e.g., generators, power transmission lines, and transformers, and also into communication equipment such as, e.g., signal processing stations, signal transmission towers, and the like.

Such systems may further be incorporated into various civilian or military vehicles examples of which may include, but not be limited to, land vehicles (e.g., automobiles, motorcycles, cranes, tanks, and the like), surface vessels (e.g., ships or boats), underwater vessels (e.g., submarines), aircrafts (e.g., airplanes or helicopters), spacecraft, satellites, and the like.

In addition to the aforementioned specific devices and equipment, the magnet-shunted systems of the present invention may also be incorporated into any articles of commerce which may generate the secondary MFs and MWs to protect the user therefrom, which may need to be protected from the extrinsic MFs and MWs, and the like. For example, such systems may be incorporated into any nano-scale devices, semiconductor chips, electric circuits, electrical panels, and electrical instruments each of which may include wire through which AC electric current flows and/or through which DC electric current flows with frequent temporal variations.

In one aspect of the present invention, a magnet-shunted system may be provided to reroute magnetic waves propagating toward a target away from such a target using at least one magnetically permeable material.

In one exemplary embodiment of this aspect of the invention, a system may include at least one magnet member and at least one path member. The magnet member may be arranged to have at least one permanent magnet defining at least one N pole and S pole thereon, where such a magnet member will be referred to as a “basic magnet member” hereinafter. The path member may be arranged to be magnetically permeable, to magnetically couple with the magnet member, to absorb the waves therein, and to reroute the waves to at least one of the poles of the magnet member in which the waves may be eliminated.

In another exemplary embodiment of this aspect of the present invention, a system may include at least one path member as well as at least one magnet member. The path member may be arranged to be magnetically permeable and to absorb and accumulate the magnetic waves therein. The magnet member may be arranged to have at least one permanent magnet with at least one N pole and at least one S pole thereon, to magnetically couple with the path member, and to transport the waves which may be accumulated inside the path member thereinto, thereby preventing (or at least minimizing) the path member from saturation.

In another exemplary embodiment of this aspect of the invention, a system may include at least one “basic” magnet member and at least one path member. The path member may be arranged to be magnetically permeable, to be magnetically coupled to the magnet member with at least one portion, to be temporarily magnetized by the magnet member, to generate a magnetic field around the portion for absorbing the waves not only directed toward the path member but also propagating away from such a path member but attracted to the path member by the magnetic field, and to reroute such absorbed waves to at least one of the poles of the magnet member in which such waves may be eliminated.

In another exemplary embodiment of this aspect of the invention, a system may include at least one “basic” magnet member and at least one path member. Such a path member may be arranged to have multiple segments at least two of which may be arranged to include the material, to magnetically couple with the magnet member, to be temporarily magnetized by the magnet member, and to generate magnetic fields propagating in different directions, whereby such at least two segments of the path member may be arranged to absorb the waves propagating in different directions and to reroute such waves to at least one of the poles of the magnet member in which such waves may be eliminated.

In another exemplary embodiment of this aspect of the invention, a system may include at least one “basic” magnet member and at least two path members. Such path members may be arranged to have the material, to magnetically couple with the magnet member, to be temporarily magnetized by the magnet member, and to generate magnetic fields propagating in different directions, whereby the path members may be arranged to absorb the waves propagating along different directions by at least one thereof, and then to reroute the waves to at least one of the poles of the magnet member in which the waves may be eliminated.

In another exemplary embodiment of this aspect of the invention, a system may include at least one “basic” magnet member and at least two path members. Such path members may be arranged to include the material, to magnetically couple with the magnet member, to be disposed for receiving the waves one at a time or sequentially, to be temporarily magnetized by the magnet member, and then to generate magnetic fields which propagate in different directions, whereby the path members may be arranged to absorb the waves propagating in different directions by the path members one at a time or sequentially, and to reroute the magnetic waves to at least one of the poles of the magnet member in which such waves may be eliminated.

In another aspect of the present invention, another magnet-shunted system may be provided for rerouting magnetic waves propagating toward a target away from such a target using at least one magnetically permeable material while preventing or at least minimizing permanent magnetization of the material.

In one exemplary embodiment of this aspect of the invention, a system may include at least one “basic” magnet member which is arranged to have at least one permanent magnet which defines at least one N pole and S pole thereon and at least one path member. The path member may be arranged to be magnetically permeable, to be magnetically coupled to the magnet member with at least a portion thereof, to be temporarily magnetized around the portion by one of the poles of the magnet member, to absorb the waves therein, and then to reroute the waves to one of the poles of the magnet member in which the waves may be eliminated. At least one of the magnet and path members may be arranged to move with respect to the other of the members manually by an user so that the portion of the path member may be arranged to be temporarily magnetized by the other of the poles, whereby the portion of the path member may be arranged to be prevented from being permanently magnetized into a single polarity of such one pole.

In another exemplary embodiment of this aspect of the invention, a system may include at least one “basic” magnet member, at least one path member, and at least one sensor. Such a path member may be arranged to be magnetically permeable, to be magnetically coupled to the magnet member by at least a portion thereof, to be temporarily magnetized in or around the portion by one of the poles of the magnet member, to absorb the waves therein, and to reroute the waves to one of the poles of such a magnet member in which such waves may be eliminated. Such a sensor may be arranged to monitor a period of magnetic coupling between the path and magnet members and to issue a signal to an user after a preset period of time elapses after such a coupling may be formed.

In another exemplary embodiment of this aspect of the invention, a system may include at least one “basic” magnet member, at least one path member, as well as at least one actuator member. The path member may be arranged to be magnetically permeable, to form a magnetic coupling with such a magnet member by at least a portion thereof, to be temporarily magnetized around the portion by one of the poles of the magnet member, to absorb the waves therein, and to reroute the waves to one of the poles of the magnet member in which the waves may be eliminated. The actuator member may be arranged to monitor a period of magnetic coupling of the path member with the magnet member and to translate, rotate or otherwise move at least one of the magnet and path members with respect to the other thereof after a preset period of time, whereby the portion of the path member may be arranged to be temporarily magnetized by the other of the poles after such a preset period and to be prevented from being permanently magnetized in polarity of such one pole.

In another aspect of the present invention, a magnet-shunted system may also be provided for rerouting magnetic waves which propagate toward a target away from such a target by at least one magnetically permeable material and eliminating the waves by at least one magnet while preventing or at least minimizing) permanent magnetization of the material.

In one exemplary embodiment of this aspect of the invention, a system may include at least one “basic” magnet member and at least one path member. The path member may be arranged to have the material therein, to be magnetically coupled to the magnet member, to absorb such waves therein, and to reroute the waves to at least one of the poles of the magnet member in which such waves may be eliminated. The magnet member may then be arranged to translate along different portions of the path member and to temporarily magnetize the portions of the path member to different poles of the magnet member alternatingly so as to prevent or at least minimize such portions of the path member from such permanent magnetization.

In another exemplary embodiment of this aspect of the invention, a system may include at least one path member and at least one magnet member. The path member may be arranged to include the material therein and to absorb the waves therein. The magnet member may be arranged to include at least one permanent magnet defining at least one N pole and S pole therein, to be magnetically coupled to the path member, to receive the waves through the path member, and then to eliminate such waves in at least one of the poles thereof. The magnet member may be arranged to change orientation of the poles with respect to the path member and then to temporarily magnetize different portions of the path member with the poles, thereby preventing or at least minimizing the path member from the permanent magnetization.

In another aspect of the present invention, a magnet-shunted system may consist of a preset number of portions each of which may be capable of rerouting magnetic waves propagating toward a target away from the target by at least one magnetically permeable material.

In one exemplary embodiment of this aspect of the invention, a system may include at least one path member and at least one magnet member. The path member may be arranged to have the preset number of the portions, to be magnetically permeable, and to absorb the magnetic waves therein. The magnet member may be arranged to have at least one permanent magnet defining at least one N pole and S pole therein, and to magnetically couple with each of the portions of the path member, whereby each of the portions of the path member may be arranged to be cut away from the rest of such a path member while including at least a portion of the magnet member, to receive such waves from the path member, and then to eliminate the waves in at least one of the poles of such at least a portion of such a magnet member.

In another exemplary embodiment of this aspect of the invention, a system may include at least one path member and at least one magnet member. The path member may be arranged to define the preset number of the portions in a preset dimension, to be magnetically permeable, and to absorb such waves therein. The magnet member may be arranged to have at least one permanent magnet which may arranged to define at least one N pole and S pole thereon, to extend in the dimension of the path member, and to magnetically couple with each of the portions of the path member. Thus, each of the portions of the path member may be arranged to be cut away from the rest of the path member while including at least a portion of the magnet member, to receive such waves from the path member, and then to eliminate the waves in at least one of the poles of the at least a portion of the magnet member

In another exemplary embodiment of this aspect of the invention, a system may include at least one “basic” magnet member and at least one path member which may be arranged to have a skeleton thereof, to form multiple openings across the skeleton, to be magnetically permeable, to magnetically couple with the magnet member through the skeleton, to absorb the waves through the skeleton, and to reroute the absorbed waves through the skeleton to at least one of the poles of the magnet member in which such waves may be eliminated, whereby the path member is arranged to provide an access to the target through the openings thereof.

In another exemplary embodiment of this aspect of the invention, such a system may include at least one path member and at least one magnet member. The path member may be arranged to define multiple openings thereacross, to be magnetically permeable, and to absorb such waves therein. The magnet member may be arranged to have at least one permanent magnet which may have at least one N pole and S pole, to magnetically couple with the path member, to receive the absorbed waves from the path member, and to eliminate such waves in at least one of the poles thereof. The path member may also be arranged to have a ratio of a total area of the openings to a total area of the rest of such a path member to be about 0.1, greater or less than 0.1, and the like.

In another exemplary embodiment of this aspect of the invention, a system may include at least two path members and at least one magnet member. Such a path members may be arranged to define multiple openings thereacross, to be magnetically permeable, to be disposed one over the other while misaligning at least portions of the openings, to receive the waves one at a time or sequentially, and then to absorb waves therein. The magnet member may be arranged to have at least one permanent magnet which is arranged to define at least one N pole and S pole thereon, to magnetically couple with each of the path member, to receive the absorbed waves from the path members, and to eliminate the waves in at least one of the poles thereof.

In another exemplary embodiment of this aspect of the invention, a system may include at least one “basic” magnet member and at least one path member. The path member may be arranged to be magnetically permeable, to be magnetically coupled to the magnet member, to absorb the waves, and to reroute the waves to at least one of the poles of the magnet member in which the magnetic waves may be eliminated. These members may be arranged to have a ratio of an area of the path member to an area of the magnet member to be at least about 20, thereby maximizing the area through which the waves may be absorbed.

Embodiments of the above four aspects of the present invention may also include one or more of the following features.

Such path members temporarily magnetized by different poles may be vertically disposed one over the other, may be helically or spirally woven, may be woven into a quilt, and the like. Such path members temporarily magnetized by different poles may be disposed to receive the magnetic waves sequentially or one at a time. Each of multiple path members temporarily magnetized by different poles may receive a different portion of the magnetic waves. Such path members may couple with a single magnet member or multiple magnet members. Such path members may be disposed to contact each other or, in the alternative, may be intervened by a gap and/or a filter as described in the co-pending Application. A strength of the magnetic field of the temporarily magnetized path member may also be stronger than, similar or equal to, or less than a static magnetic fields of the Earth.

The magnet member may include at least one electromagnet instead of the permanent magnet. The system may include a power source and the electromagnet may operate by the source. At least a portion of the path member may generate an electric current in response to electric fields or electric waves of the waves and the electromagnet may operate by the current.

Each of the preset portions of the path member may incorporate at least one magnet member embedded therein. The magnet member may be elongated enough to encompass each of the preset portions of the path member. The magnet member may encompass each of the preset portions and then define at least one N pole and at least one S pole when cut away along with the preset portions of the path member. Such preset portions of the path member may be defined along a length, width, thickness, height, and/or radius of the path member. The magnet member may be stationary, while at least a portion of the path member may translate, rotate or otherwise move with respect to the magnet member.

The ratio of the total area of the openings to the total area of the rest of the path member may be in the range of about thousands, hundreds, tens or less or, e.g., 4,000, 3,000, 2,000, 1,000, 800, 600, 400, 200, 100, 80, 60, 40, 20, 10, 8, 6, 4, 2, 1, 0.8, 0.6, 0.4, 0.2, 0.1.0, 0.08, 0.06, 0.04, 0.03, 0.02, 0.01 or less. Such openings may be identical or at least two of the openings may be different. Such a system may include multiple path members each of which may in turn have the openings which may be identical or different from each other. The openings of the path members may be aligned one over the other. Alternatively, the openings of the path members may be misaligned one over the other. The area of the openings of an upper path member may be larger than that of the openings of a lower path member. The upper path member may include some openings, whereas the lower path member may include very little or no openings. The ratio of the area of the path member to the area of the magnet member may be equal to or greater than, e.g., 2,000, 1,000, 500, 300, 200, 100, 90, 80, 70, 60, 50, 40, 30, 25, 20, 15, 10, 5, 1, 0.5. 0.1 or less.

The system may include at least one shunt member which has the permeability and which may be arranged to enclose at least a portion of the magnet and to allow the path member to magnetically couple with the magnet of the magnet member one of directly and indirectly. The shunt member may be arranged to minimize intrinsic magnetic fields generated by the magnet which may propagate away therefrom. The intrinsic magnetic fields may be arranged to collected and rerouted through the shunt member and to be eliminated in at least one of the poles of the magnet of the magnet member.

The path and/or shunt members may define high electric conductivity or, in the alternative, low electric conductivity. The path and/or shunt members may be a semiconductor such as, e.g., silicon, carbon, germanium, and/or a compound thereof. The path and/or shunt members may be made of or include electric insulators. The path and/or shunt member may have different permeabilities according to frequencies of the MFs and MWs. The path and magnet (or shunt) member may be intervened by a gap or filler.

In another aspect of the present invention, an electric device may incorporate therein at least one magnet-shunted system capable of preventing or at least minimizing secondary magnetic waves which are generated by a wave generating component of the device from propagating away out of the device.

In one exemplary embodiment of this aspect of the invention, a device may include at least one magnet member and at least one path member. Such a magnet member may be a permanent magnet of the system and may be arranged to have at least one N pole and S pole thereon and to be disposed adjacent to the device. The path member may be arranged to be magnetically permeable, to enclose at least a portion of such a generating component of the device, to magnetically couple with the magnet member, to absorb the secondary magnetic waves therein, and to reroute such secondary magnetic waves toward at least one of the poles of the magnet member in which the waves are eliminated.

In another exemplary embodiment of this aspect of the invention, a device may include at least one path component and at least one magnet member. Such a path component may be a component of the electric device and magnetically permeable. The magnet member may be arranged to include at least one permanent magnet defining at least one N pole and S pole and to magnetically couple with the path component, whereby at least a portion of the waves is arranged to be absorbed by the path component, to be rerouted to the magnet member through the path component, and to be eliminated by at least one of the poles of the magnet member.

In another exemplary embodiment of this aspect of the invention, a device may include at least one shunt component, at least one path member, as well as at least one magnet member. The shunt component may be a component of the device and magnetically permeable. Such a path member may be arranged to be magnetically permeable, to be disposed on or below at least a portion of the device, and to absorb the magnetic waves therein. The magnet member may be arranged to have at least one permanent magnet defining at least one N pole and S pole therein, to magnetically couple with the path member, and to be at least partially enclosed by the shunt component of the device, whereby at least a portion of the waves is absorbed by the path member, rerouted toward the magnet member through the path member, and then eliminated in at least one of the poles of the magnet member and whereby at least a portion of intrinsic magnetic fields generated by the magnet member is also absorbed by the shunt component of the device.

In another exemplary embodiment of this aspect of the invention, a device may include at least one permanent magnet (or electromagnet) and at least one path member. Such a permanent magnet (or electromagnet) may be a component of the device and arranged to define at least one N pole and S pole thereon. The path member may be arranged to be magnetically permeable, to enclose at least a portion of the electric device, to be magnetically coupled to the permanent magnet (or electromagnet), to absorb the waves therein, and to reroute the waves to at least one of the poles of the permanent magnet (or electromagnet) in which the waves may be eliminated.

In another aspect of the present invention, a magnet-shunted system may be incorporated into an electric device for preventing or at least minimizing secondary magnetic waves generated by the device from propagating away out of the device.

In one exemplary embodiment of this aspect of the invention, a system may include at least one path member and at least one magnet member. The path member may be arranged to be magnetically permeable and to absorb the secondary magnetic waves thereinto, where at least a portion of such a path member may be arranged to be retrofit into the device. The magnet member may be arranged to define at least one N pole and S pole therein, to magnetically couple with the path member, to receive the absorbed waves through the path member, and to eliminate the waves in at least one of the poles.

In another exemplary embodiment of this aspect of the invention, a system may include at least one magnet member and at least one path member. The magnet member may be arranged to define at least one N pole and S pole. Such a path member may be arranged to be magnetically permeable, to enclose at least a portion of an exterior of the electric device, to magnetically couple with the magnet member, to absorb the secondary magnetic waves therein, and to reroute such waves to at least one of the poles of the magnet member in which the waves may be eliminated.

In another exemplary embodiment of this aspect of the invention, a system may include at least one path member and multiple magnet members. The path member may be arranged to be in one of a liquid, a solution, a sol, and an emulsion, to be magnetically permeable, and to absorb the secondary magnetic waves therein. The magnet members may be arranged to define at least one N pole and S pole and to be mixed in the path member, whereby a mixture of the path and magnet members may be arranged to be coated over at least a portion of the device such that the secondary magnetic waves are absorbed and rerouted to the magnet members by the path members and whereby the waves are eliminated in at least one of the poles of the magnet members.

In another aspect of the present invention, a magnet-shunted system may be provided for the purpose of preventing or at least minimizing secondary magnetic waves which may be generated by an electric device from propagating away therefrom.

In one exemplary embodiment of this aspect of the invention, a system may include at least one “basic” magnet member, while the electric device may include at least one path component having high magnetic permeability. The magnet member may be arranged to magnetically couple with such a path component of the device, whereby at least a portion of the magnetic waves may then be arranged to be absorbed by the path component of the device, to be rerouted toward the magnet member through the path component, and then to be eliminated in at least one of the poles of the magnet member.

In another exemplary embodiment of this aspect of the invention, a system may include at least one path member as well as at least one magnet member. Such a path member may be arranged to be magnetically permeable, to be disposed on or below at least a portion of the electric device, and to absorb the magnetic waves therein. The magnet member may include at least one permanent magnet defining at least one N pole and S pole and magnetically couple with such a path member. The electric device may be arranged to have at least one shunt component having high magnetic permeability, and the magnet member may be arranged to be at least partially enclosed by the shunt component of the electric device, whereby at least a portion of the magnetic waves may be arranged to be absorbed by the path member, to be rerouted toward the magnet member through the path member, and then to be eliminated by at least one of the poles of the magnet member. In addition, at least a portion of intrinsic magnetic fields generated by the magnet member may also be absorbed by such a shunt component.

In another exemplary embodiment of this aspect of the invention, a system may include at least one path member, and the electric device includes at least one permanent magnet (or electromagnet) with at least one N pole and S pole. The path member may be arranged to be magnetically permeable and to enclose at least a portion of the device. The path member may be arranged to be magnetically coupled to the permanent magnet (or electromagnet), to absorb the magnetic waves therein, and to reroute the magnetic waves to at least one of the poles of the at least one of the permanent magnet and electromagnet in which the secondary magnetic waves are eliminated.

Embodiments of the above three aspects of the present invention may include one or more of the following features.

The path, magnet, and shunt members may be similar or identical to those described in the first four aspect of this invention. The path component may also be similar or identical to the path members described in the first four aspects of this invention.

The path component may reroute extrinsic magnetic waves propagating to the electric device to the magnet member therethrough. The path component may be electrically conductive or insulative. The system may also reroute and eliminate extrinsic MFs and MWs to ensure intended operation of the device. The system may include at least one shunt member enclosing at least a portion of the magnet member and to confine intrinsic MFs generated by the magnet member within a preset distance. Such a magnet member may have at least one electromagnet instead of the permanent magnet. The system or device may include a power source and the electromagnet may operate by the source. At least a portion of the path member (or component) may generate electric current in response to electric fields and electric waves of the waves and the electromagnet may operate by the current.

Such path and/or shunt members may have high electric conductivity or, in the alternative, low electric conductivity. The path and/or shunt members may be semiconductors or electric insulators.

Such magnet members may be made as fine particles with sizes in the ranges of nanometers, microns, millimeters, and so on. The particulate magnet members may also define shapes of spheres, ellipsoids, cylinders, fibers, and the like, where each of these shapes may be solid or porous. Such particulate magnet members may be covered by various fillers which may be electrically conductive, semiconductive or insulative, which may be magnetically permeable, less permeable than such path and/or shunt members, and the like. The particulate magnet members may also be mixed with the path member which may be in a phase of a liquid, gel or powder or may be in another phase of a solution, gel, emulsion, suspension or powder with a base. The particulate magnet members and path member may be mixed and coated over the device. Such a device may include a casing which may be coated with a mixture of the magnet and path members and also define at least one indentation into which the magnet members may be disposed. The particulate magnet members and path member may be mixed and processed to another article having a shape of a curvilinear sheet or slab, an elongated filament or fiber, a woven screen, mesh or fabric, and the like.

In another aspect of the present invention, a method may be provided for rerouting extrinsic magnetic waves propagating toward a target away therefrom.

In one exemplary embodiment of this aspect of the invention, a method may include the steps of: disposing at least one magnetically permeable path member between a source of the waves and the target; magnetically coupling the path member with a magnet member defining at least one N pole and at least one S pole; absorbing the waves with the path member; and eliminating such waves in at least one of the poles of the magnet member, thereby increasing an extent of such absorbing per an unit mass (or volume, length, thickness) of the path member.

In another exemplary embodiment of this aspect of the invention, a method may have the steps of: disposing at least one magnetically permeable path member between a source of the waves and the target; magnetically coupling the path member with a magnet member defining at least one N pole and at least one S pole; absorbing the waves with the path member; and rerouting such waves to at least one of the poles of the magnet member, thereby eliminating the waves from the path member and preventing (or at least minimizing) saturation thereof.

In another exemplary embodiment of this aspect of the invention, a method may have the steps of: disposing at least one magnetically permeable path member between a source of the waves and the target; magnetically coupling the path member with a magnet member defining at least one N pole and S pole, thereby temporarily magnetizing at least a portion of the path member; absorbing inside the path member not only a portion of the waves directed to the path member but also another portion of the waves not originally directed thereto but attracted to the temporarily magnetized portion of the path member; and rerouting both of the above portions of such waves toward at least one of the poles of the magnet member, thereby eliminating the waves therein.

In another exemplary embodiment of this aspect of the invention, a method may have the steps of: disposing at least two magnetically permeable path members between a source of the waves and the target; magnetically coupling each of the path members with different poles of a magnet member in a preset pattern, thereby temporarily magnetizing the path members and creating magnetic fields in the path members propagating in different directions; absorbing different portions of the waves with each of such path members; and rerouting such waves to at least one of the poles of the magnet member, thereby eliminating the waves from the path member.

In another exemplary embodiment of this aspect of the invention, a method may have the steps of: disposing at least two magnetically permeable path members one over the other between a source of the waves and the target; magnetically coupling each of the path members with different poles of a magnet member in a preset pattern, thereby temporarily magnetizing the path members and generating magnetic fields in the path members propagating in different directions; absorbing the waves with the path members consecutively or one at a time; and rerouting such waves to at least one of the poles of the magnet member, thereby eliminating the waves from the path member.

In another aspect of this invention, a method may be provided for rerouting extrinsic magnetic waves propagating toward a target away therefrom by a magnetically permeable path member while minimizing its permanent magnetization.

In one exemplary embodiment of this aspect of the invention, a method may include the steps of: disposing at least one magnetically permeable path member between a source of the waves and the target; magnetically coupling the path member with each polarity of a magnet member alternatingly; absorbing the waves with the path member; and rerouting the waves to at least one of the poles of the magnet member, thereby eliminating the waves from the path member in the magnet member.

In another exemplary embodiment of this aspect of the invention, a method may have the steps of: disposing at least one magnetically permeable path member between a source of the waves and the target; magnetically coupling the path member with one polarity of a magnet member, absorbing the waves with the path member; rerouting the waves to at least one of the poles of the magnet member, thereby eliminating the waves from the path member in the magnet member; and magnetically coupling the path member with an opposite polarity of the magnet member, thereby preventing the path member from being permanently magnetized into the one polarity.

In another exemplary embodiment of this aspect of the invention, a method may have the steps of: disposing at least one magnetically permeable path member between a source of the waves and the target; magnetically coupling the path member with one polarity of a magnet member with at least one N pole and S pole while monitoring a period of such coupling; absorbing the waves with the path member, rerouting the waves to at least one of such poles of the magnet member, thereby eliminating the waves from the path member in the magnet member; and issuing a signal to an user as the period of the coupling reaches a preset value.

In another exemplary embodiment of this aspect of the invention, a method may have the steps of: disposing at least one magnetically permeable path member between a source of the waves and the target; magnetically coupling the path member with one polarity of a magnet member with at least one N pole and S pole while monitoring a period of the coupling and/or an extent of magnetization of the path member; absorbing the waves with the path member; rerouting the waves to at least one of the poles of the magnet member, thereby eliminating such waves from the path member in the magnet member; and magnetically coupling the path member with an opposite polarity of the magnet member after at least one of the period and extent reaches a preset value.

In another aspect of the present invention, a method may be provided for minimizing permanent magnetization of a magnetically permeable path member for rerouting extrinsic magnetic waves which propagate to a target away therefrom.

In one exemplary embodiment of this aspect of the invention, a method may include the steps of: disposing at least one magnetically permeable path member between a source of the waves and the target; magnetically coupling the path member with one polarity of a magnet member; absorbing the waves with the path member; rerouting the waves to at least one of the poles of the magnet member, thereby eliminating the waves in the magnet member; and moving at least one of the magnet and path members with respect to the other thereof so as to couple the path member to an opposite polarity of the magnet member, thereby preventing the path member from being permanently magnetized into the one polarity.

In another exemplary embodiment of this aspect of the invention, a method may have the steps of: disposing at least one magnetically permeable path member between a source of the waves and the target; magnetically coupling the path member with one polarity of a magnet member with at least one N pole and S pole; absorbing such waves with the path member; rerouting the waves to at least one of the poles of the magnet member, thereby eliminating such waves in the magnet member; and translating the path member to an opposite polarity of the magnet member, thereby preventing the path member from being permanently magnetized into the one polarity.

In another exemplary embodiment of this aspect of the invention, a method may have the steps of: disposing at least one magnetically permeable path member between a source of the waves and the target; rotatably coupling the path member with one polarity of a magnet member; absorbing such waves with the path member; rerouting the waves to at least one of the poles of the magnet member, thereby eliminating the waves in the magnet member; and rotating the path member to another polarity of the magnet member, thereby preventing the path member from being permanently magnetized into the one polarity.

In another aspect of the present invention, a method may be provided for forming in a magnet-shunted system a preset number of portions each of which reroutes magnetic waves propagating to a target away therefrom.

In one exemplary embodiment of this aspect of the invention, a method may include the steps of: disposing at least one magnetically permeable path member between a source of the waves and the target; defining the preset number of the portions in the path member; magnetically coupling each of the portions of the path member with a magnet member; separating one of the portions from a rest of the path member while incorporating therein at least a portion of the magnet member; absorbing the waves with the one of the portions of the path member; and rerouting the waves toward at least one pole of the portion of the magnet member, thereby eliminating such waves in the portion of the magnet member.

In another exemplary embodiment of this aspect of the invention, a method may have the steps of: disposing at least one magnetically permeable path member between a source of the waves and target; defining the preset number of the portions in the path member; providing an elongated magnet member; magnetically coupling the magnet member with each of the portions of such a path member; separating one of the portions from the rest of the path member while incorporating therein at least a length of the magnet member; absorbing the waves with the one of the portions of the path member; and rerouting the waves toward at least one pole of the above length of the magnet member, thereby eliminating the waves in the magnet member.

In another exemplary embodiment of this aspect of the invention, a method may have the steps of: disposing at least one magnetically permeable path member between a source of the waves and the target; defining a skeleton in the path member as well as multiple openings around such a skeleton; magnetically coupling the path member with a magnet member through such a skeleton; absorbing the waves with the skeleton of the path member while providing an access to an opposite side of such a path member through the openings and a visibility therethrough; and rerouting such waves toward at least one pole of the magnet member, thereby eliminating the waves in the magnet member.

In another exemplary embodiment of this aspect of the invention, a method may have the steps of: providing at least two magnetically permeable path members; defining at least one skeleton as well as multiple openings around the skeleton in a first of the path members; disposing the first of the path members over the other thereof; disposing the path members between the target and a source of the waves; magnetically coupling the path members with a magnet member; absorbing a portion of such waves with the first of the path members and another portion of the waves with the other of the path members; and then rerouting the waves toward at least one pole of such a magnet member, thereby eliminating the waves in the magnet member.

In another exemplary embodiment of this aspect of the invention, a method may have the steps of: providing at least two magnetically permeable path members each of which may form at least one skeleton and multiple openings around the skeleton; disposing the path members over the other while misaligning the openings; disposing the path members between the target and a source of the waves; magnetically coupling the path members with a magnet member; absorbing a portion of the waves by an upper of the path members and another portion of the waves by a lower of the path members; and rerouting the waves toward at least one pole of the magnet member, thereby eliminating the waves in the magnet member.

In another aspect of the present invention, another method may be provided for at least one of ensuring intended operations of an electric device against extrinsic magnetic waves and minimizing secondary magnetic waves which are generated by the device from propagating away therefrom.

In one exemplary embodiment of this aspect of the invention, a method may include the steps of: disposing a magnetically permeable path member around at least a portion of the electric device; magnetically coupling the path member with a magnet member having at least one N pole and at least one S pole; absorbing at least one of the waves with the path member; and eliminating the waves in at least one of the poles of the magnet member.

In another exemplary embodiment of this aspect of the invention, a method may have the steps of: locating a magnetically permeable path component of the device; magnetically coupling such a path component with a magnet member including at least one N pole and S pole; absorbing at least one of the waves with the path component; and eliminating such waves in at least one of the poles of such a magnet member.

In another exemplary embodiment of this aspect of the invention, a method may have the steps of: disposing a magnetically permeable path member around at least a portion of the device; locating a magnetically permeable shunt component of the device; enclosing by the shunt component at least a portion of a magnet member defining at least one N pole and S pole; magnetically coupling such a path member with the magnet member; absorbing at least one of such waves with the path member; and eliminating the waves in at least one of the poles of the magnet member.

In another exemplary embodiment of this aspect of the invention, a method may have the steps of: disposing a magnetically permeable path member around at least a portion of the device; locating in the device a magnet member capable of defining at least one N pole and S pole; magnetically coupling the path member with the magnet member; absorbing at least one of the waves with the path member; and eliminating the waves in at least one of the poles of the magnet member.

In another aspect of the present invention, a method may be provided for incorporating into an electric device a magnet-shunted system which may be capable of ensuring intended operation of the device against extrinsic magnetic waves and/or minimizing secondary magnetic waves generated by the device from propagating away therefrom.

In one exemplary embodiment of this aspect of the invention, a method may include the steps of: retrofitting at least one magnetically permeable path member into the device; magnetically coupling the path member with a magnet member having at least one N pole and at least one S pole; absorbing the waves with the path member; and eliminating the waves in at least one of the poles of the magnet member, thereby increasing an extent of the absorbing per an unit mass (or volume, length, thickness) of the path member.

In another exemplary embodiment of this aspect of the invention, a method may have the steps of: covering at least a portion of such a device with at least one magnetically permeable path member; magnetically coupling the path member with a magnet member having at least one N pole and at least one S pole; absorbing the waves with the path member; and eliminating such waves in at least one of the poles of the magnet member, thereby increasing an extent of such absorbing per an unit mass (or volume, length, thickness) of the path member.

In another exemplary embodiment of this aspect of the invention, a method may have the steps of: coating at least one magnetically permeable path member over at least a portion of such a device; magnetically coupling the path member with a magnet member having at least one N pole and at least one S pole; absorbing the waves with the path member; and eliminating such waves in at least one of the poles of the magnet member, thereby increasing an extent of such absorbing per an unit mass (or volume, length, thickness) of the path member.

In another exemplary embodiment of this aspect of the invention, a method may have the steps of: fabricating at least one magnetically permeable material into a path member defining a preset shape and size; disposing the path member over at least a portion of the device; magnetically coupling such a path member with a magnet member defining at least one N pole and at least one S pole; absorbing the waves with the path member; and eliminating the waves in at least one of the poles of the magnet member, thereby increasing an extent of the absorbing per an unit mass (or volume, length, thickness) of the path member.

Embodiments of the above method aspects of the present invention may be similar or identical to those of the above features of the systems claims.

In another aspect of the present invention, a magnet-shunted system may also be provided for rerouting magnetic waves propagating toward a target away therefrom by at least one magnetically permeable material.

In one exemplary embodiment of this aspect of the invention, such a system may be made by a process including the steps of: providing at least one magnetically permeable path member; disposing the path member between a source of the waves and the target; providing a magnet member having at least one N pole and at least one S pole thereon; magnetically and fixedly or releasably coupling the path and magnet members; absorbing and accumulating the waves in the path member; and rerouting the waves to at least one of the poles of the magnet member, thereby eliminating the waves therein.

In another exemplary embodiment of this aspect of the invention, such a system may be made by a process which includes the steps of: providing at least one magnetically permeable path member; providing a magnet member having at least one N pole and at least one S pole thereon; disposing such a path member between a source of the waves and the target; magnetically coupling the path member with the magnet member; absorbing the waves in the path member; and rerouting the waves toward at least one of the poles of the magnet member and eliminating the waves therein, thereby preventing (or at least minimizing) the path member from saturation.

In another exemplary embodiment of this aspect of the invention, such a system may be made by a process which includes the steps of: providing at least one magnetically permeable path member; providing a magnet member having at least one N pole and at least one S pole thereon; disposing such a path member between a source of the waves and the target; magnetically coupling the path member with the magnet member, thereby temporarily magnetizing at least a portion of the above path member; absorbing the waves in the path member; and rerouting the waves to at least one of the poles of the magnet member, thereby eliminating.

In another exemplary embodiment of this aspect of the invention, such a system may be made by a process which includes the steps of: providing multiple magnetically permeable path members; disposing the path member between a source of the waves and target; providing a magnet member having at least one N pole and S pole thereon; magnetically coupling a first of the path members with the magnet member in a first pattern, thereby temporarily magnetizing at least a first portion of the first of the path members and creating a first magnetic field propagating along a first direction; magnetically coupling a second of the path members to the magnet member in a second pattern which is different from the first pattern, thereby temporarily magnetizing at least a second portion of the second of the path members and creating a second magnetic field propagating along a second direction; absorbing a first portion of the waves which propagates in a direction at least similar to the first direction by the first of the path members; absorbing a second portion of the waves which propagates in a direction at least similar to the second direction by the second of the path members; and rerouting the first and second portions of the waves to at least one of the poles of the magnet member, thereby eliminating the waves therein.

More product-by-process claims may be constructed by modifying the foregoing preambles of the apparatus and/or method claims and by appending thereto such bodies of the apparatus and/or method claims. In addition, such process claims may include one or more of the above features of the apparatus and/or method claims of the present invention.

As used herein, the term “magnet” means any article which can actively generate a magnetic field therearound by itself, where a strength of the magnetic field may be measured by a conventional gauss-meter. Accordingly, any permanent magnet with any arbitrary shape, size, and number of the N and/or S poles may qualify as the “magnet” within the scope of the present invention as far as such a permanent magnet may generate the measurable magnetic field therearound. It is to be understood, however, that the “magnet” may not include electromagnets within the scope of the present invention. It is also appreciated that a portion of a path member which may magnetically couple with the magnet member and temporarily magnetized by the magnet member may not qualify as the “magnet”, for such a portion may not actively or may not alone generate the magnetic field therearound.

The term “magnetic permeability” refers to a property of a substance of retaining magnetic field lines therein. The term “relative permeability” is a ratio of the magnetic permeability of the substance to that of air. As used herein, the term “permeability” refers to either the magnetic permeability or relative permeability unless otherwise specified. Similarly, the term “magnetically very permeable” means that the magnetic permeability of the substance is at least a few orders of magnitudes greater than that of the air. In general, a ferromagnetic material is magnetically very permeable, where examples of such materials may include, but not be limited to, elements such as iron, cobalt, nickel, and gadolinium, and certain alloys based on one or more of those elements. In addition, non-ferromagnetic, paramagnetic materials have the magnetic permeability slightly greater than that of the air, while non-ferromagnetic, diamagnetic substance have the magnetic permeability slightly less than that of air. Accordingly, the relative permeabilities of the ferromagnetic materials is very greater than 1.0, while those of the non-ferromagnetic, paramagnetic and diamagnetic materials are respectively slightly greater and less than 1.0. The term “magnetic susceptibility” refers to a different between the relative permeability and 1.0. Accordingly, the magnetic susceptibilities of the ferromagnetic materials is very greater than 0.0, while those of the non-ferromagnetic, paramagnetic and diamagnetic materials are slightly greater and less than 0.0, respectively.

As used herein, “extrinsic” magnetic fields and waves refer to those fields and waves which originate from a source which is disposed far away from a target and propagate in space toward the target, while “intrinsic” magnetic fields refer to the fields generated by a magnet and/or electromagnet of a magnet member of a magnet-shunted system of this invention. In addition, “secondary” magnetic fields and waves refer to those fields and waves which generally originate from an electric or optical device disposed relatively close to the target and propagate toward the target through the device and then through space.

The terms “magnetic fields” and “magnetic waves” within the scope of this invention refer to those which are associated with various electromagnetic waves. Therefore, such “magnetic fields” are accompanied by matching electric fields, while such “magnetic waves” are also accompanied by matching electric waves. When the “magnetic fields” are static, however, they are not accompanied by the electric fields.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A to 1C are schematic diagrams of prior art configurations for shielding electromagnetic waves by electric conductors and magnetically permeable materials;

FIGS. 2A to 2C are schematic diagrams of a magnetic field formed near a conventional magnet and prior art configurations of shunting such magnetic field;

FIGS. 3A to 3C are perspective views of exemplary magnet-shunted systems each of which includes a magnet member, a path member, and a shunt member according to the present invention;

FIGS. 3D to 3G are top views of exemplary magnet-shunted systems each of which includes a shunt member and an optional path member according to the present invention;

FIGS. 4A to 4X are top views of exemplary path members each of which has a preset number of magnet members defining polarities in a preset arrangement according to the present invention;

FIGS. 5A to 5H are top views of exemplary path members which define multiple segments and each of which includes a preset number of magnet members according to the present invention;

FIGS. 5I to 5P are top views of exemplary path members which define shapes of screens and each of which includes a preset number of magnet members according to the present invention;

FIGS. 6A to 6D are perspective views of exemplary path members each of which has a shape of an elongated rod and which magnetically couple with one or multiple magnet members according to the present invention;

FIGS. 6E to 6H are perspective views of exemplary path members which are similar to those of FIGS. 6A to 6D but includes multiple segments according to the present invention;

FIGS. 6I to 6P are perspective views of exemplary path members each of which has a shape of an elongated annular or hollow tube and magnetically couple with one or multiple magnet members according to the present invention;

FIGS. 6Q to 6X are top views of exemplary path members which define shapes of mesh and each of which includes a preset number of magnet members according to the present invention;

FIGS. 7A to 7P are perspective views of exemplary path assemblies each having at least two path members and generating temporary magnetic fields on at least portions thereof according to the present invention;

FIGS. 8A to 8H are perspective views of exemplary path members fixedly or movably coupling with each other according to the present invention; and

FIGS. 9A to 9H are perspective view of exemplary magnet-shunted systems which include at least one movable member according to the present invention.

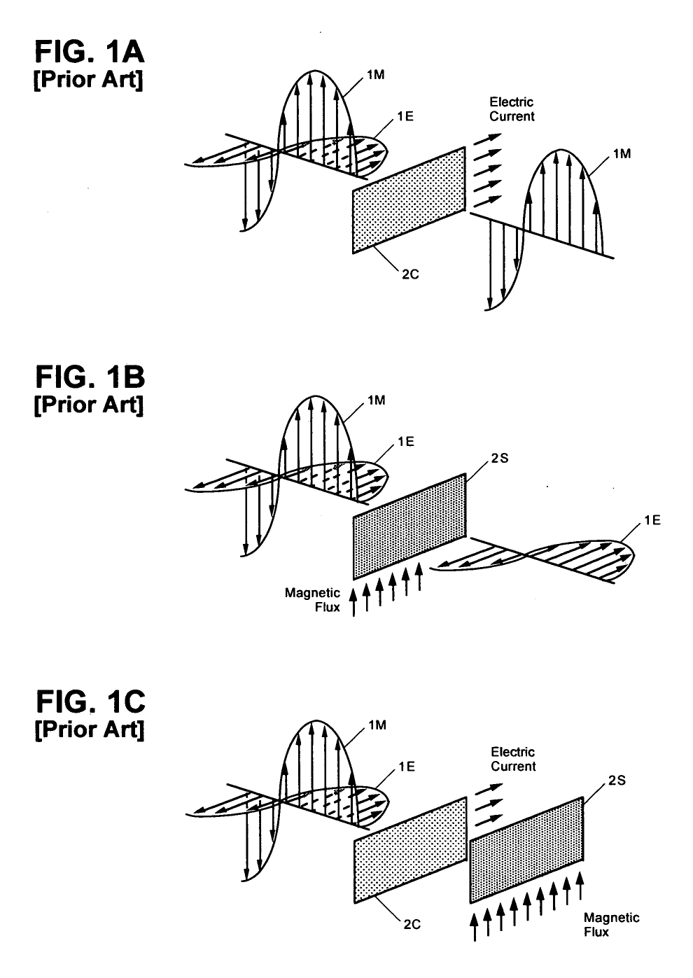

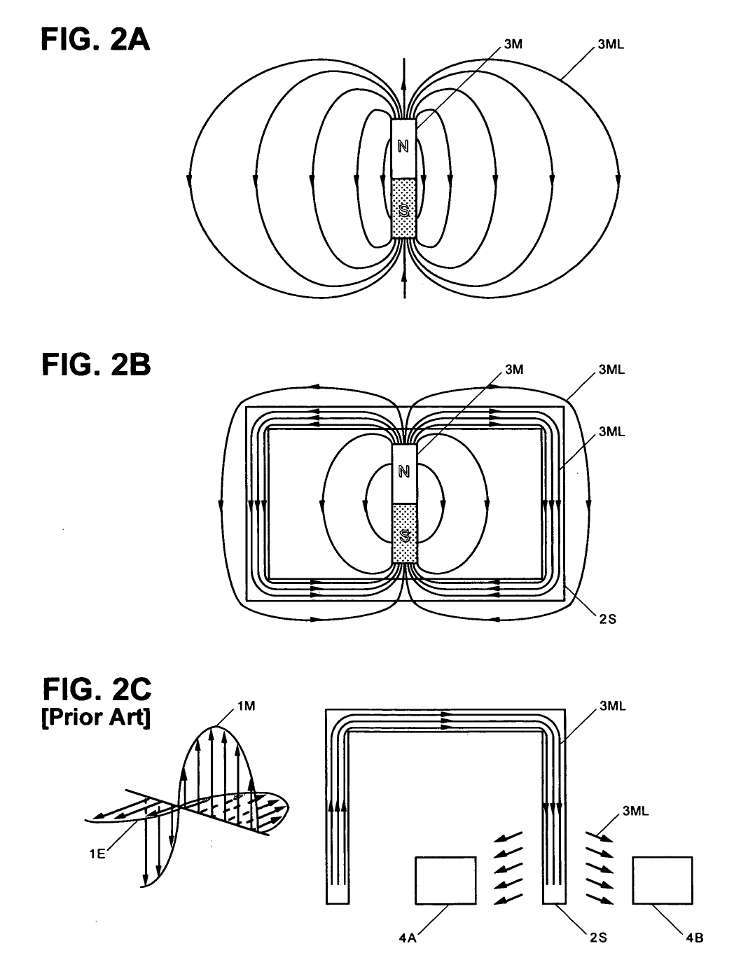

### DETAILED DESCRIPTION OF THE PREFERRED EMBODIMENTS

The present invention generally relates to magnet-shunted systems which may be capable of shielding a target from extrinsic and intrinsic magnetic fields (or MFs) and magnetic waves or radiation (or MWs). More particularly, the present invention relates to various magnet-shunted systems each of which may include at least one path member and at least one magnet member, where the latter may in turn include at least one permanent magnet or electromagnet at least a portion of which is enclosed or covered by at least one shunt member. Both of the path and shunt members may be typically made of or include highly magnetically permeable materials such that those members may define paths through which MFs and MWs of various extrinsic electromagnetic waves (or EM waves) may propagate while bypassing the target, that the magnet or electromagnet of the magnet member may serve as a sink or a termination point in which such MFs and MWs complete their propagation, and that the shunt member may define another path through which intrinsic MFs generated by the magnet or electromagnet of the magnet member may be contained very close to the shunt and/or magnet members and also prevented from penetrating the shunt member toward the target. Therefore, the magnet-shunted systems of this invention may direct the extrinsic MFs and MWs through the path member toward the magnet member and eliminate the extrinsic MFs and MWs by the magnet or electromagnet of the magnet member, while containing at least a substantial portion of such intrinsic MFs within a preset distance from the shunt member, thereby effectively protecting the target from the extrinsic as well as intrinsic MFs and MWS. The present invention also relates to various magnet-shunted systems having at least one path and/or shunt members which may be permanently magnetized by the magnet or electromagnet of the magnet member. These arrangements may allow the path and/or shunt members to attract and contain more extrinsic and/or intrinsic MFs and MWs per unit area, mass or volume of such members. The present invention also relates to various magnet-shunted systems each including at least one movable magnet, path or shunt member which may change its orientation with respect to the other members in various arrangements. These movable arrangements may prevent or at least minimize the path and/or shunt members from being permanently magnetized and/or saturated. The present invention also relates to various magnet-shunted systems which may be disposed inside or outside an electric device so as to prevent or at least minimize secondary MFs and MWs generated by the device from propagating out of such a device. The present invention also relates to various magnet-shunted systems which may be arranged to utilize a permanent magnet or electromagnet of an electric device as their magnet member and to eliminate the extrinsic and/or secondary MFs and MWs using such a magnet or electromagnet.

The present invention also relates to various methods for forming at least one termination point or sink for the MFs and MWs of the extrinsic EM waves along (or on) the magnetically permeable path member, various methods for eliminating such MFs and MWs by at least one permanent magnet and/or electromagnet while containing intrinsic MFs generated by such a magnet and/or electromagnet close thereto, various methods for confining such intrinsic MFs close to the magnet and/or shunt members, various methods for incorporating the shunt member around the magnet member, various methods for magnetically coupling the magnet and/or electromagnet to the shunt and/or path members, and the like. The present invention also relates to various methods for permanently magnetizing at least a portion of the path and/or shunt members in order to attract more extrinsic and/or secondary MFs and MWs than otherwise, various methods for changing orientation of at least one of such members with respect to others, various methods for coupling preset portions of the path and/or shunt members with different poles of the above magnet and/or electromagnet, various methods for preventing or at least minimizing permanent magnetization of preset portions of such path and/or shunt members, various methods for preventing or at least minimizing saturation of such path and/or shunt members, various methods for preventing the secondary MFs and MWs generated by such an electric device from propagating away therefrom, and various methods for utilizing the magnet or electromagnet of the preexisting device for eliminating the extrinsic and/or secondary MFs and MWs.

The present invention further relates to various processes for fabricating the magnet member which may have at least one permanent magnet and/or electromagnet at least a portion of which may be covered and/or enclosed by at least one magnetically permeable shunt member, various processes for providing the magnet member shunted by the shunt member and capable of defining therearound intrinsic MFs of a preset strength on an exterior surface of the shunt member, various processes for magnetically coupling the magnet member to the path and/or shunt members, and various processes for providing the magnet-shunted system capable of eliminating the extrinsic MFs and MWs as well as confining the intrinsic MFs within a preset distance from its magnet and/or shunt members.

The present invention further relates to various processes for fabricating the magnet-shunted system including at least one movable magnet, path or shunt member, various processes for providing a movable magnet, path, and/or shunt members and coupling preset portions of the path and/or shunt members with different poles of the magnet member alternatingly, various processes for providing the path member of which different segments may magnetically couple with different poles of the magnet member, various processes for fabricating the path and/or shunt members at least portions of which may be permanently magnetized and more efficiently attract such extrinsic and/or secondary MFs and MWs, various processes for providing such path and/or shunt members which may be constructed to minimize saturation thereof, various processes for providing the magnet-shunted systems which may be incorporated inside and/or outside the electric device and prevent such secondary MFs and MWs from escaping the device, and various processes for providing the magnet-shunted systems which may utilize the magnet or electromagnet of the device as the termination point or sink for the extrinsic and/or secondary MFs and MWs.

Various aspects and/or embodiments of various systems, methods, and/or processes of this invention will now be described more particularly with reference to the accompanying drawings and text, where such aspects and/or embodiments thereof only represent different forms. Such systems, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various members, units, elements, and parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

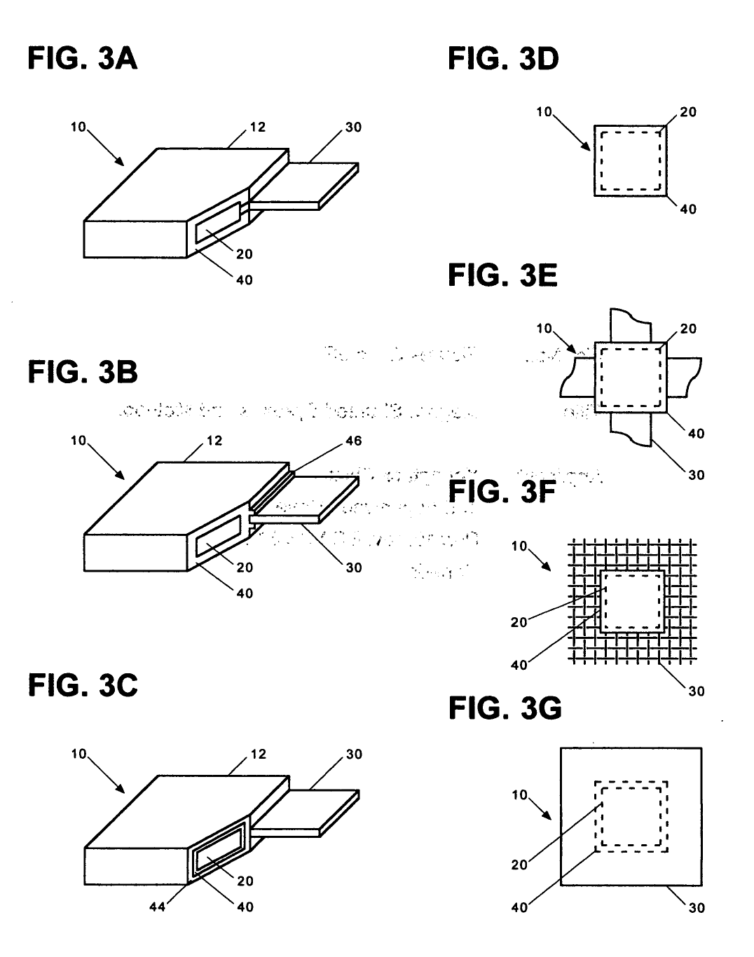

In one aspect of the present invention, an exemplary magnet-shunted system includes at least one magnet member, at least one path member, and at least one shunt member. FIGS. 3A to 3C show perspective views of exemplary magnet-shunted systems each of which includes a magnet member, a path member, and a shunt member according to the present invention.

One exemplary embodiment of such an aspect of the invention is described in FIG. 3A which is a perspective view of an exemplary magnet-shunted system including a path member which directly couples with a magnet member, where an edge of the system is cut away for illustration according to the present invention. An exemplary magnet member 20 includes a flat or planar permanent magnet at least a substantial portion of which is enclosed or covered by a shunt member 40. The shunt member 40 is generally disposed on, over, and/or around the magnet member 20 by a preset thickness which may be uniform or vary from location to location. The shunt member 40 also forms a slit along its side through which one end of a path member 30 is inserted in order to physically and magnetically couple with the magnet member 20. As will be described in detail below, the path and shunt members 30, 40 are made of and/or include at least highly magnetically permeable material.

In operation, the magnet member 20 may be fabricated by forming the magnet defining a preset thickness and a preset number of poles formed in preset orientations and exhibiting a preset magnetic field strength. Thereafter, only a portion or an entire portion of the magnet member 20 is inserted into and/or enclosed by the shunt member 40. Because the shunt member 40 is magnetically permeable, at least a substantial or entire portion of magnetic field (or MF) lines generated by the magnet member 20 may be contained or confined therein, where only a limited or negligible portion of the MF lines may penetrate the shield member 40. Accordingly, the shunt member 40 may preferably be shaped and/or sized to manipulate a MF strength of the magnet member 20 within a preset threshold when measured on an exterior surface 12 of the shunt member 40. One end of the path member 30 may be disposed through the slit of the shunt member 40 such that the end physically touches the magnet of the magnet member 20. Because the path member 30 is also magnetically permeable, the end and/or neighboring portion of the path member 30 may then be temporarily magnetized by the magnet member 20, where a MF strength temporarily induced by the path member 30 may also be determined by various factors such as, e.g., the MF strength of the magnet member 20, magnetic permeability of the path member 30, distance between the end of the path member 30 and a point of interest of the path member 30, and so on. The assembled magnet-shunted system 10 is then disposed over, on or around a target which is disposed in open space through which extrinsic electromagnetic waves (or EM waves) propagate. When the EM waves impinge on the path member 30, at least portions of magnetic fields (or MFs) and magnetic waves (or MWs) of the EM waves may be rerouted into the path member 30 which is more permeable than the air, thereby bypassing the target. Once contained inside the path member 30, the accumulated MFs and MWs propagate through the path member 30 to a magnetic sink which may be an opposite pole such as the S pole of the magnet member 20. Accordingly, the MFs and MWs of the EM waves rerouted into the path member 30 may complete their propagation at the magnet member 20, instead of penetrating the path member 30 to propagate toward the target. In the meantime, the shunt member 40 may reroute intrinsic MFs generated by the magnet member 20 thereinto, for such a shunt member 40 is arranged to be more magnetically permeable than any articles surrounding the magnet-shunted system 10, while maintaining the MF strength on its exterior surface 12 below the preset limit. Therefore, the magnet-shunted system 10 may not only protect the target from the extrinsic MFs and MWs but also prevent the intrinsic MFs from propagating away from the shunt member 40. It is to be understood that such a portion of the path member 30 which is temporarily magnetized by the magnet member 20 may be able to distort contour of the extrinsic MFs and MWs theretoward and reroute the distorted MFs and MWs therealong, thereby rerouting more MFs and MWs than otherwise, i.e., when the path member 30 is not temporarily magnetized.

Alternatively, the assembled magnet-shunted system 10 may be disposed over, on or around an electric device (not shown in the figure) which may emanate the EM waves. As the extrinsic EM waves impinge on the path member 30, at least portions of their MFs and MWs may be rerouted into the path member 30, thereby bypassing the device. Once contained inside the path member 30, the accumulated MFs and MWs propagate through the path member 30 toward the magnetic sink which is the S pole of the magnet member 20. In addition, because the shunt member 40 is arranged to enclose the device, at least a substantial portion of MFs and MWS of EM waves generated by the device also impinge upon the path member 30, are rerouted into the path member 30, and then are eliminated in the S pole of the magnet member 20. At the same time, the shunt member may 40 reroute the intrinsic MFs generated by the magnet member 20 thereby, while maintaining the MF strength on its exterior surface 12 below the preset limit. Accordingly, the magnet-shunted system 10 protects the target device from the extrinsic MFs and MWs in order to ensure normal operations of such a device, protects an user of the device by preventing the MFs and MWs of the EM waves of the device from penetrating the shunt member 40, and prevents the intrinsic MFs of the magnet member 20 from propagating away from the shunt member 40, thereby preventing all of the rerouted MFs and MWs of various MFs and EM waves from penetrating the path member 30 to propagate toward the target. It is to be understood that such a portion of the path member 30 which is temporarily magnetized by the magnet member 20 can distort contour of the extrinsic MFs and MWs theretoward and reroute the distorted MFs and MWs thereinto, thereby rerouting more MFs and MWs than otherwise.

Another exemplary embodiment of this aspect of the invention is described in FIG. 3B which is a perspective view of an exemplary magnet-shunted system including a path member which indirectly couples with a magnet member, where an edge of the system is cut away for illustration according to the present invention. An exemplary magnet member 20 and shunt member 40 are similar to those of FIG. 3A. Such a shunt member 40, however, may not define a slit along its side but instead include at least one coupler 46 which may be shaped and sized to receive one end of a path member 30 in order to physically couple with the path member 30. Because such a shunt member 40 has a high magnetic permeability, the path member 30 magnetically couples with the magnet member 20 indirectly through the shunt member 40. Other than the indirect magnetic coupling between the magnet member 20 and path member 30 through the shunt member 40, other configurational and operational characteristics of the system 10 of FIG. 3B are similar or identical to those of the system of FIG. 3A.

Another exemplary embodiment of this aspect of the invention is described in FIG. 3C which is a perspective view of an exemplary magnet-shunted system having a shunt member which includes a filler defining an exterior surface thereof, where an edge is cut away for illustration according to the present invention. An exemplary magnet member 20 and path member 30 are similar to those shown in FIG. 3B and magnetically couple with each other indirectly through through a coupler (not shown in the figure) or directly through a slit (not shown in the figure) of a shunt member 40. However, at least or an entire portion of the shunt member 40 is enclosed or covered by a filler 44 of a preset thickness which may be uniform or vary from location to location. Such a filler 44 may be an additional layer of a different or identical magnetically permeable material, of another material having a preset mechanical strength and capable of mechanically protecting the magnet member 20 from external impact, of yet another inert material capable of preventing an user from direct contact with the shunt member 40 in case the shunt member 40 includes a material which may cause skin allergy or irritation, and the like. Other than the filler 46 for the shunt member 40, other configurational and operational characteristics of the system 10 of FIG. 3C are similar or identical to those of the systems of FIGS. 3A and 3B.

In another aspect of the present invention, an exemplary magnet-shunted system may include at least one magnet member and at least one shunt member, without or with at least one optional path member magnetically coupling with the magnet and/or shunt members. FIGS. 3D to 3G are top views of exemplary magnet-shunted systems each of which includes a shunt member and an optional path member according to the present invention.

One exemplary embodiment of such an aspect of the invention is described in FIG. 3D which is a perspective view of an exemplary magnet-shunted system including a magnet member and a shunt member according to the present invention. As shown in the figure, an exemplary system 10 may not include any path member, while its magnet and shunt members 20, 40 are similar or identical to those of FIGS. 3A to 3C. Because the system 10 does not have the path member, the shunt member 40 may neither define any slit of FIG. 3A thereon nor incorporate any coupler of FIG. 3B thereto. This system 10 may be best used when an existing article or device includes at least one portion which may have high magnetic permeability and may reroute the MFs and MWs of the extrinsic EM waves and/or MFs and MWs generated thereby thereinto. Then the system 10 is fixedly or releasably incorporated into the device in order to form direct or indirect magnetic coupling between its magnet member 20 and the magnetically permeable portion of the device. Such a system 10 may also be used to provide a static MF therearound when, e.g., the static MFs of the Earth are rerouted into the shunt member 40 of such a system 10 along with the MFs and MWs of the extrinsic EM waves and a magnetic vacuum is to be created around the user. To effectively generate the static MFs, such magnet and shunt members 20, 40 may be arranged to have specific shapes and/or sizes, to expose one type of poles more than the other type of poles, and so on, as will be described in greater detail below. Other configurational and operational characteristics of the system 10 of FIG. 3D are similar or identical to those of the systems of FIGS. 3A to 3C.

Another exemplary embodiment of this aspect of the invention is described in FIG. 3E which is a perspective view of an exemplary magnet-shunted system including multiple path members coupling to a magnet member and a shunt member according to the present invention. Such a magnet member 20 and shunt member 40 are generally similar to those of FIGS. 3A to 3D, while multiple path members 30 may be magnetically coupled to the magnet member 20 by direct physical contact therewith and/or indirectly through the shunt member 40. The path members 30 may be disposed around the magnet or shunt member 20, 40 in various arrangements, where four path members 30 are disposed around the square shunt member 40 in this embodiment. It is appreciated that multiple path members 30 of such a system 10 may be magnetically coupled to a single or multiple poles of the magnet member 20 defining the same polarity or, alternatively, at least one of the path members 30 may be magnetically coupled to a pole of one polarity while the rest of the path members 30 may magnetically couple with one or more poles of an opposite polarity. Other configurational and operational characteristics of the system 10 of FIG. 3E are similar or identical to those of the systems of FIGS. 3A to 3D.

Another exemplary embodiment of this aspect of the invention is described in FIG. 3F which is a perspective view of an exemplary magnet-shunted system including a magnet member and a shunt member surrounded by multiple path members forming a net, mesh or screen according to the present invention. A magnet member 20 and a shunt member 40 are similar to those of FIGS. 3A to 3E, while multiple path members 30 are arranged in a shape of a net, mesh, screen, fabric, garment, and/or any other interwoven arrangements. Such path members 30 may be magnetically coupled to the poles of the same or opposite polarities in various arrangements. For example, all of the path members 30 may be magnetically coupled to a single or multiple poles of the same polarity or, in the alternative, at least one of the path members 30 may be magnetically coupled to a pole of one polarity while the rest of the path members 30 may magnetically couple with one or more poles of an opposite polarity. In another alternative, all horizontal path members 30 may magnetically couple with one or more poles having one polarity, while all vertical path members 30 may be magnetically coupled to one or more poles having an opposite polarity. In addition, the horizontal and vertical path members 30 may instead magnetically couple to different poles arranged in an alternating mode such that at least substantial portions of the path members 30 may be coupled to opposite poles in the alternating mode. It is to be understood that an efficiency in rerouting the MFs and MWs by such a system 10 may depend on a spacing between the horizontal and vertical path members 30, magnetic permeability of such path members 30, strength of the MFs temporarily imparted to the path members 30 by the magnet member 20, and the like, where detailed design of such path members 30 and selection of suitable materials therefor may generally be a matter of choice of one of ordinary skill in the relevant art. Other configurational and/or operational characteristics of the system 10 of FIG. 3F are similar or identical to those of the systems of FIGS. 3A through 3E.

Another exemplary embodiment of this aspect of the invention is described in FIG. 3G which is a perspective view of an exemplary magnet-shunted system including a magnet member and a shunt member which are embedded between or inside a path member according to the present invention. A magnet member 20 and a shunt member 40 are typically similar to those of FIGS. 3A to 3F but shaped as a flat or planar article defining a finite thickness. A path member 30 is similarly shaped as a planar or flat article with a preset thickness and arranged to receive the magnet and shunt members 20, 40 between its upper and lower surfaces, through a groove or an indentation provided on the upper or lower surfaces thereof, on its upper or lower surfaces, and the like. Accordingly, the MFs and MWs rerouted into such a path member 30 are readily guided along the path member 30 toward the magnet member 20 in which the MFs and MWs terminate their propagation at one magnetic pole of the magnet of the magnet member 20. Other configurational and operational characteristics of the system 10 of FIG. 3G are similar or identical to those of the systems of FIGS. 3A to 3F.

It is appreciated in each of FIGS. 3A to 3G that only a portion of each magnet-shunted system may be displayed for ease of illustration. For example, the displayed magnet member may correspond to only a portion of a bigger magnet member, to only a single layer of a magnet member having multiple layers of magnets disposed one over the other or side by side, to only a planar portion of a bigger and curvilinear magnet member, and the like. Similarly, the displayed path member may correspond to only a selected portion of a bigger and/or thicker path member, to only one of multiple path members which are disposed one over the other or side by side, to only a flat portion of a bigger and curvilinear path member, and so on. By the same token, the shunt member may correspond to only a selected portion of a bigger and/or thicker shunt member, to only one of multiple shunt members disposed one over the other or side by side, to only a flat portion of a bigger and curvilinear shunt member, and so on. Any of the above magnet, path, and shunt members of the magnet-shunted systems may also be provided in different physical and/or magnetic configurations, in different numbers, and/or in different coupling modes, where details of such members will now be provided in reference to accompanied figures.

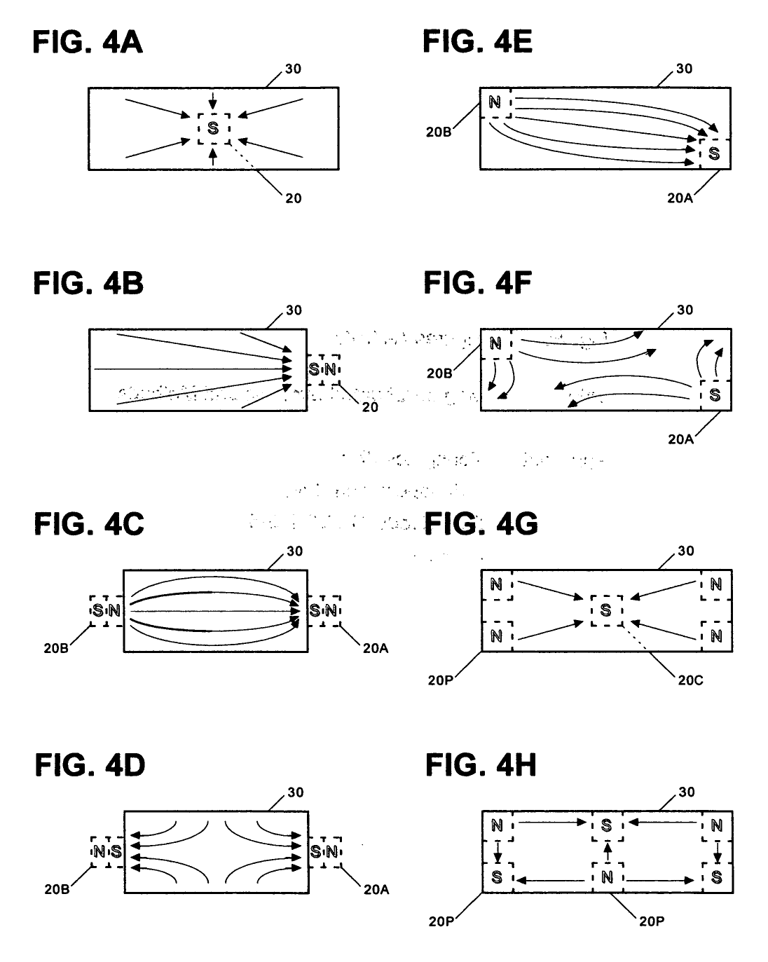

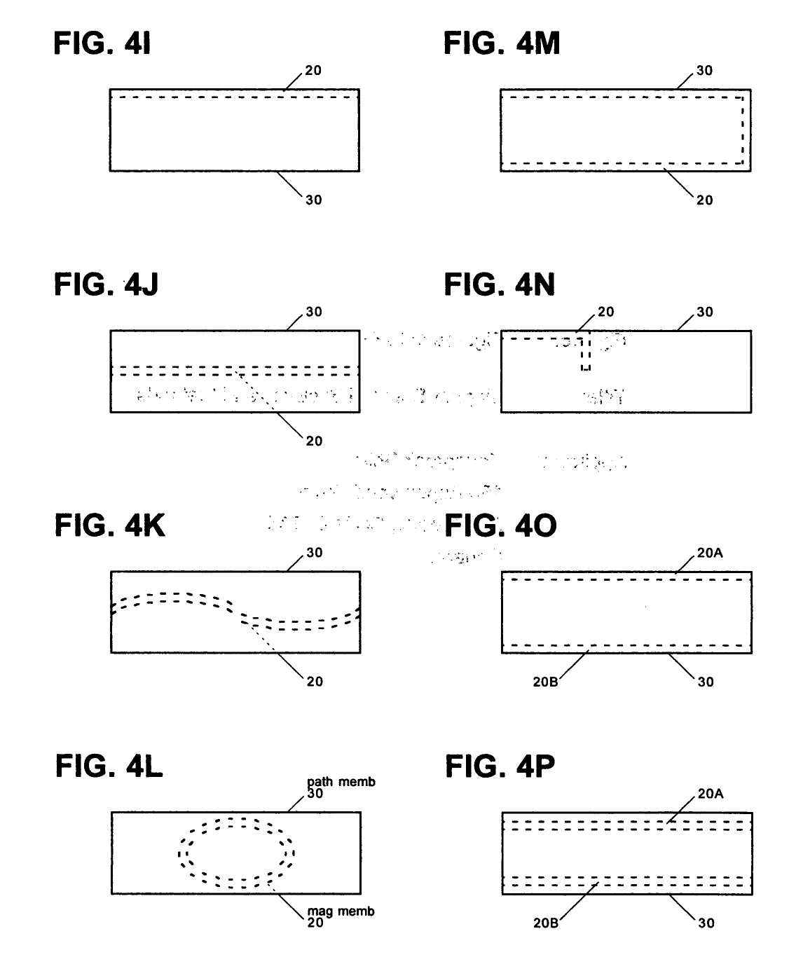

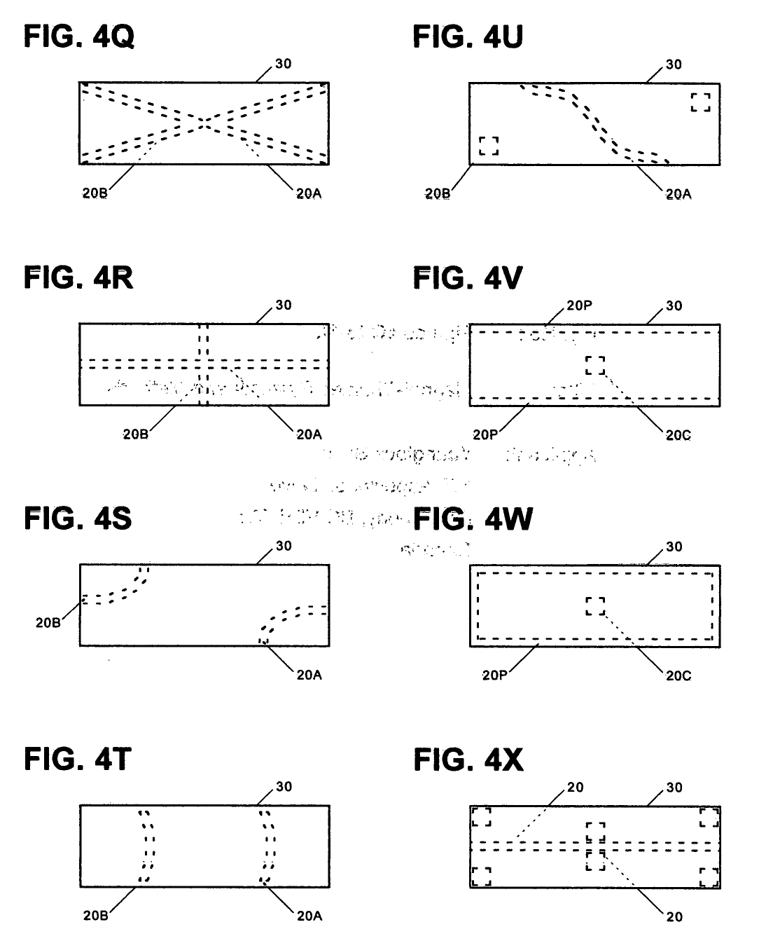

In another aspect of the present invention, an exemplary magnet-shunted system may include a variety of path members each of which may couple with a preset number of magnet members each of which may or may not be enclosed by at least one shunt member. FIGS. 4A to 4H are top views of exemplary path members each of which has a preset number of magnet members defining polarities in a preset arrangement according to the present invention. It is appreciated that each of FIGS. 4A to 4H may represent only a portion of the magnet-shunted system for ease of illustration. Accordingly, such a depicted portion of the path member may correspond to only a selected portion of a bigger or thicker path member, to only one of multiple path members which are disposed one over the other or side by side, to only a flat portion of a bigger and curvilinear path member, and the like. Similarly, the depicted portion of the magnet member may correspond to only a portion of a bigger magnet member, to only a single layer of a magnet member which have multiple layers of permanent magnets or electromagnets disposed one over the other or side by side, to only a planar portion of a bigger and curvilinear magnet member, and the like.

In one exemplary embodiment of this aspect of the invention, a path member may couple with a magnet member in its interior. FIG. 4A is a top view of such an exemplary path member 30 which may couple with a magnet member 20 disposed over its upper surface, below its lower surface, between its upper and lower surfaces, and the like. In this embodiment, the S pole of the magnet member 20 is arranged to magnetically couple with the path member 30. Thus, at least a portion of the path member 30 may then be temporarily magnetized to the same polarity and attract the MFs and MWs accumulated in the path member 30 thereto. Although the magnet member 20 may seem to be disposed in a center of the path member 30, the former 20 may in fact be disposed much doser to one edge of the latter 30 depending upon which portion of the entire path member 30 may be described in the figure.

In operation, the path member 30 may be provided in the shape and size described in the figure or, in the alternative, a portion of a bigger or wider path member 30 may be cut into the shape and size of the figure. The magnet member 20 may then be disposed over, below or along the path member 30 of the shape and size shown in FIG. 3A, thereby temporarily magnetizing at least a portion of the path member 30, specifically the portion closer to the magnet member 20. When the extrinsic or secondary MFs and MWs impinge upon the path member 30, such MFs and MWs may be accumulated in the path member 30 and then guided to the magnet member 20 therealong. Once reaching the magnet member 20, the MFs and MWs may then be absorbed into the S pole of the magnet member 20 and terminate its propagation thereat.

In another exemplary embodiment of this aspect of the present invention, such a path member may couple with a magnet member along one or more of its edges. FIG. 4B shows a top view of such an exemplary path member 30 which may couple with a magnet member 20 disposed on or along one or more of its edges. In this embodiment, the S pole of the magnet member 20 is similarly arranged to magnetically couple with the path member 30 so that at least a portion of the path member 30 may then be temporarily magnetized to the same polarity and attract the MFs and MWs accumulated in the path member 30 thereto. Although the magnet member 20 may seem to be disposed on a right edge of the path member 30, the former 20 may in fact be disposed along a top, bottom or left edge of the latter 30 depending upon which orientation the path member 30 may be described in the figure. Such a magnet member 20 may also couple with other path members on its other sides. Other configurational and/or operational characteristics of the members of FIG. 4B are similar or identical to those of the members of FIG. 4A.

In another exemplary embodiment of this aspect of the present invention, such a path member may couple with a pair of magnet members disposed on its opposing edges. FIG. 4C is a top view of such an exemplary path member 30 coupling with a pair of magnet members 20A, 20B which may be disposed on right and left edges of the path member 30. More particularly, the magnet members 20A, 20B may couple with the path member 30 with different poles thereof so that the path member 30 may be temporarily magnetized and create a MF from left to right. In a related exemplary embodiment, FIG. 4D is a top view of another exemplary path member 30 coupling with a pair of magnet members 20A, 20B which may be disposed in similar or identical positions as those exemplified in FIG. 4C but with the same poles thereof. Accordingly, the magnet members 20A, 20B generate a MF which is symmetric along a vertical axis and pointing toward each S pole thereof. As a result, the extrinsic or secondary MFs and MWs may be guided to either S pole depending upon its location of impinging upon the path member. Other configurational and/or operational characteristics of the members of FIGS. 4C and 4D are similar or identical to those of the members of FIGS. 4A and 4B.

In another exemplary embodiment of this aspect of the present invention, such a path member may couple with a pair of magnet members disposed on its opposing corners. FIG. 4E is a top view of such an exemplary path member 30 coupling with a pair of magnet members 20A, 20B which may be disposed on a top-left corner and a bottom-right corner of the path member 30. More particularly, the magnet members 20A, 20B may couple with the path member with different poles thereof so that the path member 30 may be temporarily magnetized and generate a MF from top-left to bottom-right. In a related embodiment, FIG. 4F is a top view of such an exemplary path member 30 coupling with a pair of magnet members 20A, 20B which may be disposed in similar or identical positions as those shown in FIG. 4E but with the same poles thereof. Therefore, the magnet members 20A, 20B generate a MF which is symmetric along a diagonal and pointing toward each S pole thereof. Therefore, the extrinsic or secondary MFs and MWs may be guided to either S pole depending upon its location of impinging on the path member 30. Other configurational and/or operational characteristics of the members of FIGS. 4E and 4F are similar or identical to those of the members of FIGS. 4A to 4D.

In another exemplary embodiment of this aspect of the present invention, such a path member may couple with multiple magnet members disposed in an interior, edges, and/or corners thereof. FIG. 4G is a top view of such an exemplary path member 30 coupling with one center magnet member 20C as well as four peripheral magnet members 20P disposed on each corner thereof. More specifically, the center magnet member 20C may couple with the path member 30 with the S pole, while the rest of the peripheral magnet members 20P may couple with the path member 30 with their N poles so that the path member 30 may be temporarily magnetized by a MF which points inwardly 360° about the center magnet member 20C. In a related embodiment, FIG. 4H depicts a top view of another exemplary path member 30 coupling with multiple peripheral magnets disposed along the edges and/or corners of the path member 30. It is appreciated that such magnets 20P may preferably be arranged to couple with the path member 30 in an alternating mode both in horizontal and vertical directions. Accordingly, the path member 30 may be temporarily magnetized while defining multiple concentric MFs each of which may point inwardly 180° about each S pole of the magnet members 20P. Other configurational and/or operational characteristics of the members of FIGS. 4G and 4H are similar or identical to those of the members of FIGS. 4A to 4F.

As described hereinabove, the path members of FIGS. 4A through 4H may correspond to only portions of bigger and/or wider path members and that the rest of such path members may include the same or similar portions repeated across the rest thereof. Even so, it is to be understood that the path members of FIGS. 4C through 4H may operate in smaller units when divided into two or more units and when each of such units may include at least one magnet member therein or a portion of the member. It is appreciated that, while the path members of FIGS. 4A to 4C, 4E, and 4G generate the MFs defined in an unidirectional direction, the path members of FIGS. 4D, 4F, and 4H generate multiple MFs defined along different or opposite directions. Considering that the MFs and MWs may propagate in opposite directions, it is generally preferred that the path members define multiple MFs in different directions to better attract the fluctuating MFs and MWs of such extrinsic and secondary EM waves. It is also to be understood that the path members generating the unidirectional MFs may also be used in multiple and arranged in such a way that the path members may generate the MFs in different directions, thereby better attracting the fluctuating MFs and MWs of the extrinsic and secondary EM waves with different path members.

In another aspect of the present invention, an exemplary magnet-shunted system may include various path members each of which may couple with a preset number of elongated magnet members each of which may or may not be enclosed by at least one shunt member. FIGS. 4I to 4X describe top views of exemplary path members each including a preset number of magnet members with polarities in a preset arrangement according to the present invention. Similar to those of FIGS. 4A to 4H, each of FIGS. 4I through 4X may describe only a portion of the magnet-shunted system for ease of illustration. Accordingly, such a depicted portion of the path member may correspond to only a selected portion of a bigger or thicker path member, to only one of multiple path members disposed one over the other or side by side, to only a flat portion of a bigger or curvilinear path member, and so on. Similarly, such a depicted portion of the magnet member may correspond to only a portion of a bigger magnet member, to only a single layer of a magnet member which may include multiple layers of permanent magnets or electromagnets disposed one over the other or side by side, to only a planar portion of a bigger and/or curvilinear magnet member, and the like. It is appreciated that, in contrary to those magnet members of FIGS. 4A to 4H which may be deemed as point sources, the magnet members of FIGS. 4I to 4X may be deemed to define elongated bodies which may have at least one characteristic dimension which may be comparable or longer than shorter or shortest dimension of such path members. Accordingly, the path members of FIGS. 4I to 4X may also operate in smaller units when divided or cut into two or more units because each of such units may include at least a portion of the elongated magnet members. It is also appreciated that the magnet members of FIGS. 4I to 4X may have any polarity therealong or any distribution of polarities and, accordingly, that such magnet members may not be designated with any particular polarity.

In one exemplary embodiment of this aspect of the present invention, such a path member may couple with an elongated magnet member along one or more of its edges. FIG. 4I shows a top view of such an exemplary path member 30 which may couple with an elongated magnet member 20 along its top or bottom edge. More particularly, the magnet member 20 may be fabricated as an elongated linear strip and may be either releasably or fixedly coupled to the top edge of the path member, either on top of, below or along the top edge thereof. Depending upon the polarity of the magnet member 20, those portions of the path member 30 in proximity of the magnet member 20 may be temporarily magnetized and generate a MF to attract the extrinsic and/or secondary MFs and MWs.

In operation, the path member 30 may be provided in the shape and size described in the figure or, in the alternative, a portion of a bigger or wider path member 30 may be cut into the shape and size of the figure. It is appreciated that such a portion may be cut rather vertically such that the cutaway portion may include at least a portion of the magnet member 20, thereby temporarily magnetizing such a cutaway portion of the path member 30. As the extrinsic or secondary MFs and MWs impinge upon the path member 30, such MFs and MWs may be accumulated in the path member 30 and then guided to the magnet member 20 therealong. Once reaching the magnet member 20, such MFs and MWs may then be absorbed into one of the poles of the magnet member 20 and terminate its propagation thereat. Other configurational and/or operational characteristics of the members shown in FIG. 4I are similar or identical to those of the members of FIGS. 4A to 4H.

In another exemplary embodiment of this aspect of the present invention, such a path member may couple with a magnet member along its interior. FIG. 4J is a top view of such an exemplary path member 30 which may couple with a linear elongated magnet member 20 along a center portion of its interior, where the magnet member 20 may be generally similar to that of FIG. 41. Although the magnet member 20 may seem to be disposed in a center of the path member 30, the former 20 may in fact be disposed much closer to one edge of the latter 30 depending upon which portion of the path member 30 may be described in the figure. In a related embodiment, such a path member may similarly couple with a curved magnet member along its edge and/or in its interior. FIG. 4K shows a top view of such an exemplary path member 30 which may couple with a magnet member 20 along a center portion of its interior similar to that of FIG. 4J, except that at least a portion of the magnet member 20 may instead be curved. Other configurational and/or operational characteristics of such members of FIGS. 4J and 4K are similar or identical to those of the members of FIGS. 4A to 4I.

In another exemplary embodiment of this aspect of the present invention, such a path member may couple with a magnet member which may enclose a preset portion of the path member. FIG. 4L shows a top view of such an exemplary path member 30 which may couple with a concentric magnet member 20 in its interior and/or along at least one of its edges. Depending upon detailed arrangements of the poles of the magnet member 20, such an enclosed portion of the path member 30 may have the polarity which may be identical or opposite to the polarity of the remaining portion of the path member 30. Other configurational and/or operational characteristics of the members of FIG. 4L may be similar or identical to those of the members of FIGS. 4A to 4K.

In another exemplary embodiment of this aspect of the present invention, such a path member may couple with a magnet member which may extend in multiple directions along and/or across such a path member. FIG. 4M is a top view of such an exemplary path member 30 which may couple with an elongated magnet member 20 a first portion of which is disposed along one edge, a second portion of which is disposed along an opposite edge, and a third portion of which is arranged to connect the first and second portions. In a related embodiment, FIG. 4N is a top view of such an exemplary path member 30 which may couple with a magnet member 20 a first portion of which may be disposed on one edge and a second portion of which may extend in a transverse direction. Other configurational and/or operational characteristics of the members of FIGS. 4M and 4N are similar or identical to those of the members of FIGS. 4A to 4L.

In another exemplary embodiment of this aspect of the present invention, such a path member may couple with multiple elongated magnet members disposed in an interior and/or along edges of the path member. FIG. 40 is a top view of such an exemplary path member 30 which may couple with a pair of magnet members 20A, 20B which may be disposed along opposing edges of the path member 30 and which may also be similar or identical to that of FIG. 41. In a related embodiment, FIG. 4P shows a top view of such an exemplary path member 30 which may couple with a pair of magnet members 20A, 20B which may be disposed parallel to each other along the interior of the path member 30 and may be similar or identical to that of FIG. 4J. In another related embodiment, FIG. 4Q shows a top view of such an exemplary path member 30 which may have multiple magnet members 20A, 20B extending across the path member 30 diagonally or at a nonzero angle. Accordingly, the magnet members 20A, 20B may intersect each other in the interior and/or on the edges of the path member 30 as exemplified in the figure or, in the alternative, may be disposed at least substantially parallel to each other. In yet another related embodiment, FIG. 4R is a top view of such an exemplary path member 30 which may couple to a pair of magnet members 20A, 20B one of which may extend at least substantially parallel to edges of the path member 30 and the other of which may intersect the parallel magnet member 20A at right angles. Other configurational and/or operational characteristics of the members of FIGS. 4O to 4R are similar or identical to those of the members of FIGS. 4A to 4N.

In another exemplary embodiment of this aspect of the present invention, such a path member may couple with one or more magnet members which may be elongated along a curvilinear contour. FIG. 4S is a top view of such an exemplary path member 30 which may couple with a pair of magnet members 20A, 20B which may be disposed in opposite corners of the path member 30. In particular, each magnet member 20A, 20B may define a shape of a quarter-circle and be disposed symmetrically with respect to a center of the path member 30. In a related embodiment, FIG. 4T shows a top view of such an exemplary path member 30 which may couple to a pair of arcuate magnet members 20A, 20B extending across at least substantial portions of top and bottom edges of the path member 30. In yet another related embodiment, FIG. 4U is a top view of such an exemplary path member 30 which may couple with a S-shaped magnet member 20A and multiple corner magnet members 20B. The curved magnet member 20A extends across top and bottom edges of the path member 30, while the corner magnet members 20B are generally similar to those shown in FIGS. 4A to 4H and disposed in opposing corners of the path member 30. It is appreciated that such curved magnet members of these figures may also have other shapes such as portions of circles, ellipses, and other curvilinear configurations. Other configurational and/or operational characteristics of such members of FIGS. 4S to 4U are similar or identical to those of the members of FIGS. 4A to 4R.

In another exemplary embodiment of this-aspect of the present invention, such a path member may couple with at least one elongated magnet member as well as at least one magnet member of the point-source type. FIG. 4V is a top view of such an exemplary path member 30 which may couple to a pair of linear, elongated, and peripheral magnet members 20P and to a center magnet member 20C. The peripheral magnet members 20P are generally similar to those of FIG. 4P, while the center magnet 20C may be any of those of FIGS. 4A through 4H. The center magnet 20C may be disposed at equal distances from the peripheral magnets 20P or may be closer to one of the peripheral magnets 20P. In a related embodiment, FIG. 4W is a top view of such an exemplary path member 30 which may couple with a peripheral magnet 20P and a center magnet 20C. Such a peripheral magnet 20P may enclose an entire portion of the path member 30 or the portion thereof displayed in the figure, somewhat similar to that shown in FIG. 4M. The center magnet 20C may be any of those of FIGS. 4A to 4H, disposed at equal distances from such peripheral magnets 20P or closer to one of the peripheral magnets 20P. In another related embodiment, FIG. 4X is a top view of such an exemplary path member 30 which may couple with a horizontally extending magnet member 20 and multiple magnet members 20 of the point-source type. It is appreciated in all of these embodiments of FIGS. 4V to 4X that almost any cutaway portions of the path member 30 may have at least one magnet member 20 or at least a portion thereof so that the MFs and MWs accumulated in the path member may 30 may be removed therefrom by one pole of the magnet member 30. Other configurational and operational characteristics of the members of FIGS. 4V to 4X are similar or identical to those of the members of FIGS. 4A to 4U.

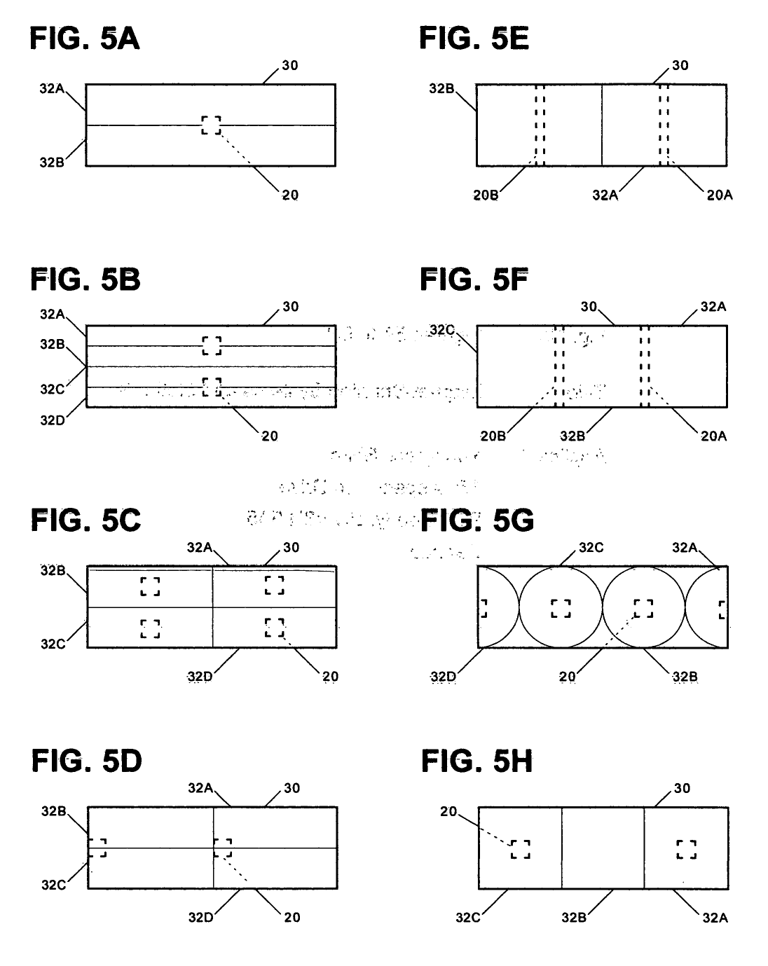

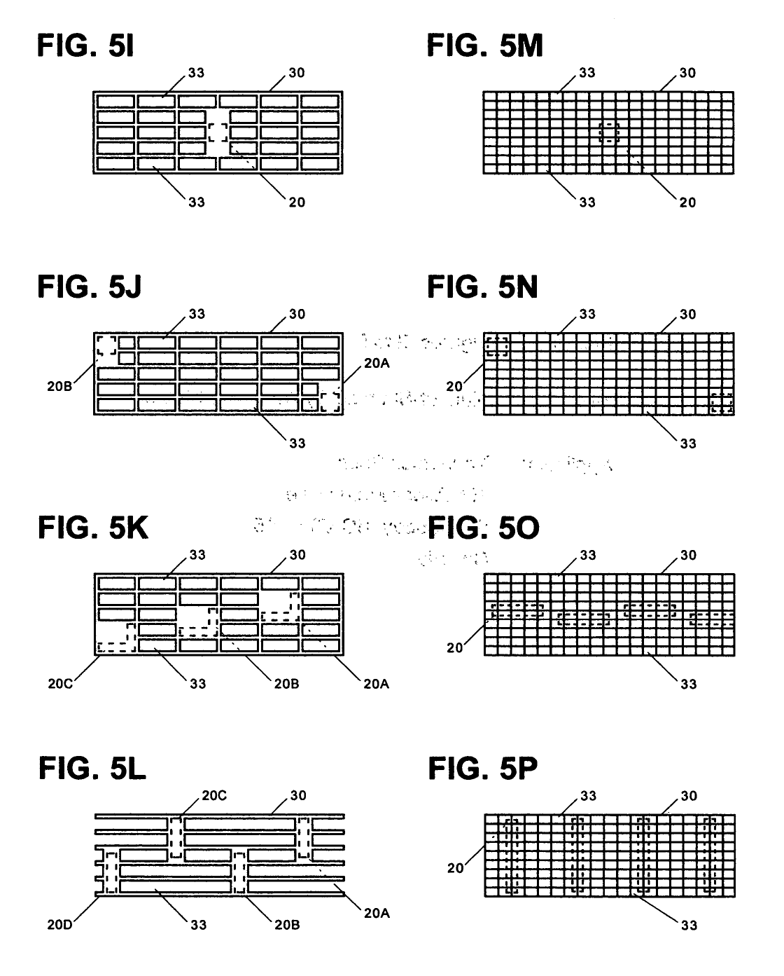

In another aspect of the present invention, an exemplary magnet-shunted system may include a path member defining therealong multiple segments each of which may couple with a preset number of magnet members which may or may not be enclosed by at least one shunt member. FIGS. 5A to 5H are top views of exemplary path members each of which has a preset number of segments coupling with a preset number of magnet members defining polarities in a preset arrangement according to the present invention. It is to be understood that each of FIGS. 5A to 5H may show only a portion of such a magnet-shunted system for ease of illustration. Therefore, the depicted portion of the path member may correspond to only a selected portion of a bigger or thicker path member, to only a few of multiple segments of the path member which are disposed one over the other and/or side by side, to only one of multiple path members which may be disposed vertically or laterally, to only a flat portion of a bigger and/or curvilinear path member, and the like. Similarly, the depicted portion of the magnet member may represent only a portion of a bigger magnet member, to only a single layer of a magnet member which have multiple layers of permanent magnets or electromagnets disposed one over the other or side by side, to only a planar portion of a bigger and curvilinear magnet member, and the like.

In one exemplary embodiment of this aspect of the present invention, such a path member may include a pair of segments each extending along a length of the path member. FIG. 5A is a top view of such an exemplary path member 30 with a pair of segments 32A, 32B which may extend laterally and may be parallel to each other. A single magnet member 20 may then be disposed in a border of those two segments 32A, 32B so that the segments 32A, 32B may be temporarily polarized by the same or different poles of the magnet member 20, depending upon arrangement and/or orientation of the poles of the magnet member 20. In a related embodiment, FIG. 5B shows a top view of such an exemplary path member 30 which defines four parallel segments 32A-32D along a lateral direction. Two magnet members 20 are then disposed in borders of each pair of the segments 32A-32D so that the segments 32A-32D may be temporarily magnetized in various combinations such as, e.g., N-N-N-N, S-S-S-S, N-S-S-S, N-S-S-S, and the like. It is appreciated in both of such embodiments that multiple segments may be arranged to have identical shapes and/or sizes or, in the alternative, at least one of such segments may define a different shape and/or size. In addition, the magnet member may be disposed not along the border but over, below or along one segment, while also temporarily magnetizing the neighboring segment. Other configurational and/or operational characteristics of the members of FIGS. 5A and 5B are similar or identical to those of the members of FIGS. 4A to 4X.

In another exemplary embodiment of this aspect of the present invention, such a path member may include multiple segments arranged in a pattern of a matrix. FIG. 5C shows a top view of such an exemplary path member 30 which defines four segments 32A-32D arranged according to a pattern of 2 by 2 matrix such as, e.g., two upper segments 32A, 32B and two lower segments 32C, 32D or two left segments 32B, 32C and two right segments 32A, 32D. Each segment 32A-32D also couples with one magnet member 20 disposed in each center portion so that such a path member 30 may exhibit a variety of polarity distributions, depending on arrangements and/or orientation of the magnet members 20. In a related embodiment, FIG. 5D shows a top view of such an exemplary path member 30 which also includes multiple segments 32A-32D as exemplified in FIG. 5C but couples with only two magnet members 20 which are disposed on borders of each pair of segments 32A and 32D, 32B and 32C. Therefore, the path member 30 may similarly have various polarity distributions. Other configurational and/or operational characteristics of the members of FIGS. 5C and 5D are similar or identical to those of the members of FIGS. 4A to 4X and FIGS. 5A and 5B.

In another exemplary embodiment of this aspect of the present invention, such a path member may include multiple segments each extending along a height of such a path member. FIG. 5E is a top view of such an exemplary path member 30 which defines a pair of laterally adjoining segments 32A, 32B. Vertically elongated magnet members 20A, 20B are disposed across the segments 32A, 32B so that at least portions adjacent thereto may be temporarily magnetized. The magnet members 20 may magnetize the segments 32A, 32B to the same or different polarities. In a related embodiment, FIG. 5F is a top view of such an exemplary path member 30 which may couple with a pair of magnet members 20A, 20B and, therefore, may be divided into three segments 32A-32C disposed side by side. Similar to those of FIG. 5E, such segments 32A-32C may be temporarily magnetized in various arrangements. Other configurational and/or operational characteristics of the members of FIGS. 5E and 5F are similar or identical to those of the members of FIGS. 4A to 4X and FIGS. 5A to 5D.

In another exemplary embodiment of this aspect of the present invention, such a path member may define multiple segments each defining a round or circular shape and disposed side by side. FIG. 5G is a top view of such an exemplary path member 30 which defines a series of laterally disposed segments 32A-32D adjoining each other. Multiple magnet members 20 may be coupled to each of the segments 32A-32D in its center portion. It is appreciated that portions of the path member 30 defined outside such segments 32A-32D may also serve as individual segment, although they may not include any magnet members. In a related embodiment, FIG. 5H shows a top view of such an exemplary path member 30 which defines a series of laterally disposed segments 32A-32C adjoining each other. The segments 32A-32C generally define rectangular or square shapes and couple with magnet members 20 in their center portions. It is to be understood that the second segment 32B may not couple to any magnet member but may similarly be temporarily magnetized by the magnet members 20 through such adjacent segments 32A, 32C. Other configurational and/or operational characteristics of the members of FIGS. 5G and 5H may be similar or identical to those of the members of FIGS. 4A to 4X and FIGS. 5A to 5G.

In another aspect of the present invention, an exemplary magnet-shunted system may include a path member which may define multiple openings or voids thereon and couple with a preset number of magnet members which may or may not be enclosed by at least one shunt member. FIGS. 5I to 5P describe top views of exemplary path members which define shapes of screens and each of which includes a preset number of magnet members according to the present invention. It is appreciated that each of FIGS. 5I to 5P may show only a portion of the magnet-shunted system for ease of illustration. Accordingly, the depicted portion of the path member may correspond to only a selected portion of a bigger or thicker path member, to only one of multiple path members which may be disposed vertically or laterally, to only a flat portion of a bigger and/or curvilinear path member, and the like. Similarly, the depicted portion of the magnet member may also represent only a portion of a bigger magnet member, to only a single layer of a magnet member which may include multiple layers of permanent magnets or electromagnets which may be disposed vertically or laterally, to only a planar portion of a bigger and curvilinear magnet member, and so on. It is also appreciated that such path members may define such openings with various shapes other than rectangular or square ones exemplified in those figures.

In one exemplary embodiment of this aspect of the present invention, such a path member may have multiple openings arranged along a length and/or height of the path member and coupling with at least one magnet member disposed thereover, thereunder or therealong. FIG. 5I is a top view of such an exemplary path member 30 which defines multiple rectangular openings 33 arranged vertically and horizontally across at least a portion thereof. Such a path member 30 may, therefore, be regarded to define a shape of a honeycomb, except that its openings 33 may not be hexagons but rectangles. A single magnet member 20 is then coupled to a center portion of the path member 30, where the center portion may be arranged to define smaller openings 33 in order to provide a room for such coupling or to better support the magnet member 20. In a related embodiment, FIG. 5J shows a top view of such an exemplary path member 30 which defines similar rectangular openings 33 but couples with multiple magnet members 20 in preset strategic locations such as, e.g., opposing corners thereof. Therefore, such path members 30 may be temporarily magnetized and define MFs similar to those of FIG. 4A and FIGS. 4E and 4F, respectively. Other configurational and operational characteristics of such members of FIGS. 5I and 5J may be typically similar or identical to those of the members shown in FIGS. 4A to 4X and FIGS. 5A to 5H.

In another exemplary embodiment of this aspect of the present invention, such a path member may define multiple openings arranged along its length and/or height coupling with at least two magnet members disposed thereover, thereunder or therealong according to a preset pattern. FIG. 5K is a top view of such an exemplary path member 30 which forms similar rectangular openings 33 but couples with multiple L-shaped magnet members 20A-20C each of which may be similar or identical to that of FIG. 4N. Such magnet members 20A-20C may be disposed in an uniform distance laterally but may be disposed in different heights or elevations, e.g., in an ascending mode as exemplified in the figure. In a related embodiment, FIG. 5L is a top view of such an exemplary path member 30 which similarly has multiple rectangular openings 33 but couples with multiple bar- or strip-shaped magnet members 20A-20D arranged in a zigzag mode. It is appreciated that such path members 30 may define openings 33 having same or different lengths, widths, heights, and so on. Other configurational and/or operational characteristics of the members of FIGS. 5K and 5L are similar or identical to those of such members of FIGS. 4A to 4X and FIGS. 5A to 5J.

In another exemplary embodiment of this aspect of the present invention, such a path member may define multiple openings along a length and/or length of the path member, where portions of such a path member between the openings may be narrower or thinner than those of FIGS. 5I to 5L. In this context, such a path member may be viewed as a screen or mesh which may not be made, however, by weaving multiple strands of wires but by cutting out portions of the openings from the path member having a shape of a curvilinear plane or sheet. FIG. 5M shows a top view of such an exemplary path member 30 which defines multiple openings 33 horizontally and vertically and couples with a magnet member 20 in its center portion. In a related embodiment, FIG. 5N is a top view of such an exemplary path member 30 which similarly defines multiple openings 33 and couples with two magnet members 20 disposed in opposite corners. It is appreciated that the path members 30 of FIGS. 5M and 5N may be similar or identical to those shown in FIGS. 51 and 5J, respectively, except a ratio of an area of the openings 33 to an area of nonporous skeletons of the path member 30. Other configurational and/or operational characteristics of such members of FIGS. 5M and 5N are similar or identical to those of the members of FIGS. 4A to 4X and FIGS. 5A to 5L.

In another exemplary embodiment of this aspect of the present invention, such a path member may define multiple openings along its length and/or height and couple with multiple magnet members disposed thereover, thereunder or therealong according to a preset pattern. FIG. 5O is a top view of such an exemplary path member 30 which may define similar rectangular openings 33 but couple with multiple bar- or strip-shaped magnet members 20 each of which may be similar or identical to those of FIGS. 4N and 5L. Such magnet members 20 may be disposed in an uniform distance laterally but may be disposed in different heights or elevations, e.g., in a zigzag pattern as exemplified in the figure. In a related embodiment, FIG. 5P is a top view of such an exemplary path member 30 which also defines similar openings 33 but couples with multiple bar- or strip-shaped magnet members 20 which in turn are arranged in a vertical direction, at an uniform distance, and across at least a substantial portion of the height of such a path member 30. Other configurational and/or operational characteristics of such members of FIGS. 5O and 5P may be similar or identical to those of the members of FIGS. 4A to 4X and FIGS. 5A to 5N.

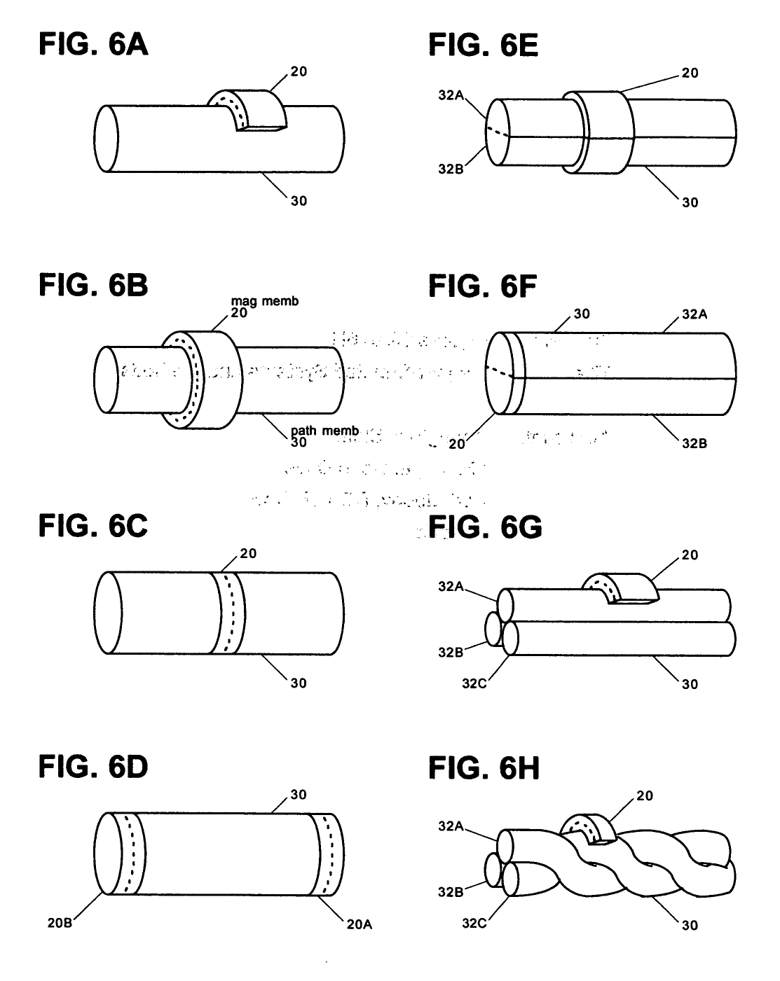

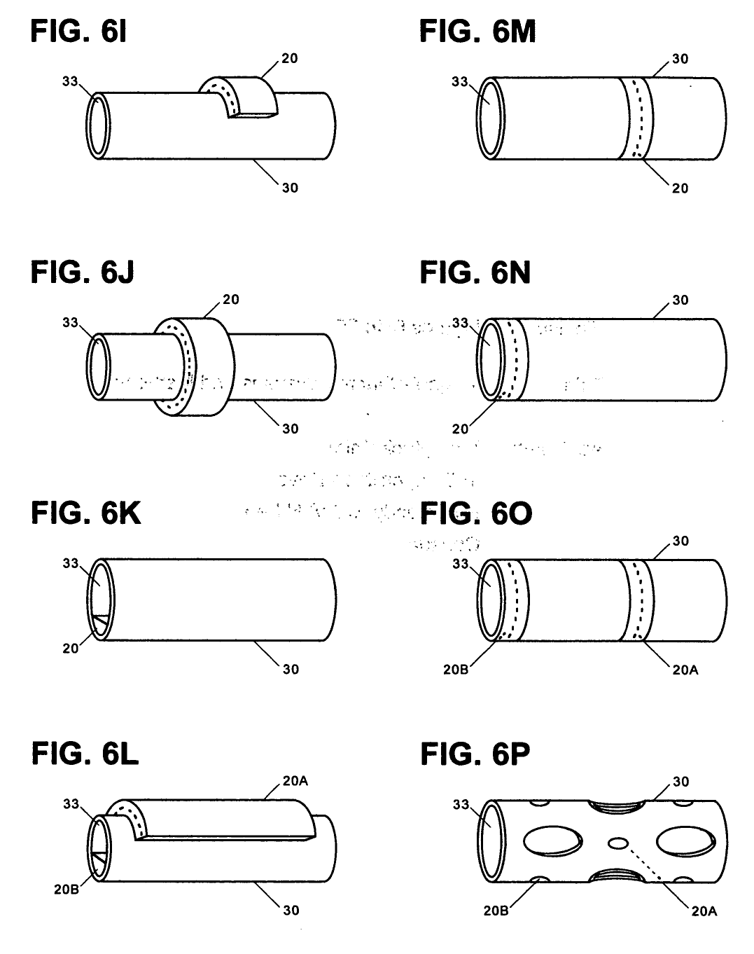

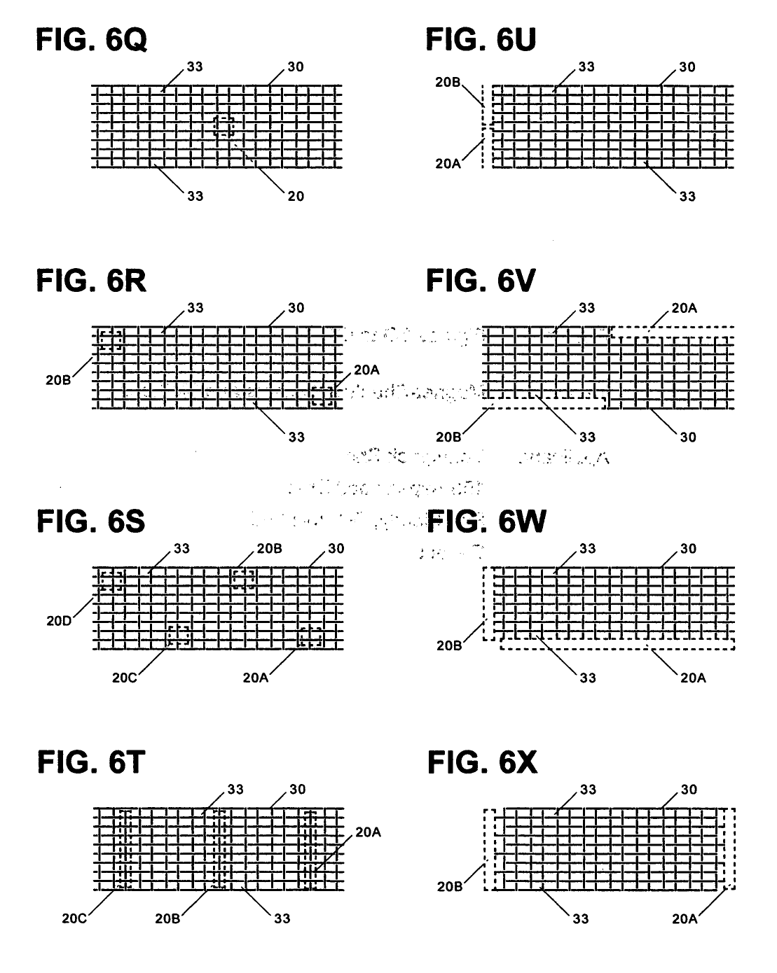

In other aspects of the present invention, exemplary magnet-shunted systems may also have various elongated path members each of which may be shaped and/or sized as, e.g., a fiber, a wire, a strand, a thread, and the like. In one aspect, such path members may be made as a solid fiber, wire, strand, and/or thread as exemplified in FIGS. 6A to 6D which are perspective views of exemplary path members each of which has a shape of an elongated rod and which magnetically couple with one or more magnet members according to the present invention. In another aspect, such path members may be similarly made as a solid fiber, wire, strand, and/or thread with multiple segments as exemplified in FIGS. 6E to 6H which are perspective views of exemplary path members which are similar to those of FIGS. 6A to 6D but includes multiple segments according to the present invention. In another aspect, such path members may instead be made as a hollow fiber, wire, strand, and/or thread having one or multiple segments as exemplified in FIGS. 6I to 6P which depict perspective views of exemplary path members each of which has a shape of an elongated annular or hollow tube and magnetically couple with one or multiple magnet members according to the present invention. It is appreciated that each of FIGS. 6A to 6P may correspond to only a portion of the magnet-shunted system for ease of illustration. Accordingly, such a depicted portion of the path member may correspond to only a selected portion of a bigger or thicker path member, to only one of multiple path members which are disposed horizontally or vertically, to only a flat portion of a bigger and curvilinear path member, and the like. Similarly, such a depicted portion of the magnet member may represent only a portion of a bigger magnet member, to only a single layer of a magnet member which may form multiple layers of permanent magnets and/or electromagnets disposed one over the other or side by side, to only a planar portion of a bigger and curvilinear magnet member, and the like. It is also appreciated that such path members may also have various cross-sectional shapes other than circular ones exemplified in these figures.

In one exemplary embodiment of such aspects of this invention, a path member may consist of a single strand of magnetically permeable materials. FIG. 6A is a top view of such an exemplary path member 30 which may be solid, have a circular cross-section, and extend for a preset length. Such a path member 30 may generally maintain the same cross-section along its length or, in the alternative, may define different cross-sections varying along its length. The path member 30 may couple with a magnet member 20 along only a portion of its periphery. In a related embodiment, FIG. 6B is a top view of such an exemplary path member 30 which is generally similar to that of FIG. 6A but couples with a magnet member 20 along at least a substantial portion of its periphery. As described hereinabove, the magnet member 20 may be arranged to have various pole distributions so that different portions of the path member 30 may be temporarily magnetized to different or identical polarity. Other configurational and/or operational characteristics of such members of FIGS. 6A and 6B are similar or identical to those of the members of FIGS. 4A to 4X and FIGS. 5A to 5P.

In another exemplary embodiment of such aspects of this invention, such a path member may similarly consist of a strand of magnetically permeable materials as FIGS. 6A and 6B but couple with at least one magnet member which may not only encircle but also penetrate at least a portion of the path member. FIG. 6C is a top view of such an exemplary path member 30 which couples with an annular magnet member 20 which penetrates the path member 30 to a preset depth. In this embodiment, such a magnet member 20 may be arranged to have different poles in an axial direction of the path member and to be also flush with the path member 30. Accordingly, portions of the path member 30 disposed on opposite side of the magnet member 20 may be temporarily magnetized to different polarities. In a related embodiment, FIG. 6D shows a top view of such an exemplary path member 30 which is similar to that of FIG. 6C, except that multiple magnet members 20A, 20B may be coupled to opposing ends of a preset length of the path member 30. Thus, such a path member 30 may be temporarily magnetized and generate a MF similar to those of FIG. 4C or 4D. It is appreciated that such magnet members 20 of FIGS. 6C and 6D may also be arranged to extend across an entire cross-section of the path members 30 such that the path member 30 may define at least two segments on different sides of such magnet members 20. Other configurational and/or operational characteristics of the members of FIGS. 6C and 6D are similar or identical to those of the members of FIGS. 4A to 4X, FIGS. 5A to 5P, and FIGS. 6A and 6B.

In another exemplary embodiment of such aspects of this invention, a path member may define multiple segments which may extend along a length of the path member in either a straight or winding mode. FIG. 6E is a top view of such an exemplary path member 30 which consists of a pair of at least substantially symmetric segments 32A, 32B each of which may correspond to one half of a cylinder cut along an axial direction. The path member 30 may then couple with a magnet member 20 enclosing an entire periphery thereof. Contrary to the magnet member of FIG. 6A which may magnetize the path member to a single polarity, the magnet member 30 of this embodiment may define different poles in its opposite halves. By aligning such poles of the magnet member 30 with a demarcation line or a border between such segments 32A, 32B, the path member 30 may be temporarily magnetized into different polarities. In a related embodiment, FIG. 6F is a top view of such an exemplary path member 30 which is similar to that of FIG. 6E but couples with a magnet member 20 on its edge. The magnet member 20 is similarly arranged to define different polarities and to temporarily magnetize different segments 32A, 32B into different polarities. Other configurational and/or operational characteristics of such members of FIGS. 6E and 6F are typically similar or identical to those of the members of FIGS. 4A to 4X, FIGS. 5A to 5P, and FIGS. 6A to 6D.

In another exemplary embodiment of such aspects of this invention, another path member may consist of multiple segments each of which may extend along a length of the path member and which may be disposed close to each other and coupled to each other in either a straight or winding mode. FIG. 6G is a top view of such an exemplary path member 30 which consists of three straight or linear segments 32A-32C coupled to each other in a straight mode. A magnet member 20 may be arranged to couple with at least one segment 32A-32C with the same or different poles and then to temporarily magnetize at least one of the segments 32A-32C. It is appreciated that these segments 32A-32C may be mechanically coupled to each other by the magnet member 20 or by other conventional mechanical coupling therebetween. In a related embodiment, FIG. 6H is a top view of an exemplary path member 30 which consists of three segments 32A-32C which may be interwoven into a helical configuration. A magnet member 20 may couple with at least one segment 32A-32C with the same or different poles and temporarily magnetize at least one of such segments 32A-32C. Such segments 32A-32C may be arranged to retain the helical configuration by themselves but may optionally be coupled to each other at least partially by the magnet member 20. Other configurational and/or operational characteristics of the members of FIGS. 6G and 6H are similar or identical to those of the members shown in FIGS. 4A to 4X, FIGS. 5A to 5P, and FIGS. 6A to 6F.

In another exemplary embodiment of those aspects of this invention, such a path member may consist of a single hollow strand of magnetically permeable materials. FIG. 6I is a top view of such an exemplary path member 30 which may have an annular cross-section, extend for a preset length, and define an opening or lumen 33 therealong. Such a path member 30 may typically maintain the identical cross-section along its length or, in the alternative, may define different cross-sections varying along its length. The path member 30 may couple to a magnet member 20 on its exterior surface along only a portion of its periphery. In a related embodiment, FIG. 6J is a top view of such an exemplary path member 30 which may be generally similar to that of FIG. 6I but couples with a magnet member 20 on its exterior surface along at least a substantial portion of its periphery. As described hereinabove, the magnet member 20 may be arranged to have various pole distributions so that different portions of the path member 30 may be temporarily magnetized to different or identical polarity. Other configurational and/or operational characteristics of the members of FIGS. 6I and 6J are similar or identical to those of the members of FIGS. 4A to 4X, FIGS. 5A to 5P, and FIGS. 6A to 6H.

In another exemplary embodiment of those aspects of this invention, such a path member may be similar to those of FIGS. 6I and 6J but couple with at least one magnet member through its lumen or opening. FIG. 6K shows a top view of such an exemplary path member 30 which is similar to those of FIGS. 6I and 6J but receives a magnet member 20 into its lumen 33. Therefore, such a path member 30 may be temporarily magnetized by the magnet member 20 from its interior surface toward its exterior surface. In a related embodiment, FIG. 6L is a top view of such an exemplary path member 30 which may be similar to that of FIG. 6K but couples with a first magnet member 20A on its exterior surface as shown in FIG. 61 and also with a second magnet member 20B on its interior surface as exemplified in FIG. 6K. Depending on pole distributions of such magnet members 20A, 20B, the path member 30 may be temporarily magnetized and generate a MF similar to those of FIG. 4C or 4D. Other configurational and/or operational characteristics of the members of FIGS. 6K and 6L are similar or identical to those of the members of FIGS. 4A to 4X, FIGS. 5A to 5P, and FIGS. 6A to 6J.

In another exemplary embodiment of such aspects of this invention, such a path member may be similar to those of FIGS. 6I and 6J but couple with at least one magnet member disposed therealong. FIG. 6M is a top view of such an exemplary path member 30 which couples with a magnet member 20 in its middle portion. In a related embodiment, FIG. 6N is a top view of such an exemplary path member 30 which rather couples with a similar magnet member 20 along one of its ends. In yet another related embodiment, FIG. 6O is a top view of such an exemplary path member 30 which couples with multiple magnet members 20A, 20N in its middle portion and along one of its ends. Such magnet members 20, 20A, 208 of these embodiments are generally annular and disposed on or over an exterior surface of the path member 30. Alternatively, the magnet members 20, 20A, 20B may be inserted into the lumen 33 of the path member 30 so as to couple with an interior surface of the path member 30. In another alternative, the magnet members 20, 20A, 20B may also be arranged to protrude beyond or over the exterior surface of the path member 30, to be flush with the exterior and/or interior surface of such a path member 30 or to penetrate into the lumen 33 thereof. Such magnet members 20, 20A, 20B may be arranged to have various pole distributions in order to temporarily magnetize various portions of the interior and/or exterior surfaces of such a path member 30. Other configurational and/or operational characteristics of such members of FIGS. 6M to 6O are similar or identical to those of the members of FIGS. 4A to 4X, FIGS. 5A to 5P, and FIGS. 6A to 6L.

In another exemplary embodiment of such aspects of this invention, such a path member may be similar to those of FIGS. 6I and 6J but have additional openings defined through its surface. FIG. 6P is a top view of such an exemplary path member 30 which may define multiple openings 33 according to a preset pattern and then couple with multiple magnet members 20A, 20B disposed between such openings 33. In addition to the pair of openings formed in both ends thereof, the path member 30 also define additional openings 33 which extend through a thickness thereof. Therefore, the interior of the path member 30 may be exposed through such side openings 33. Multiple magnet members 20A, 20B are disposed between such openings 33 based upon a preset pattern. Other configurational and/or operational characteristics of the members of FIG. 6P are similar or identical to those of the members of FIGS. 4A to 4X, FIGS. 5A to 5P, and FIGS. 6A to 60.

In another aspect of the present invention, an exemplary magnet-shunted system may include a path member which may be made by weaving the elongated permeable threads of FIGS. 6A through 6P while defining multiple openings or voids between such threads and coupling with a preset number of magnet members which may or may not be enclosed by at least one shunt member. FIGS. 6Q to 6X describe top views of exemplary path members defining a shape of a mesh and each coupling with a preset number of magnet members according to the present invention. It is to be understood that each of FIGS. 6Q to 6X may represent only a portion of the magnet-shunted system for ease of illustration. Accordingly, the depicted portion of the path member may correspond to only a selected portion of a bigger or thicker path member, to only one of multiple path members which may be disposed vertically or laterally, to only a flat portion of a bigger and/or curvilinear path member, and the like. Similarly, the depicted portion of the magnet member may also represent only a portion of a bigger magnet member, to only a single layer of a magnet member which may include multiple layers of permanent magnets or electromagnets which may be disposed vertically or laterally, to only a planar portion of a bigger and curvilinear magnet member, and so on. It is also appreciated that such path members may define such openings with various shapes other than rectangular or square ones exemplified in those figures.

In one exemplary embodiment of this aspect of the present invention, such a path member may include a mesh of the above permeable threads and couple with one or more magnet members of the point-source type. FIG. 6Q is a top view of such an exemplary path member 30 which couples with a single magnet member 20 in its center portion, while FIG. 6R shows a top view of such an exemplary path member 30 which rather couples with a pair of magnet members 20A, 20B in its corners opposite to each other. Accordingly, portions of the path member 30 closer to such magnet members 20, 20A, 20B may be temporarily magnetized and generate a MF with various magnetic field lines. In a related embodiment, FIG. 6S is a top view of such an exemplary path member 30 which couples with multiple magnet members 20A-20D which are of the point-source type and distributed across the path member 30 according to a preset pattern. Accordingly, portions of the path member 30 closer to such magnet members 20A-20D may be temporarily magnetized and generate a MF defined by various magnetic field lines. Other configurational and/or operational characteristics of the members of FIGS. 6Q to 6S are similar or identical to those of the members of FIGS. 4A to 4X, FIGS. 5A to 5P, and FIGS. 6A to 6P

In another exemplary embodiment of this aspect of the present invention, such a path member may include a mesh of the above permeable threads and couple with one or more elongated magnet members. FIG. 6T represents a top view of such an exemplary path member 30 which couples with multiple magnet members 20A-20C which are typically elongated and vertically disposed in an uniform distance. Such magnet members 20A-20C may extend across an entire height of the path member 30 or only a portion thereof, and may be coupled over, under, between, and/or along such threads of the path member 30. Depending upon the pole distribution thereof, the magnet members 20A-20C may be arranged to generate a composite MF which may flow along one direction or which may be symmetric while repulsing each other inbetween. In a related embodiment, FIG. 6U shows a top view of such an exemplary path member 30 which couples with multiple magnet members 20A, 20B along one or more of its edges. In the embodiment exemplified in the figure, a first magnet member 20A may couple with roughly one half of horizontal threads of the path member 30, whereas a second magnet member 20B may couple with the rest of such horizontal threads. By arranging the magnet members 20A, 20B to couple with the threads with different polarities, such magnet members 20A, 20B may generate a MF flowing from the lower to upper threads or vice versa. In a related embodiment, FIG. 6V is a top view of such an exemplary path member 30 which couples with multiple magnet members 20A, 20B along one or more of its edges. In the embodiment exemplified in the figure, a first magnet member 20A may couple with roughly one half of vertical threads of the path member 30, and a second magnet member 20B may couple with the rest of such vertical threads. By arranging the magnet members 20A, 20B to couple with the threads with different polarities, such magnet members 20A, 208 may generate a MF flowing from right to left or vice versa. In a related embodiment, FIG. 6W shows a top view of another exemplary path member 30 which couples with multiple magnet members 20A, 20B along one or more of its edges. In the embodiment exemplified in the figure, a first magnet member 20A may couple with roughly almost all of vertical threads of the path member 30, while a second magnet member 20B may couple with almost all of the horizontal threads. By arranging the magnet members 20A, 20B to couple with the threads with different polarities, such magnet members 20A, 20B may generate a composite MF centering around openings 33. In yet another related embodiment, FIG. 6X is a top view of such an exemplary path member 30 which couples with multiple magnet members 20A, 20B along one or more of its edges. In the embodiment exemplified in the figure, a first magnet member 20A may couple with roughly one half of horizontal threads of the path member 30, whereas a second magnet member 20B may couple with the rest of such horizontal threads. It is appreciated that each magnet member 20A, 20B couples with every other horizontal thread such that the magnet members 20A, 20B couple with the threads in an alternating pattern. By arranging such magnet members 20A, 20B to couple with the threads with different polarities, the magnet members 20A, 20B may generate a composite MF which may alternate its direction in each row. It is appreciated that this embodiment may be applied to couple a pair of magnet members to vertical threads in an alternating pattern and generate another composite MF which may instead alternate its direction in each column. Other configurational and/or operational characteristics of the members of FIGS. 6T and 6X are similar or identical to those of the members of FIGS. 4A to 4X, FIGS. 5A to 5P, and FIGS. 6A to 6S.

Configurational and/or operational variations and/or modifications of the above embodiments of the exemplary systems and various members thereof described in FIGS. 4A through 6X also fall within the scope of this invention.

As described herein, the main function of the path member is to provide at least one route for absorbing the MFs and MWs of the extrinsic EM waves propagating in space and the MFs and MWs of the secondary EM waves generated by an electric device, for containing or accumulating as much of such MFs and MWs as possible, and for guiding such MFs and MWs toward or to one or more magnet members. Another function of the path member is that at least a portion (such as the portion disposed close to the magnet member) thereof may become temporarily magnetized in order to attract more MFs and MWs thereto. When desirable, the path member may be arranged to become least permanently magnetized while coupling with the magnet member. Yet another function of such a path member is to receive and to transmit the static intrinsic MFs generated by the magnet member therethrough when it may be desirable to replace the static MFs of the Earth.

It is appreciated that FIGS. 4A to 5P may be interpreted in different perspectives. Accordingly, such figures may be interpreted to be top views, bottom views, side views, front views, rear views or cross-sectional views cut away vertically, horizontally or in a preset angle. In each of these view planes or angles, the path member may be deemed to define the similar shape along a third dimension which is perpendicular to the paper while pointing into and out of the paper. For example, such a path member of FIG. 5A may be viewed as a pair of two parallel segments which extend vertically into and out of the paper and which are disposed one over the other, while the path member of FIG. 5J may be viewed as a magnetically permeable sheet which may extend vertically into and out of the paper and which defines multiple layers of elongated openings also extending vertically into and out of the paper. It is further appreciated that a single path member of these figures may actually correspond to multiple path members depending upon such view planes and/or angles, while multiple path members of these figures may actually represent different portions of a single path member.

In order to reroute various MFs and MWs, the above path members may generally be made of and/or include at least one highly magnetically permeable material, where examples of such materials may include, but not be limited to, iron, nickel, and stainless steel each of which has relative magnetic permeability of about 100, various nickel/iron based alloys, various cobalt based alloys, and the like. These alloys are commercially available in the trademark names of Mumetal Alloys™, Co-Netic Alloys™, and Netic Alloys™ provided by Magnetic Shield Corporation (Bensenville, Ill.), and other alloys such as Hipernom™, HyMu-80™, Permalloy™, and the like, and exhibit the relative magnetic permeability ranging from about several thousands to a million. Within the scope of this invention, the path member may be arranged to exhibit the relative magnetic permeability of at least 200 and preferably about and beyond 1,000. Following Table 1 tabulates relative magnetic permeabilities of some substances and alloys.

TABLE 1
Relative Magnetic Permeabilities (Kₘ)
of Exemplary Elements and Alloys

| Materials | Kₘ | Materials | Kₘ |
|---|---|---|---|
| air | 1 | iron | 200 |
| aluminum | 1 | stainless steel | 200 |
| copper | 1 | MagnetShield ™ | 4,000 |
| lead | 1 | Magnetic Shielding Alloys ™ | 20,000 |
| nickel | 100 | Annealed MetGlas ™ | 1,000,000 |

These magnetically permeable materials are commercially manufactured in various configurations and sold as MF- and MW-shielding garments, films, sheets, plates, adhesive tapes, and so on. Therefore, some of the path members of the present invention may be provided by fabricating the above readily available articles. Alternatively, the path member may be directly manufactured, e.g., by fabricating or otherwise shaping one or more of the above materials and/or alloys, by covering or enclosing existing articles with one or more of the above materials and/or alloys, by coating or layering existing articles by one or more of the above materials and/or alloys, by inserting or impregnating one or more of such materials and/or alloys into existing articles, and the like.

The path member may be arranged to have an uniform permeability per unit area and/or volume regardless of how many segments may be defined therein or therealong. The path member may also be arranged to exhibit different permeabilities in different portions and/or different segments such that the portions or segments far from a junction with the magnet member may be arranged to have higher permeabilities than those close to the junction, thereby minimizing the leakage of the intrinsic MFs from the magnet member. Conversely, the portions or segments closer to the junction may be arranged to have higher permeabilities than those farther from the junction, thereby maximizing the amount of the extrinsic MFs and MWs collected and contained in the path member. Other arrangements may also be possible so that the path member may form regions of high, intermediate, and low permeability and the user may dispose such regions at his or her will depending upon the strengths of the extrinsic and/or intrinsic MFs and MWs. It is appreciated that the permeability of the path member may be arranged to be in any level as far as it is greater than, e.g., 200 or any other threshold and that the permeability of the path member may be arranged to be greater (or less) than that of the magnet member and/or shunt member, depending on various factors such as, e.g., strengths of the extrinsic, intrinsic or secondary MFs, distance from the source of the MFs and MWs, dimension of the magnet and/or shunt members, and the like. It is also appreciated that the permeability of the path member may not be a constant but vary according to frequency of the MFs and MWs and that selection of a suitable material for the path member may have to take account of a range of frequencies of such MFs and MWs to be absorbed by the path member.

In addition to the above magnetic and/or relative permeability, there exists another factor which may also affect performance of the path member, i.e., saturation of the path member. A magnetically permeable material is said to have reached its saturation as all internal domains of the material aligns in response to external MFs. In such a saturated state, the permeable material may no longer be able to absorb and to reroute the MFs and become useless. Accordingly, the path member may be arranged to have at least a minimum thickness and/or at least a minimum mass per unit area or volume so as to prevent from being saturated by such MFs. When the path member is fabricated into a thin film or foil, however, it may be saturated easily by the MFs with moderate strengths. In these circumstances, the magnet member is arranged to eliminate the MFs and MWs as much as possible, thereby rendering as much a portion of the path member absorb, contain, and reroute the MFs and MWs therealong. To this end, the magnet member may have a little more strength than otherwise, the path member may define a larger area at the junction with the magnet member to facilitate the accumulated MFs to propagate to the magnet member, and the like. Alternatively, different portions of the path member may be made of and/or include different materials having different saturation in order to prevent the path member from becoming useless. Therefore, various portions of the path member may be arranged to have different configurations (e.g., thicknesses, lengths, widths, and the like), to be made of and/or include different materials, and so on. As described herein, temporary or permanent magnetization of at least a portion of the path member may prevent the path member from being easily saturated as well.

Another factor which may affect performance of the path member may be magnetic retentivity of the material, where a material with high retentivity retains magnetic property once it is under a MF, while a material with lower retentivity rapidly loses magnetic property once the MF ceases to apply. Thus, when the path member is to participate in providing the static MFs with the magnet member, the path member may preferably be made of and/or include materials with higher retentivity. In contrary, when the path member is to purely serve to recruit and reroute the extrinsic MFs and MWs of the EM waves, such a path member may preferably be made of and/or include materials with low retentivity.

The path member may have any shapes and/or sizes which may be decided at least in part by its application, a shape and size of the target, the strengths of the MFs and MWs of the extrinsic EM waves, magnetic permeability and saturation characteristics of the material of which it is made, and so on. Because the path member is preferably arranged to absorb and reroute the MFs and MWs of the extrinsic EM waves which may impinge on a larger area, the path member is arranged to define as large a surface area as possible per unit mass and/or volume. For example, the path member may be fabricated into a thin film, foil, sheet, and layer, into a woven or networking structure such as a mesh, net, screen, fabric, yarn, and garment, into an elongated structure such as a fiber, strand, wire, and filament, into a bulk structure such as a solid or hollow sheet, slab, strip, and other shapes, and so on. At least a portion or an entire portion of the path member may be arranged to be at least substantially rigid, flexible, elastic, and the like, where detailed physical characteristics of such a path member may generally be determined by those of the raw material, bases or fillers which are to be mixed with the raw materials, and so on. Such a path member may have at least substantially flat, planar or curved shapes. In addition, such a path member may be arranged to have a two-dimensional structure such as a flat layer or slab or, in the alternative, a three-dimensional structure such as an embossed fabric, sponge, porous structure, carpet, and so on. Such a path member may be arranged to have uniform dimensions thereacross or different dimensions in various portions thereof. In any case, selection of the magnetic and/or physical characteristics and detailed shape and/or size of the path member may be generally a matter of choice of one of ordinary skill in the art. In addition, various segments of such a path member may be similarly provided as the path member itself. It is to be understood that such segments may be physically coupling or contacting each other or separated from each other, that the segments may be magnetically coupling with each other or uncoupled from each other, and the like.

As exemplified in the figures, such a magnet shunted system may include any number of path members all of which may couple with the magnet member or at least one of which may couple with another path member which couples with the magnet member. And as described hereinabove, each path member may consist of a single segment or at least one of such path members may include two or more segments therealong. The path members and/or their segments may also magnetically couple with one or more poles of the magnets of the magnet member in various configurations, either directly or through the shunt member. It is appreciated that the path member may magnetically couple with at least two magnet members which may be disposed in opposing positions of the path member and may couple with the path member in different polarities. In this embodiment, vary weak MFs are provided from one to the other of the magnet members through the path member and presence of the MFs may facilitate the recruited and accumulated MFs and MWs of the extrinsic EM waves to be rerouted to one of the magnet members more rapidly. It is also appreciated that the magnet member may be arranged to be releasably coupled to the path member such that, when the magnet of the magnet member may be degraded, the used magnet member may be readily replaced by a new magnet member. At least a substantial portion of the path member may be exposed or, alternatively, at least a portion of the path member may be enclosed within and/or covered by the magnet and/or shunt members and/or by other parts such as the fillers as will be described in detail below. Such path members itself may be made as two-dimensional or three-dimensional articles and may also be coupled to the magnet member in a two-dimensional or three-dimensional modes. Accordingly, multiple path (or magnet) members may be coupled to the magnet (or path) member in a planar configuration or in a three-dimensional modes so that some path (or magnet) members may couple with the top portion of the magnet (or path) member, while other path (or magnet) members may couple with the side or bottom portions of the magnet (or path) member. It is appreciated that, regardless of series and/or parallel coupling modes between the path and magnet members, selection of the number of each of such members and/or coupling patterns therebetween is generally a matter of choice of one or ordinary skill in the relevant art, as far as such path member may be able to recruit and reroute the MFs and MWs of the extrinsic EM waves and then to guide such MFs and MWs to the magnet member.

As described above, a single magnet shunted system may include one or more path members, whereas a single path member may define one or more segments therealong. In general, a single path member with a preset number of multiple segments may function similar or identical to a system having the same number of multiple path members each defining a single segment therealong, as far as such segments of the single path member and such path members of the single system may be arranged to have equivalent shapes, sizes, and permeabilities and to be disposed in equivalent arrangements. In this context, the single path member with multiple segments and an assembly of multiple path members may be deemed as functional equivalents.

Various path members may be manufactured through various processes. For example, a solid or bulk material with high magnetic permeability may be carved and/or cut into the path member having one of the above shapes and/or sizes. In another example, such magnetically permeable material may be fabricated into a planar or curved sheet, foil or fabric and arranged to cover, enclose, and/or wrap around an existing article of one of the above shapes and/or sizes, thereby forming the path member disposed over or below such an article. In another example, the magnetically permeable material may be provided in a form of powder, gel or solution and painted over, pasted onto or impregnated into an existing article, thereby providing the path member in an exterior surface or into a preset depth of an existing article. In another example, the magnetically permeable material may be prepared in powder, pellets, filings, fiber, filament or liquid, mixed with a base, and molded or otherwise formed into one of the foregoing shapes and/or sizes. As will be described herein, such path members may couple with magnet members which may also be provided in a form of powder, pellet, filing, fiber, filament, gel or solution. In particular, when such path members are mixed with the magnet member with the same or similar form, such a mixture may be pasted or coated over an existing article and arranged to prevent the extrinsic or secondary MFs and MWs from propagating toward the target. Thus, the path member may be provided as a solution, emulsion or gel, while the magnet member may be provided as power, short fiber or other shapes which may be suspended in the path member such that a mixture of such path and magnet members may be directly applied onto the target to be protected and/or article which may generate the secondary MFs and MWs. When the mixture may be dried or otherwise set, such a mixture of the path and magnet members may be able to absorb, accumulate, and then eliminate such MFs and MWs. It is appreciated that the magnetically permeable path member may be able to serve as the shunt member and to confine the intrinsic MFs of the magnet members within the preset distance.

As disclosed in the co-pending Application, the filler may optionally be incorporated into any of such path members for various purposes, where the filler may be incorporated inside, outside, and/or across at least a portion of such a path member or segment, between at least two path members or segments thereof, and so on. In one example, such a filler may be made of and/or include at least one magnetically inert material so that such a filler may fill the gap between the segments of a single path member or between multiple path members, may provide a space for disposing the path member or its segment along a preset direction and/or in a preset orientation, may mechanically support such a path member, may fill a void or opening between the path member and magnet and/or shunt members, may mechanically protect the path member and/or its segment from external impacts, and the like. The filler may also be coated over an exposed portion of the path member and protect the user from allergy or skin irritation therefrom. In another example, the filler may be arranged to affect or modify recruiting and/or rerouting properties of the path member, where such a filler may typically be made of and/or include at least one ferromagnetic material or other materials with high permeability. Accordingly, this type of filler may affect not only the recruiting or attracting properties of the path member but also the rerouting pattern of the MFs and MWs by manipulating accumulating pattern of the MF lines inside the path member. Such a filler may also have the magnetic permeability which may be less than, at least substantially similar to or greater than that of the path member. When desirable, such a filler may be made of and/or include materials which may not cause skin irritation so that the filler may also protect the user. The path member may include a single filler which has an uniform dimension in any direction or, in the alternative, may vary its dimension along one or more directions. In the alternative, the path member may include multiple fillers, where all of such fillers may be arranged to be identical or where at least two of such multiple fillers may have different shapes, sizes, magnetic permeability, chemical and/or physical properties, and the like. Such a filler may also be arranged to move between multiple positions in each of which the filler affects the magnetic permeability, saturation, and/or retentivity of such a path member in different ways, thereby allowing the user to manipulate the rerouting pattern of the MF lines by moving such a filler to different positions. Multiple fillers may be arranged to releasably couple with each other such that the user may releasably add and/or remove one or more fillers while controlling the path member to reroute or accumulate the MFs. It is appreciated that the fillers may be disposed between the path member and the magnet and/or shunt members in order to prevent direct physical contact therebetween while allowing magnetic coupling therebetween. In the alternative, a gap may be formed therebetween while allowing the magnetic coupling therebetween.

The path member may include one or more couplers thereon in order to facilitate releasable or fixed coupling with the magnet and/or shunt members, where examples of such couplers may include, but not be limited to, protrusions, grooves or indentations, hooks, loops, adhesive strips, Velcro's, and so on. As described heretofore and hereinafter, any path members described herein may be coupled to and/or between any magnet and/or shunt members as described in the co-pending Application and as described hereinafter. In addition, the path member may define at least one receiver through which the magnet member may be inserted and fixedly and/or releasably coupled thereto. Conversely, such a receiver may be incorporated into the magnet member so that at least a portion of the path member may be releasably or fixedly inserted and coupled thereto.

As described herein, at least a portion of the path member which may be close or adjacent to its coupling location with the magnet member may be temporarily magnetized, i.e., various domains of such a portion of the path member may be aligned along a direction of the MF generated by the magnet member, where such temporal magnetization typically vanishes when the path member is magnetically uncoupled from the magnet member. The temporal magnetization of such a portion of the path member may prove beneficial in various aspects. In one aspect, the temporarily magnetized portion of the path member may generate another MF or, in the alternative, may be viewed to extend the MF generated by the magnet member. In either case, a net result is that at least a minimal MF may be formed across the portion of the path member which may in turn attract more extrinsic MFs and MWs. Because of such MF across such a portion, the path member may not have to define a solid configuration, i.e., without any openings therealong. Depending upon the strength and/or direction of the MF thereacross, such a path member may define a substantial number of openings or a substantial void area. The extrinsic MFs and MWs which may have escaped through such openings or voids may be captured onto such a path member because of its temporal magnetization. In another aspect, the temporarily magnetized portion of the path member may serve as the termination point or sink for the extrinsic MFs and MWs, depending upon its polarity. Thus, the extrinsic MFs and MWs which may have been accumulated in the path member may then be eliminated by such a pole defined on the temporarily magnetized portion of the path member. This may also result in another benefit that such a path member may not easily be saturated, because at least a substantial portion of such extrinsic MFs and MWs may be eliminated therefrom. Therefore, the temporarily magnetized path member may be deemed to have a far greater pseudo-saturation than the same path member which may not couple with the magnet member. In yet another aspect, the temporarily magnetized path member may better attract the MFs and MWs which may propagate along the same direction as the MF generated in the path member.

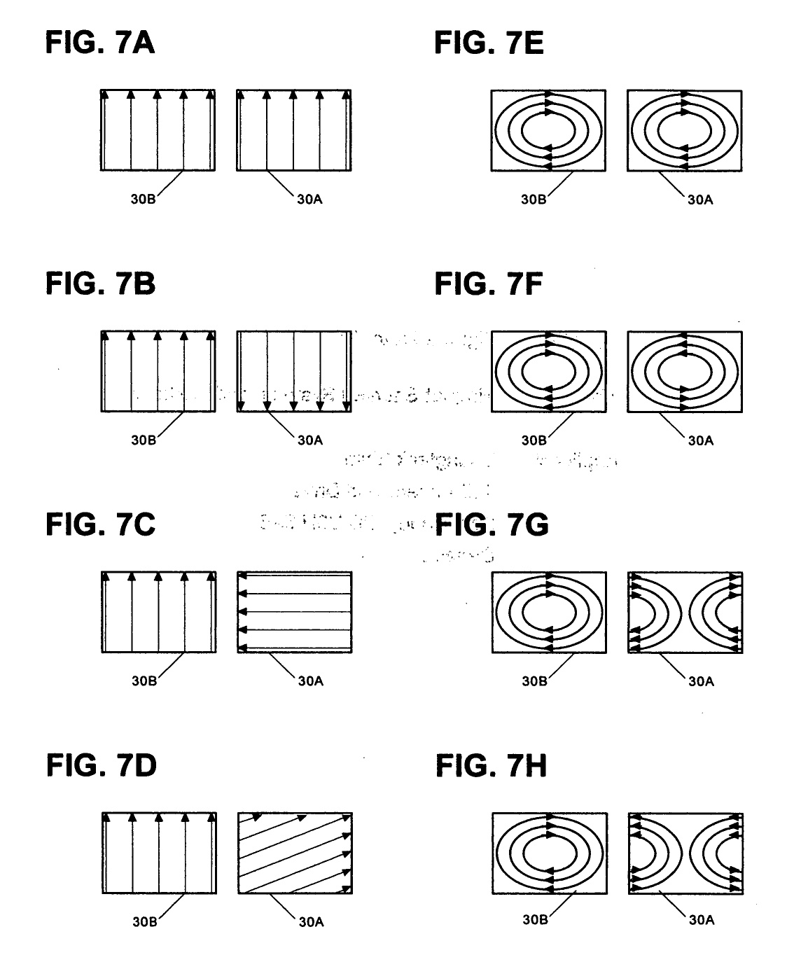

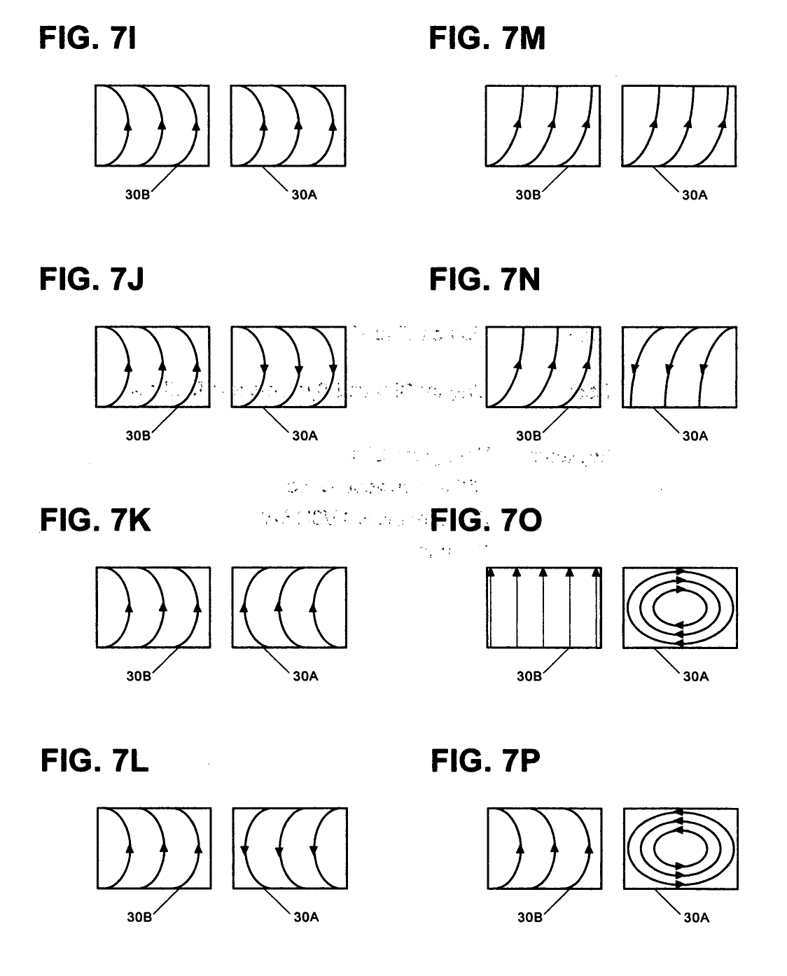

In another aspect of the present invention, a magnet shunted-system of the present invention may have a path assembly which may in turn include at least two same or different path members as described heretofore and hereinafter. FIGS. 7A through 7P are perspective views of exemplary path assemblies each including at least two path members and generating temporary magnetic fields on at least portions thereof according to the present invention. It is to be understood that the path members may be fixedly or movably coupled with respect to each other, with respect to the magnet member or shunt member, and/or other parts of the system. It is appreciated, for simplicity of illustration, that the magnet members are not included in these figures but that magnetic field lines across the temporarily magnetized path members are included therein. Accordingly, these figures are to be regarded to have one or more of the foregoing magnet members as long as they may generate the magnet field lines as exemplified in each figure. It is also appreciated that various path members of FIGS. 7A to 7P are to be used by disposing one over the other. It is further appreciated that each of FIGS. 7A through 7P may describe only a portion of the magnet-shunted system for ease of illustration. Therefore, the depicted portion of the path members may in fact correspond to only a selected portion of bigger or thicker path members, to only a few of multiple path members which may be disposed vertically or laterally, to only flat portions of bigger and/or curvilinear path members, and the like.

In one exemplary embodiment of such an aspect of this invention, a path assembly may include at least two path members each of which may be temporarily magnetized to provide parallel magnetic field lines and which may be oriented to along the same direction. FIG. 7A shows a top view of such an exemplary path assembly having a pair of path members 30A, 30B. Each path member 30A, 30B is arranged to couple with one or more of any of the above magnet members (not shown in the figure) in order to be temporarily magnetized and to generate magnetic field lines which may propagate parallel to each other. The path members 30A, 30B are then disposed one over the other while aligning those magnetic field lines to run along the same directions. In a related embodiment, FIG. 7B is a top view of such an exemplary path assembly including a pair of path members 30A, 30B which may be identical to those of FIG. 7A. These path members 30A, 30B, however, are disposed one over the other in the manner that the magnetic field lines of such members 30A, 30B run in opposite directions. In a related embodiment, FIG. 7C is a top view of such an exemplary path assembly having a pair of path members 30 which may be similar to those of FIG. 7A but arranged in such an orientation that the magnetic field lines of the members 30A, 30B are perpendicular or at least substantially transverse to each other. In another related embodiment, FIG. 7D is a top view of such an exemplary path assembly with a pair of path members 30A, 30B which are also similar to those of FIG. 7A but disposed one over the other in such a manner that their magnetic field lines are at a preset angle between 0° and 90°. In general, the embodiment of FIG. 7A is preferred to attract the MFs propagating in the same direction, whereas the embodiments of FIGS. 7B to 7D are beneficial in attracting the MFs propagating in alternating directions. Other configurational and/or operational characteristics of such members of FIGS. 7A to 7D are similar or identical to those of the members of FIGS. 4A to 4X, FIGS. 5A to 5P, and FIGS. 6A to 6X.

In another exemplary embodiment of this aspect of the present invention, a path assembly may include at least two path members each of which may be temporarily magnetized and define magnetic field lines which may propagate concentrically in a clockwise or counterclockwise direction. FIG. 7E is a top view of such an exemplary path assembly having a pair of path member 30A, 30B. Each path member 30A, 30B may be arranged to couple with one or more of any of the above magnet members (not shown in the figure) and to be temporarily magnetized, thereby generating the magnetic field lines which propagate in a concentric or radial pattern and along a clockwise direction. The path members 30A, 30B may then be disposed one over the other while aligning the magnetic field lines to run in the same directions. In a related embodiment, FIG. 7F is a top view of such an exemplary path assembly having a pair of path members 30A, 30B which may be similar to those of FIG. 7E, except that one of the path members 30A, 30B may define the magnetic field lines propagating along a counterclockwise direction. In a related embodiment, FIG. 7G is a top view of an exemplary path assembly also including a pair of path members 30A, 30B which may be similar to those of FIG. 7E. However, one of the path members 30A, 30B may be arranged to define a pair of groups of half-circle magnetic lines which also propagate in clockwise directions. Such path members 30A, 30B are disposed one over the other so that their magnetic field lines may be aligned at various angles with respect to each other. In a related embodiment, FIG. 7H depicts a top view of such an exemplary path assembly including a pair of path members 30A, 30B which are similar to those of FIG. 7G, except that the magnetic field lines of one of the path members 30A, 30B has a similar pair of groups of half circles which, however, propagates in a counterclockwise direction. In general, the embodiment shown in FIG. 7E is preferred to attract the MFs propagating in the same direction, whereas the embodiments of FIGS. 7F to 7H may be beneficial in attracting the MFs propagating along alternating directions. Other configurational and/or operational characteristics of the members of FIGS. 7E to 7H may be similar or identical to those of the members of FIGS. 4A to 4X, FIGS. 5A to 5P, FIGS. 6A to 6X, and FIGS. 7A to 7D.

In another exemplary embodiment of this aspect of the present invention, a path assembly may include at least two path members each of which may be temporarily magnetized and define magnetic field lines which may propagate along arcuate and parallel courses. FIG. 7I shows a top view of such an exemplary path assembly with a pair of path member 30A, 30B each of which may be arranged to couple with one or more of any of the above magnet members (not shown in the figure) in order to be temporarily magnetized and to generate magnetic field lines propagating along arcuate courses. In this embodiment, such courses may be generally concave to the right, and magnetic path lines propagate vertically and upwardly. The path members 30A, 30B may then be disposed one over the other while aligning the magnetic field lines to run in the same directions. In a related embodiment, FIG. 7J is a top view of such an exemplary path assembly having a pair of path members 30A, 30B which are similar to those of FIG. 7I, except that one of the path members 30A, 30B may define such magnetic field lines propagating along the same courses but vertically and downwardly. In a related embodiment, FIG. 7K is a top view of such an exemplary path assembly including a pair of path members 30A, 30B which are similar to those of FIG. 7I. However, one of the path members 30A, 30B may define the magnetic field lines which propagate vertically and upwardly but along courses which are concave to the left. Such path members 30A, 30B are disposed one over the other such that their magnetic field lines may be aligned at various angles with respect to each other while running along the similar directions. In a related embodiment, FIG. 7L is a top view of such an exemplary path assembly including a pair of path members 30A, 30B which are similar to those of FIG. 7I, except that the magnetic field lines run along opposite directions and courses of such lines are also concave to opposite directions. In general, the embodiment shown in FIG. 7I may be preferred to attract such MFs propagating in the same direction, whereas the embodiments of FIGS. 7J to 7M may be more beneficial in attracting the MFs propagating in alternating and opposite directions. In a related embodiment, FIG. 7M shows a top view of such an exemplary path assembly including a pair of path members 30A, 30B each of which defines magnetic field lines propagating upwardly along curvilinear courses which are generally concave downward. In a related embodiment, FIG. 7N is a top view of such an exemplary path assembly with a pair of path members 30A, 30B which are similar to those of FIG. 7M, except that one of the path members 30A, 30B may define the magnetic flux lines running downward. Other configurational and/or operational characteristics of the members of FIGS. 7I to 7N may be similar or identical to those of the members of FIGS. 4A to 4X, FIGS. 5A to 5P, FIGS. 6A to 6X, and FIGS. 7A to 7H.

It is appreciated that the path assemblies may include two or more of the above path members in different combinations. For example, FIG. 7O is a top view of an exemplary path assembly including one path member of FIG. 7A and one path member of FIG. 7E, while FIG. 7P is a top view of another exemplary path assembly including one path member of FIG. 7I and one path member of FIG. 7F. Other combinations are also possible and determination of which path members to be used in combination is generally a matter of choice of one of ordinary skill in the relevant art.

It is to be understood that any of the foregoing path members (including those described herein and those disclosed in the co-pending Application) may be arranged to define thereacross almost any magnetic field lines and distributions thereof which may or may not be symmetric with each other with respect to a point or a line of symmetry, which may or may not be parallel to each other, and so on. It is to be understood that current technology allows fabrication of various magnet members which may define more S (or N) poles than N (or S) poles, which may allow one pole to occupy a larger area than the opposite pole, and so on. In addition, current technology further allows fabrication of such magnet members which may generate certain magnetic field lines which may be distributed in a preset space and may propagate along a preset direction. Accordingly, once desirable distribution and/or pattern of the magnet field lines across at least a portion of the path member may be determined, information as to magnetic strength and pole distribution of the magnet member may be inversely calculated through various magnetic properties of the path member such as, e.g., magnetic permeability, saturation, and the like.

As described herein, various path members of the present invention may be arranged to be at least partially and temporarily magnetized by the magnet member. This arrangement may be generally beneficial in attracting more MFs and MWs than the same path member which may not be magnetized. Depending upon the strengths of the MF generated by the path member or such strengths transferred to the path member by the magnet member, at least a portion of the MFs and MWs may be attracted or skewed toward the path member. Accordingly, such magnetized path member, whether permanently or temporarily, may be able to absorb and accumulate the MFs and MWs while defining some openings or voids thereacross, thereby allowing fabrication of porous or see-through path members. It is to be understood, however, that the magnetization of the path member may attract the MFs and MWs when such MFs and MWs propagate along the same direction as the MF of the path member, but that such MFs and MWs may be repelled when such MFs and MWs propagate along a direction which may be opposite to the direction of the MF of the path member. Therefore, the magnet shunted system of this invention may include one of the above path assemblies, where one of the path members may provide the MF along one direction, while another path member may generate the MF in a different or opposite direction such that each portion of the MFs and MWs oscillating in alternating and opposite directions may be accumulated in either of such path members. Such an embodiment may also offer a benefit of absorbing more MFs and MWs in such a manner that a remaining portion of such MFs and MWs which may not be channeled into a first path member may be channeled to a next layer of path member, and the like.

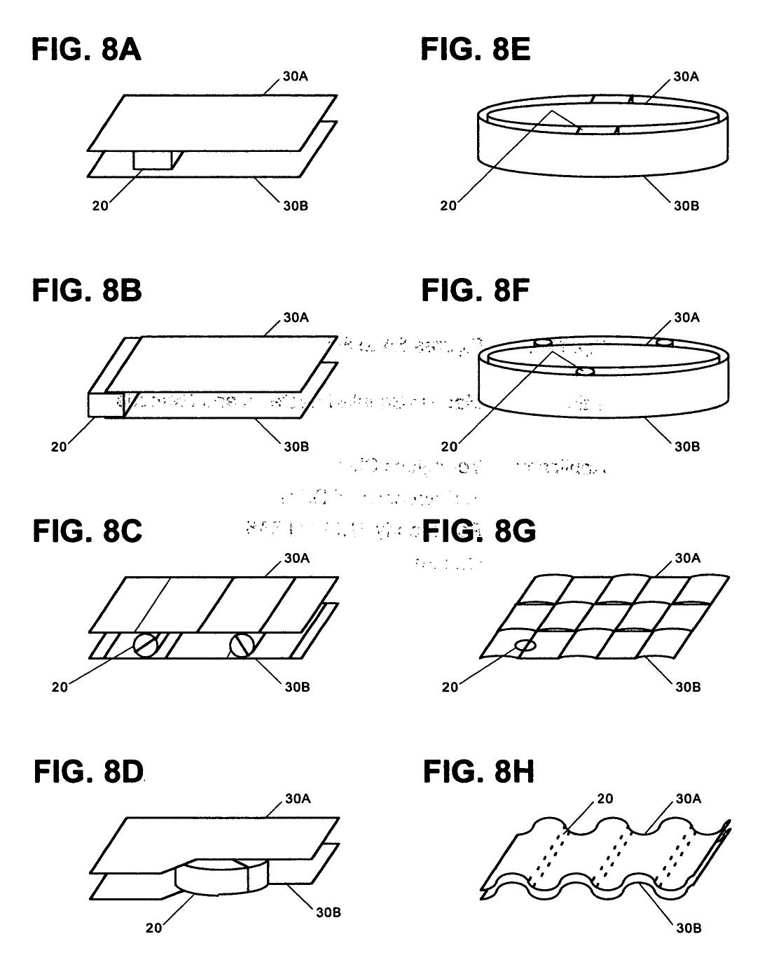

In another aspect of the present invention, two or more of the foregoing path members may be fixedly or movably coupled to each other through various mechanisms. In one exemplary embodiment, multiple path members may be coupled to each other by one or more supports which may or may not exhibit high magnetic permeability. When such a path assembly is to include at least one movable path member, such movable path member may be movably coupled to the magnet member, shunt member, one or more stationary path members, and/or other parts of the system through conventional movable coupling mechanisms. In the alternative, at least two path members of such a path assembly may also be coupled to each other either fixedly or movably by the magnet member. FIGS. 8A through 8H show perspective views of exemplary path assemblies each including path members at least two of which may couple with each other according to the present invention. It is appreciated in those figures that, although each path assembly has only two identical path members, other path assemblies may include more than two path members each of which may then be coupled to at least one of the remaining path members or may include the path member including more than two segments each of which may then couple with at least one of its remaining segments. It is also appreciated that such path members may define any planar or curved surfaces and may have different shapes and/or sizes. Furthermore, the path members of such figures may couple with one or more of any of the above magnet members so as to define various magnetic field lines thereacross.

In one exemplary embodiment of such an aspect of this invention, a path assembly may include multiple planar path members which are fixedly and/or movably coupled to each other by at least one magnet member placed therebetween. FIG. 8A is a perspective view of an exemplary path assembly having a pair of path members 30A, 30B which are disposed one over the other and coupled to each other by a magnet member 20 disposed therebetween in center portions of the members 30A, 30B. In a related embodiment, FIG. 8B shows a perspective view of another exemplary path assembly having a similar pair of path members 30A, 30B which may also be disposed one over the other and coupled to each other by a magnet member 20 which may be disposed therebetween along edges thereof. In a related embodiment, FIG. 8C is a perspective view of an exemplary path assembly including a pair of path members 30A, 30B disposed one above the other and then coupled to each other by a pair of cylindrical magnet members 20 disposed therebetween while aligning their longitudinal axes with such path members 30A, 30B. Such magnet members 20 may also be arranged to roll or slide between the path members 30A, 30B while coupling different poles with the path members 30A, 30B. In a related embodiment, FIG. 8D is a perspective view of another exemplary path assembly having a pair of path members 30A, 30B which are disposed one over the other and coupled to each other by a cylindrical magnet member 20 disposed therebetween while aligning its longitudinal axis perpendicular to the path members 30A, 30B. Depending upon pole distributions of the magnet member 20, the path members 30A, 30B of such embodiments may exhibit the same or different polarities. It is appreciated that such path members 30A, 30B may couple with the magnet member 20 not onto the surfaces of the magnet member 20 but along the edges thereof. It is also appreciated that any conventional movable coupling mechanisms may also be incorporated into the magnet and/or path members 20, 30A, 30B in order to allow one of the magnet and path members 20, 30A, 30B to move or otherwise change its position or or orientation with respect to the others. Other configurational and/or operational characteristics of the members of FIGS. 8A to 8D may be similar or identical to those of the members of FIGS. 4A to 4X, FIGS. 5A to 5P, FIGS. 6A to 6X, and FIGS. 7A to 7P.

In another exemplary embodiment of this aspect of the present invention, a path assembly may include multiple curved path members which are fixedly and/or movably coupled to each other by at least one magnet member placed therebetween. FIG. 8E is a perspective view of an exemplary path assembly having a pair of round path members 30A, 30B disposed concentrically and coupled to each other by multiple magnet members 20. In a related embodiment, FIG. 8F describes a perspective view of another exemplary path assembly including a pair of path members 30A, 30B which may be similar to those of FIG. 8E but coupled to each other by cylindrical or round magnet members 20 which may be arranged to serve as cylindrical rod bearings or spherical ball bearings. Therefore, at least one of such path members 30A, 30B may rotate with respect to the other radially. Depending upon the pole distributions of the magnet member 20, the path members 30A, 30B of such embodiments may similarly exhibit the same or different polarities. Other configurational and/or operational characteristics of the members shown in FIGS. 8E and 8F may be similar or identical to those of the members of FIGS. 4A to 4X, FIGS. 5A to 5P, FIGS. 6A to 6X, FIGS. 7A to 7P, and FIGS. 8A to 8D.

In another exemplary embodiment of this aspect of the present invention, a path assembly may include multiple path members which are arranged in an interwoven pattern to form a planar or curved article. FIG. 8G is a perspective view of an exemplary path assembly including multiple path members 30A, 30B which have shapes of strips and are woven into, e.g., a fabric or quilt. It is appreciated that the path assembly includes numerous path members, where a total number of such path members is a product of a number of the path members required along a length of the assembly and another number of such members disposed along a width thereof. The path members 30A, 30B are typically arranged one over the other in an alternating pattern so that one half of each strip-shaped path member may be exposed, while the other half thereof may be covered by other path members. It is to be understood that such path members may also be woven in other patterns as commonly seen in conventional yarn, fabric, and the like. At least one magnet member 20 may be fixedly or releasably coupled over, below, between or along the path members in order to temporarily magnetize at least a portion of such a path assembly, where the magnetic field in the magnetized portion of the path assembly may be determined by pole distribution of the magnet member, by a location of coupling therebetween, and the like. Other configurational and/or operational characteristics of the members of FIG. 8G may be similar or identical to those of the members shown in FIGS. 4A to 4X, FIGS. 5A to 5P, FIGS. 6A to 6X, FIGS. 7A to 7P, and FIGS. 8A to 8F.

In another exemplary embodiment of this aspect of the present invention, a path assembly may have multiple path members which may be arranged to define curvilinear surfaces and to be disposed one above the other. FIG. 8H is a perspective view of an exemplary path assembly including a pair of path members 30A, 30B which may define curved or, more specifically, embossed surfaces and may be disposed one over the other while aligning ridges and valleys of each path member 30A, 30B. An elongated magnet member 20 may be disposed over, below, between or along one or both of the path members 30A, 30B and then temporarily magnetize at least a portion of each path member 30A, 30B. Other configurational and/or operational characterstics of the members of FIG. 8H may be identical or similar to those of the members shown in FIGS. 4A to 4X, FIGS. 5A to 5P, FIGS. 6A to 6X, FIGS. 7A to 7P, and FIGS. 8A to 8G.

Configurational and/or operational variations and/or modifications of the above embodiments of the exemplary systems and various members thereof described in FIGS. 8A through 8H also fall within the scope of this invention.

Such path members of the present invention may be arranged to accomplish various functions. For example, the path members may serve to receive or absorb various extrinsic, secondary, and/or intrinsic MFs and MWs and then to accumulate such MFs and MWs therein. Such path members may preferably exhibit high magnetic permeability or, more specifically, relative magnetic permeability of at least 200. Such path members may also couple with various magnet members such that the MFs and MWs accumulated in the path members may propagate therethrough toward the magnet members and be eliminated in one or both poles of the magnet members.

In a second example, such path members may serve to attract the above extrinsic, secondary, and/or intrinsic MFs and MWs by being temporarily magnetized by the MF generated by and/or leaking from the magnet and/or shunt members. The path members may eliminate such MFs and MWs thereby or deliver such MFs and MWs to the magnet member which may serve as their termination point and/or sink. These path members may exhibit the magnetic permeability similar to the previous example and may further be arranged to couple with the magnet and/or shunt members which may allow such path members to be at least temporarily magnetized and to have preset minimal strengths, where examples of such strengths may be at least, e.g., 5 mG, 10 mG, 20 mG, 30 mG, 40 mG, 50 mG, 75 mG, 100 mG, 200 mG, 300 mG, 400 mG, 500 mG, 600 mG, 700 mG, 800mG, 900 mG, 1 G, 2 G, 3 G, 4 G, 5 G, 10 G, and so on. Although selection of a specific minimal strength may depend upon, e.g., strengths of the extrinsic and/or secondary MFs and MWs, desired extent of removing the MFs and MWs, and the like, the magnetic field strength of about 500 mG may generally suffice. It is appreciated that those above strengths generally refer to the strengths measured at exterior surfaces of such path members and, therefore, that the strength of the magnet member may have to be greater than these preset minimal strengths of the path members.

In a third example, such path members may also serve to repel the above extrinsic, secondary, and/or intrinsic MFs and MWs by being temporarily magnetized by the MF generated by and/or leaking from the above magnet and/or shunt members. It is to be understood that the MFs and MWs of the EW waves oscillate while changing their directions and, accordingly, that a MF of the path member which may attract a portion of such MFs and MWs of the EM waves may have to repel an opposite portion of the EM waves. In general, repulsion of such MFs and MWs are not favorable, for such MFs and MWs may propagate toward the target and inflict damages thereon. Therefore, provisions may have to be made to guide such an opposite portion of the MFs and MWs toward another path member which may define a MF which is in an identical or similar direction as the opposite portion of the MFs and MWs.

In a fourth example, the path members may serve to reflect such extrinsic, secondary, and/or intrinsic MFs and MWs without necessarily being temporarily magnetized by the magnet and/or shunt members. It is appreciated that reflective characteristics of the path members may be determined by their physical properties such as, e.g., reflective index, and that such path members may then have to exhibit at least a minimal reflective index in addition to a fairly high magnetic permeability. Similar to the above repulsion, reflection of such MFs and MWs may not be favorable, for such MFs and MWs may propagate toward the target and inflict damages thereon. Therefore, provisions may have to be made to guide the reflected MFs and MWs toward the path members which may absorb and accumulate the MFs and MWs therein. The reflective path member may be useful when the magnet member may have to be provided in a location far from a major portion of the path member or may be substantially smaller than the path member. In these cases, the path member may be utilized to concentrate such MFs and MWs to a region of the path member closer to the magnet member, thereby facilitating more portions of the MFs and MWs to propagate to the magnet member and eliminated therein.

The above second role of the path members is worth while to be described in greater detail. It is first to be understood that conventional magnetically permeable articles are suggested to enclose or cover an entire portion of a target, for even a small gap in a junction or seam may jeopardize effective magnetic shielding thereof. Such a disadvantage may be explained by the very fact that the MFs and MWs accumulated inside the permeable article are bound to propagate in any direction as far as such a direction may coincide with a direction to a magnet pole having an opposite polarity. In other words, conventional magnetic shielding has to require the entire portion of the target to be enclosed within or covered by the permeable articles without forming any gap so as to minimize the chance of such MFs and MWs from penetrating the permeable articles to the target. Accordingly, such permeable articles may not define any opening thereacross without seriously jeopardizing its capability. Contrary to the conventional magnetic shielding, the path member of this invention may be temporarily magnetized and, therefore, allowed to attract such MFs and MWs which may propagate along collision courses as well as the MFs and MWs which may not propagate along such collision courses. That is, because of the temporary MF of the path member, some MFs and MWs which may not impinge upon the path member may be attracted toward and impinge upon the path member. Conversely speaking, such attraction of the MFs and MWs may allow the path member of the present invention to define some openings and/or void areas without degrading its performance, as far as magnetic strengths of the temporary MF may be strong enough to attract the MFs and MWs which may have passed through the openings or areas onto a skeleton, matrix or thread of the path member. Accordingly, such path members which may be temporarily magnetized may collect more MFs and MWs than those which may have the same shapes and sizes but which may not be magnetized. It is to be understood that such path members or at least temporarily magnetized portions thereof may be made of and/or include materials with less magnetic permeability than the rest of the path members in order to emanate the MF lines therefrom rather than confining such lines therein. It then follows that the secondary MF around the temporarily magnetized path member may be manipulated through, e.g., varying the magnetic permeability of different portions of the path member, varying such permeabilities of each of multiple path members, varying dimensions of different portions of the path member, varying such dimensions of each of multiple path members, and the like.

In addition, the path members which may be temporarily magnetized may form openings or void areas thereon, thereby providing ventilation or air flow therethrough, to improve visibility therethrough, and the like. It also follows that the temporarily magnetized path member of the present invention may still absorb and accumulate more or at least equivalent amounts of the MFs and MWs therein than the conventional permeable article having the same shape and/or size even when the path member of this invention may be made of and/or include materials defining less magnetic permeabilities. Accordingly, while maintaining better or at least equivalent efficiency in absorbing and/or accumulating the MFs and MWs therein, such a path member may be fabricated to be porous, to be at least partly transparent, to be incorporated into a transparent medium or to otherwise provide see-through capability. Because of its improved efficiency, the path member of this invention may not have to be made of or include the materials with the highest magnetic permeability, thereby reducing cost of raw materials.

Such openings have been exemplified in FIGS. 5I to 5P, but may also be provided in other path members of FIGS. 4A through 5H as well as FIGS. 6A through 8H. Such openings may define various shapes and sizes, where a single path member may include multiple openings of the same or different shapes and/or sizes. Such openings may be distributed uniformly across at least a portion of the path member or may be disposed in different pattern, arrangement, density, and the like. In addition, such openings may be provided at a preset ratio of a total area of the openings to a total area of the rest of the path member such as its skeleton, matrix or thread, where examples of such ratios may be in the range of about thousands, hundreds, tens, and less or, more specifically, 4,000, 3,000, 2,000, 1,000, 800, 600, 400, 200, 100, 80, 60, 40, 20, 10, 8, 6, 4, 2, 1.0, 0.8, 0.6, 0.4, 0.2, 0.1, 0.08, 0.06, 0.04, 0.02, and the like, as long as the skeleton, matrix or thread of the path member may effectively absorb and accumulate the MFs and MWs therein. Such ratios may be determined by various factors examples of which may also include, but not be limited to, magnetic permeabilities of the path and/or shunt member, dimensions of the openings and those of the rest of the path member, strength of the magnet member, coupling characteristics between the path member and magnet or shunt members, a desired extent of removing such MFs and MWs, and so on. For example, more openings may be formed or greater area ratios may be attained while accumulating the same amount of such MFs and MWs in the path member as the path member exhibits higher magnetic permeability, as the magnet member generates stronger MF lines, as the path member more securely couples with the magnet and/or shunt members, and the like. Accordingly, selection of such a ratio is generally a matter of choice of one of ordinary skill in the relevant art.

The path member defining the above openings (to be referred to as the “porous” path member hereinafter) may be used in conjunction with at least one another path member which may or may not define such openings thereacross in order to enhance various performances of the magnet-shunted systems. For example, the porous path member may be disposed over another porous or nonporous path member and the magnet member is coupled to both path members while temporarily magnetizing both of the path members in such a manner that the path members may generate the temporary MFs propagating in different or opposite directions. Therefore, a portion of the MFs and MWs propagating in one direction may be absorbed by the upper porous path member, while the remaining portion of the MFs and MWs may be repelled by the upper porous path member, may propagate to the lower porous or nonporous path member, and then may be absorbed thereby. In another example, multiple porous path members may be disposed directly one over the other or in a staggered mode in order to provide a see-through configuration. Depending upon the above factors, some areas of the path member may be covered by the openings of different path members, thereby enhancing the visibility therethrough. In another example, such porous path members may be stacked in any mode while providing air flow or ventilation therethrough.

Another advantage of the temporary magnetization of the path member may be that this path member may be fabricated to be smaller or thinner than its conventional counterpart such as the non-magnetized permeable articles. Whether porous or not, the path member of the present invention with a preset thickness and/or height will be able to absorb and to accumulate more MFs and MWs than the conventional permeable article with a comparable height and/or thickness. Considering current trend toward higher output electric devices, such a path member will, therefore, be able to more effectively guard the target from the extrinsic and secondary MFs and MWs. Whether porous or not, such a path member of this invention capable of absorbing and accumulating a preset amount of the MFs and MWs will also require a less thickness or height, less length or width or less characteristic dimensions than the conventional permeable article capable of absorbing and accumulating a comparable amount of the MFs and MWs. Considering current trend toward more compact electric devices, the path member of this invention may not suffer from space limitations.

Whether porous or not, at least two of the above path members may be disposed one over the other with or without being intervened by a gap or filler. In the alternative, such path members may be disposed one over the other while being separated by a gap of a preset dimension, where such a gap may be filled by the filler. The first embodiment may generally be preferred when the magnet-shunted system may have to be incorporated into a tight space, whereas the second embodiment may instead be preferred when at least two path members may define the MFs running in different directions.

Instead of the above path members at least portions of which may be temporarily magnetized, at least a portion of such a path member may be arranged to be permanently magnetized, to include a permanent magnet and/or electromagnet. Such a portion of the path member may then serve as or, in the alternative, replace the magnet member so that the extrinsic and/or secondary MFs and MWs may propagate thereto and may be eliminated thereat. Such a portion of the path member, therefore, may have the magnetic strength which may be greater than, equal to or less than static that of the Earth. When desirable, at least a substantial portion or entire portion of the path member may be permanently magnetized and/or enclosed or covered by the shunt member. Conversely, the magnet member may be coupled to the path member but arranged to not temporarily magnetize such a path member beyond a preset threshold. Whether or not the path member may include a portion which may be permanently magnetized or may operate as the electromagnet, such a portion may also be enclosed or covered by the shunt member when it is desirable to confine a MF generated by such a portion, where details of such a shunt member have already been disclosed in the co-pending Application.

It is appreciated that the above path assemblies having multiple path members may be viewed as a path member having multiple segments therealong and/or therein. For example, the path members of FIGS. 5A to 5H with multiple segments may be viewed as the path assemblies including multiple path members. Conversely, each of the path assemblies of FIGS. 7A to 7P may be viewed as a single path member defining multiple segments which may form a contiguous article.

As briefly described above, the temporarily and/or permanently magnetized path members may be arranged to define an unipolar MF, i.e., the MF generating the MF lines from one to an opposing end thereof. Alternatively, the path members may be arranged to define bipolar MFs, i.e., the MFs forming the MF lines in different directions at least two of which may attract or repel each other. Similarly, the path assemblies may be arranged to define unidirectional, bidirectional or multidirectional MF lines.

In addition to be magnetically permeable, the path members may be arranged to define various electrical properties over a wide range. In one example, such a path member may be arranged to be electrically conductive or to include an electric conductor therein. This embodiment may be beneficial in attracting the EFs and EWs of the extrinsic and secondary EM waves in addition to their MFs and MWs. In another example, the path member may instead be arranged to be electrically insulative or, in the alternative, to be embedded into, mixed with or enclosed in an electrically insulative base. Such an insulator may prevent or suppress electromagnetic induction of electric current in such a path member and, therefore, prevent generation of MFs opposing the intrinsic MFs of the magnet member coupling with the path member. Therefore, such an embodiment may prove beneficial in preventing the magnet member from losing its magnetic property. As a compromise, the path member may be made of and/or include semiconductive materials examples of which may include, but not be limited to, silicon, carbon, germanium, and various compounds thereof. By fabricating the path members with less thicknesses, magnetically isolating the magnet member from the MFs generated by the path member or protective means, the semiconductive path member may absorb some of the EFs and EWs of the extrinsic and secondary EM waves while ensuring the magnet member to maintain its magnetic property.

When desirable, at least a portion of the path member may be electrically conductive such that the path member may not only absorb the MFs and MWs of the EM waves but also absorb the EFs and EWs thereof. Electric currents generated by the absorbed EFs and EWs may then be used for other purposes, e.g., to operate the electromagnet of the magnet-shunted system.

In another aspect of the present invention, such magnet-shunted systems may include various magnet members each of which may in turn include at least one permanent magnet and/or at least one electromagnet. Various magnet members having one or more permanent magnets have already been disclosed in the co-pending Application. Therefore, the present invention will describe details of such a magnet member which may include at least one electromagnet. It is appreciated that such a magnet member may optionally include one or more permanent magnet which may or may not be magnetically coupled to the electromagnet.

In one exemplary embodiment of such an aspect of this invention, a magnet member may have at least one conventional electromagnet which is characterized by multiple coils of conductive wire. Accordingly, such an electromagnet may be one or more loops of conductive wire and may optionally be fabricated as solenoids or toroids which may or may not include ferromagnetic materials therein. Similar to the permanent magnets of the co-pending Application, at least a portion or an entire portion of the electromagnet may be enclosed or covered by the shunt member so as to contain or suppress the intrinsic MF generated by the electromagnet within a preset distance and/or so as to maintain such strengths of the intrinsic MF measured at the exterior surface of the shunt member and/or at a preset distance therefrom within a preset threshold. In addition, such an electromagnet may be magnetically coupled to the path member and may optionally magnetize at least a portion of the path member when the electromagnet is turned on, i.e., electric current flows in the wire and the electromagnet forms the intrinsic MF therearound. In this aspect, the electromagnet is deemed to be an essential component of the magnet-shunted system. It is appreciated that the electromagnet of this embodiment may not have to have the conventional configuration, i.e., the solenoids or toroids. Accordingly, any one or multiple loops of conductive substances of the magnet-shunted system may be utilized as the electromagnet within the scope of the present invention. For example, when a portion of the path member or other parts of the system happens to be also electrically conductive and may generate a MF therearound in response to electric current flowing therein, such a portion may serve as the electromagnet of such a magnet-shunted system. Therefore, such a portion may or may not be enclosed by the shunt member depending upon whether or not to contain such intrinsic MF near such a portion of the path member or other parts of the system. In general, the magnet-shunted system may include a power source such as, e.g., a current source, battery, and/or solar cell in order to operate such an electromagnet. When feasible, any electric current induced in the conductive portion of the system may be used as such a power source of the electromagnet.

In another exemplary embodiment of this aspect of the present invention, the magnet-shunted system may not include any electromagnet at all. Instead, the system may be arranged to operatively couple with an electromagnet of an electric device and to utilize the electromagnet as the termination point or sink of the extrinsic and/or secondary MFs and MWs. Such a system may be characterized by its path member which may be arranged to magnetically couple with such an electromagnet so that the MFs and MWs absorbed and accumulated in the path member may be guided therethrough toward such an electromagnet and eliminated thereat. It is appreciated in a related embodiment that, when the electrical device happens to include a permanent magnet, the magnet-shunted system may similarly be arranged to use such a magnet as the magnet member thereof, with or without enclosing or covering the magnet of the device by the shunt member of the system. Such an electromagnet is to operate by an energy source of the device and, therefore, the system may not have to include a separate power source for such an electromagnet. However, the system may include a power source which may be able to supplement the power source of the device and may replace the latter when such runs out of energy. When desirable, electric current which is induced by the MFs and MWs in the wiring, circuit or component of the system may be utilized to operate the electromagnet or to supplement the energy source of such an electromagnet of the device.

In another exemplary embodiment of this aspect of the present invention, the magnet-shunted magnet member may not include any electromagnet at all and may also be used in conjunction with an electric device which may not include any electromagnet per se. In one example, the path member of such a system may couple, however, with any wiring, circuit or component of the device which may generate therearound at least a weak MF so that the MFs and MWs absorbed and accumulated in the path member may be guided thereto and eliminated thereat. In another example, the magnet-shunted system may include a wiring, circuit or component which may then be electrically coupled to a wiring, circuit or component of the device and generate a weak or moderate MF so that the MFs and MWs absorbed and accumulated in the path member may be guided thereto and eliminated thereat. Thus, it is to be understood that exact configuration of such wiring, circuit or component may not be material within the scope of the present invention as long as they may be able to generate the MF therearound and the extrinsic and/or secondary MFs and MWs may be terminated thereat. Such a wiring, circuit or component of the device is to carry electric current provided by the device itself and, therefore, such a system may not have to include a separate power source for such a pseudo-electromagnet. Such a system, however, may include a power source which may be able to supplement the power source of the device and may replace the latter when such may run out of energy. When desirable, electric current induced by the MFs and MWs along the wiring, circuit or component of the system may also be used to operate the pseudo-electromagnet or to supplement the power source of the device.

When the electric current induced by the extrinsic and/or secondary MFs and MWs are used to operate the electromagnet as described in the last two embodiments, the induced electric current may need to be rectified and/or other wise manipulated to simulate a DC current. Such an embodiment may be beneficial in preventing the electromagnet from emitting its own EM waves to the target.

The foregoing wiring, circuit, and/or component of the device may have various configurations such as, e.g., wire, loop, coil, plate, screen, mesh, foam, and the like. As long as the electric current may flow therethrough and the MF may be generated around a portion of the device by itself and/or in conjunction with a matching wiring, circuit or component of the system, such a portion is to qualify as the pseudo-electromagnet within the scope of the present invention.

The above electromagnet may also be arranged to operate and generate the MF therearound constantly or, in the alternative, only when the electric device is on. The former embodiment may be beneficial in preventing the extrinsic MFs and MWs from interfering with the normal operation of such a device, whereas the latter embodiment may be beneficial in minimizing the secondary MFs and MWs generated by the device.

In another aspect of the present invention, such magnet-shunted systems may include various shunt members which may be arranged to enclose and/or to cover at least a portion of the permanent magnet and/or electromagnet of the magnet member. Various shunt members which may include one or more bodies have already been disclosed in the co-pending Application. Accordingly, the present invention will describe further details and/or variations of such shunt members.

In one exemplary embodiment of such an aspect of this invention, at least a portion of a shunt member may be arranged to generate secondary MFs therearound and to better attract the extrinsic MFs and MWs thereto or to the magnet member therethrough. Characteristics of such a portion of the shunt member may be generally similar or identical to those portions of the path members which may also be temporarily magnetized directly by the magnet member or indirectly thereby through the shunt member. It is to be understood that such a shunt member or at least a temporarily magnetized portion thereof may be made of and/or include materials which may define less magnetic permeability than the rest of the shunt member so that the intrinsic MFs may penetrate such a portion of the shunt member rather than being confined therein, thereby generating MFs similar to the secondary MFs generated by the temporarily or permanently magnetized path member. It follows that the intrinsic or secondary MFs around the temporarily magnetized shunt member and/or temporarily magnetized portion thereof may be manipulated by, e.g., changing the magnetic permeability of different portions of the shunt member, varying the permeabilities of each of multiple shunt members, varying dimensions of different portions of the shunt member, varying the dimensions of each of multiple shunt members, and so on. Such an embodiment may be generally beneficial when the magnet-shunted system of this invention is intended to protect a target from the MFs and MWs emanating from an extrinsic source.

In an opposite exemplary embodiment of such an aspect of the invention, a shunt member may instead be arranged to prevent or at least minimize leakage of the intrinsic MFs of the magnet member therethrough. Such a shunt member may have various configurations as described in the co-pending Application, e.g., enclosing at least a portion or entire portion of the magnet member by an identical or different thicknesses, exhibiting uniform or varying magnetic permeabilities therealong, forming various contours in at least portions thereof, defining staggered configurations to allow coupling with the path member, and the like.

In another exemplary embodiment of this aspect of the present invention, the magnet-shunted system may not include any shunt member at all. Instead, the system may be arranged to operatively couple with a magnetically permeable part of an electric device and to utilize such a part as the shunt for absorbing and accumulating the intrinsic MFs. Such a system may be characterized by its magnet member which may be arranged to magnetically couple with the magnetically permeable part such that the intrinsic MFs from the magnet member may be accumulated and confined within such a part of the device. Depending upon intended use of the system, such a permeable part may be selected to cover or enclose only an intended portion or entire portion of the magnet member. It is to be understood that an intended role of such a magnetically permeable part of the device may not be material to the scope of this invention as long as such a part may absorb and accumulate a preset amount of the MFs and MWs. Therefore, such a part may be incorporated into the device to absorb and accumulate the MFs and MWs therein, to operate as a portion of a device circuit, and the like. In addition, an exact shape and/or size of such a part may not be material either within the scope of the present invention so that such a part may be fabricated as, e.g., a casing of the device, a divider or partition inside the device, a support of the part, and the like. Such a part may also have various shapes such as, e.g., a planar or curved sheet or slab, a wire, fiber or filament, a coil or loop, a screen or mesh, a foam or sponge, and other shapes as described in the co-pending Applications.

In another exemplary embodiment of such an aspect of the present invention, at least a portion of the shunt member may be permanently magnetized, may be replaced by a permanent magnet, may include and/or operate as an electromagnet, and the like, so that such a portion may also define a MF around the shunt member. In this context, such a portion of the shunt member may be regarded as a portion of the magnet member exposed on its exterior surface. Such a portion may also be defined on an exterior or interior surface of the shunt member, between or across such surfaces, on an edge or in an interior of the shunt member, and the like. Configurational and/or operational characteristics of such a portion, permanent magnet, and electromagnet of the shunt member may be similar or identical to those of the magnet and/or path members as described above.

When desirable, at least a portion of the shunt member may be electrically conductive so that the shunt member may not only absorb the MFs and MWs of the EM waves but also absorb the EFs and EWs thereof. Electric currents generated by the absorbed EFs and EWs may then be utilized for other purposes, e.g., to operate the electromagnet of the magnet-shunted system.

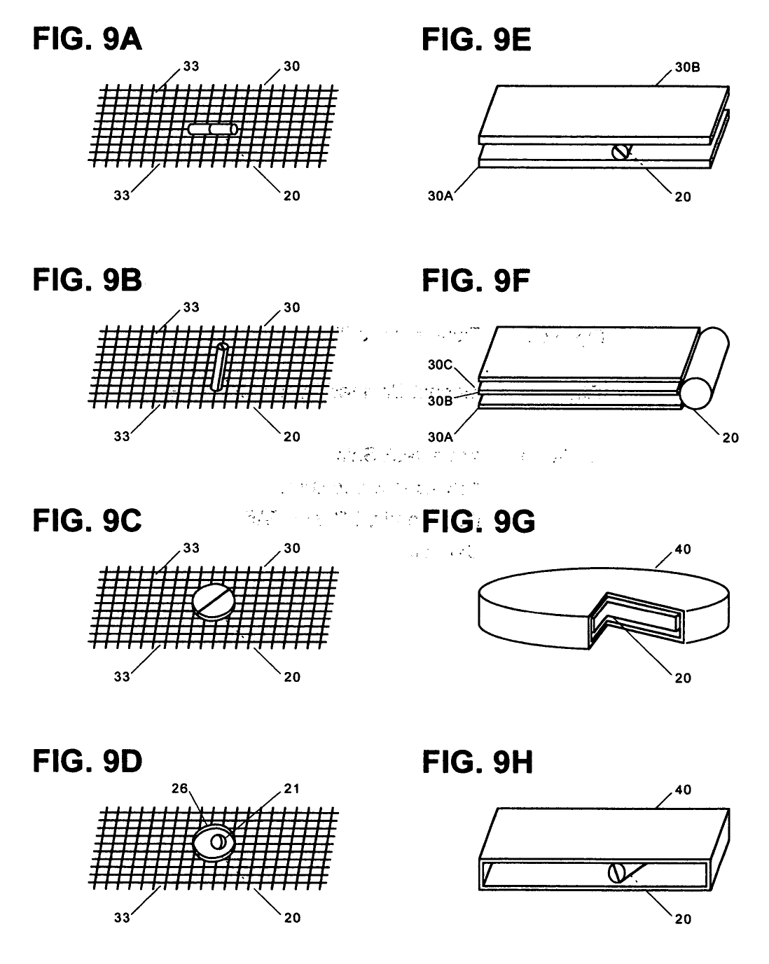

In another aspect of the present invention, the above members of the magnet-shunted system may be arranged to translate, rotate, and/or otherwise move and to prevent permanent magnetization of the path member into a fixed pole distribution. It is appreciated that the path and shunt members of the system are made of and/or include the magnetically permeable material and that such materials are prone to permanently align their domains along the MFs applied thereto. Accordingly, coupling the path and/or shunt members to specific poles of the magnet member may tend to permanently magnetize the path and/or shunt members in the direction of the intrinsic MFs of the magnet member, which may not be favorable in attracting and absorbing those portions of the extrinsic and secondary MFs and MWs propagating in opposite or transverse directions. In addition, the path and shunt members may begin to generate the secondary MFs therearound instead of absorbing and accumulating the MFs and MWs as these members become permanently magnetized. Accordingly, when it is desirable to prevent the path and/or shunt members from generating the MFs therearound, at least one of the above magnet, path, and shunt members may translate, rotate or otherwise move to prevent or at least minimize such permanent magnetization of the path and/or shunt members. Following FIGS. 9A to 9H describe some exemplary embodiments intended to prevent or at least minimize such permanent magnetization of the path and/or shunt members. It is appreciated that any of these embodiments are equally applicable to any of the foregoing path members described herein and disclosed in the co-pending Application. It is also appreciated that any of such embodiments are equally applicable to the shunt members disclosed herein and described in the co-pending Application. Therefore, when any of those path and/or shunt members have different configurations, the following embodiments may be slightly modified in order to accommodate such configurations.

In one exemplary embodiment of this aspect of the present invention, such a shunted-magnet system may include at least one magnet member which may translate, rotate, and/or otherwise move over, below or along a path member while coupling the path member with opposite poles. FIG. 9A is a perspective view of an exemplary magnet member 20 translating across different positions of a path member 30 and contacting the path member 30 with the same pole according to the present invention. The path member 30 has a shape of a screen or mesh defining multiple openings 33 thereon similar to those of FIGS. 5I to 5P and 6Q to 6X, while the magnet member 20 has a shape of a cylindrical bar and defines opposite poles in its opposing ends. The magnet member 20 may be arranged to move over or below an exterior surface of the path member 30, thereby temporarily magnetizing different portions of the path member 30 into different polarities. It is appreciated that, because the magnet member 20 defines different poles In their ends, translation, rotation, and/or rolling of the magnet member 20 over or below the path member 30 may accomplish an identical or at least substantially similar results such as, e.g., temporarily magnetizing some portions of the path member 30 into the N polarity, while other portions into the S polarity.

In another exemplary embodiment of such an aspect of the invention, such a shunted-magnet system may include at least one magnet member which may translate, rotate, and/or otherwise move over, below or along a path member while coupling the path member with the same pole. FIG. 9B is a perspective view of another exemplary magnet member 20 moving along different positions of a path member 30 while contacting the path member 30 with a single pole according to the present invention. The path member 30 is similar to that of FIG. 9A, and the magnet member 20 defines the shape similar to that of FIG. 9A but defines opposite poles across its longitudinal axis. Accordingly, at least portions of the path member 30 close to the magnet member 20 are temporarily magnetized into a single polarity depending upon which portion of the magnet member 20 couples with the path member 30. Contrary to the magnet member of FIG. 9A which couples with the path member through its opposite poles, the magnet member 20 of this embodiment may be coupled to the path member 30 by a single pole. It is to be understood that the path member 30 may be magnetized into one polarity when the magnet member 20 may translate or rotate while contacting the path member 30 with one side or, in the alternative, into different opposite polarities alternatingly when the magnet member 20 may rotate or roll over or below the path member 30. Other configurational and/or operational characteristics of such members of FIG. 9B are similar or identical to those of the members of FIG. 9A.

In another exemplary embodiment of such an aspect of the invention, such a shunted-magnet system may include at least one magnet member which may rotate about a center of rotation provided in a path member. FIG. 9C is a perspective view of an exemplary magnet member 20 rotating above or below a fixed position of a path member 30 while contacting the path member 30 with a single pole or opposite poles according to the present invention. Such a path member 30 is similar to that of FIG. 9A, while the magnet member 20 is arranged to rotate around a center of location (not shown in the figure but defined on the path member 30 below a center of the magnet member 20) which may be defined on an edge or in an interior of the path member 30. The magnet member 20 may be arranged to couple its opposite poles with the path member 30 and, therefore, to temporarily magnetize different portions of the path member 30 with different polarities as it rotates about the center of rotation. The magnet member 30 may also be arranged to translate over or below the path member 30 in addition to rotation about the center of rotation. Further configurational and/or operational characteristics of the members of FIG. 9C are similar or identical to those of the members of FIGS. 9A and 9B.

In another exemplary embodiment of such an aspect of the invention, such a shunted-magnet system may include at least one magnet member which may translate, rotate, and/or otherwise move within a housing disposed over, below or along a path member. FIG. 9D shows a perspective view of an exemplary magnet member 20 moving within a housing 26 while changing its orientation as well as position while indirectly contacting a path member 30 with the same or different poles according to the present invention. The path member 30 is generally similar to that of FIG. 9A, and the magnet member 20 defines a housing 26 and at least one magnet 21, where the housing 26 may be generally made of and/or include at least one magnetically permeable material and fixedly or releasably coupling with the path member 30 and where the magnet 21 may be movably disposed inside the housing 26 and move within the housing 26 while coupling with the housing 26 and path member 30 with a single or multiple poles thereof. The housing 26 may have any arbitrary shapes and/or sizes as long as the magnet 21 of the magnet member 20 may translate, rotate, roll or otherwise move within or while being guided by the housing 26. Accordingly, at least a portion of the path member 30 may be temporarily magnetized depending upon the exact position of the magnet 21 of the magnet member 20 inside the housing 26, orientation of such poles of the magnet 21, magnetic properties of the housing 25, and the like. Other configurational and/or operational characteristics of the members of FIG. 9D are similar or identical to those of the members of FIGS. 9A to 9C.

In another exemplary embodiment of such an aspect of the invention, such a shunted-magnet system may include at least one magnet member which may translate, rotate, and/or otherwise move between path members. FIG. 9E is a perspective view of an exemplary magnet member 20 disposed between two path members 30A, 30B and changing its orientation and/or position while coupling with the path members 30A, 30B by different poles according to the present invention. The path members 30A, 30B have generally curvilinear planar shapes and disposed parallel to each other, where such path members 30A, 30B may define openings and/or couplers thereon described herein. The magnet member 20 has a shape of a cylinder and defines opposite poles along a longitudinal direction. Such a magnet member 20 may then temporarily magnetize coupling portions of the path members 30A, 30B in different polarities. In addition, the magnet member 30 may be arranged to rotate or roll between the path members 30A, 30B which may in turn translate or rotate in opposite directions. Accordingly, the portions of the path members 30A, 30B which may couple with the rotating or rolling magnet member 20 may be temporarily magnetized in different polarities alternatingly as the magnet member 20 rotates or rolls therebetween. Other configurational and/or operational characteristics of the members of FIG. 9D are similar or identical to those of the members of FIGS. 9A to 9D.

In another exemplary embodiment of such an aspect of the invention, such a shunted-magnet system may include at least one magnet member which may translate, rotate or otherwise move along an edge of at least one path member. FIG. 9F is a perspective view of an exemplary magnet member 20 changing its orientation and/or position while coupling with multiple path members 30A-30C with its single or different poles according to the present invention. The path members 30A-30C are similar to those of FIG. 9E, while the magnet member 20 is arranged to be disposed along and couple with ends of such path members 30A-30C. Accordingly, at least portions of the path members 30A-30C may be temporarily magnetized depending upon pole distribution of the magnet member 20. In addition, such a magnet member 20 and/or path members 30A-30C may be arranged to move vertically or horizontally along edges of the path members 30A-30C and/or to rotate while maintaining magnetic coupling with such edges. Accordingly, the portions of the path members 30A-30C coupling with such a rotating or rolling magnet member 20 may be temporarily magnetized in different polarities in an alternating mode. Other configurational and/or operational characteristics of the members of FIG. 9F are typically similar or identical to those of the members of FIGS. 9A to 9E.

In another exemplary embodiment of such an aspect of the invention, such a shunted-magnet system may include at least one magnet member which may translate, rotate, and/or otherwise move within or inside at least a portion of a shunt member. FIG. 9G is a perspective view of an exemplary magnet member 20 changing its orientation and/or position while coupling with a shunt member 40 by a single or different poles according to the present invention. As described herein, the shunt member 40 has a shape of an annular cylinder in which a cylindrical magnet member 20 may be disposed. The magnet member 20 is also arranged to rotate within the shunt member 40 so that poles of the magnet member 20 may couple with different portions of the shunt member 40 as the magnet member 20 may rotate therein. When the magnet member 20 has the opposite poles in layers, e.g., an upper portion of the shunt member 40 always couples with one pole of the magnet member 20 regardless of whether or not the magnet member 20 may rotate. Accordingly, such a magnet member 20 is arranged to have each of the opposite poles in a right half and a left half thereof so that rotation of the magnet member 20 may alternatingly couple the different poles of the magnet member 20 with different portions of the shunt member 40. Other configurational and/or operational characteristics of the members of FIG. 9G are similar or identical to those of the members of FIGS. 9A to 9F.

In another exemplary embodiment of such an aspect of the invention, such a magnet-shunted system may include at least one magnet member which may translate, rotate, and/or otherwise move inside a shunt member which is greater than the magnet member. FIG. 9H is a perspective view of an exemplary magnet member 20 which varies its orientation and/or position while coupling with a shunt member 40 with different poles according to the present invention. The shunt member 40 is generally similar to that of FIG. 9G but is preferably arranged to be longer, wider, and/or higher than the magnet member 20 in order to allow the magnet member 20 to translate, rotate or otherwise move therein. In this context, this oversized shunt member 40 may be viewed as a housing similar to that of FIG. 9D. Therefore, the magnet member 20 may couple with any portion of the shunt member 40 with any of its poles depending upon, e,g., position of the magnet-shunted system, movement of the system, and the like, while temporarily magnetizing different portions of the shunt member 40 with different polarities. Other configurational and/or operational characteristics of the members shown in FIG. 9D are similar or identical to those of the members of FIGS. 9A to 9G.

Configurational and/or operational variations and/or modifications of the above embodiments of the exemplary systems and various members thereof described in FIGS. 9A through 9H also fall within the scope of the present invention.

As described hereinabove, permanent magnetization of such path and/or shunt members may be avoided or at least minimized by moving at least one of the magnet, path, and shunt members with respect to the others so that those temporarily magnetized portions of the path and/or shunt members may be coupled not to a single pole but to different poles of the magnet member. Such movements of the magnet, path, and/or shunt members may also prevent or at least minimize saturation of the path or shunt members by eliminating the MFs and MWs accumulated therein. In one example, the movements may be actuated manually by an user such that he or she may translate, rotate or otherwise move the magnet member at his or her will. In another example, the magnet-shunted system may include a timer which may monitor a period of temporary coupling between the magnet member and the path and/or shunt members and then moves at least one of the magnet, path, and shunt members in each preset period. In another example, the magnet-shunted system may have a sensor which may be arranged to monitor an extent of permanent magnetization of such a coupling portion of the path and/or shunt members and to move at least one of the magnet, path, and shunt members.

When the magnet member includes an electromagnet, the permanent magnetization of coupling portions of the path and/or shunt members may be easily prevented or minimized by varying directions of the electric current therethrough so that the electromagnet may form opposite polarities in response thereto. In the alternative, such an electromagnet may similarly translated, rotated or otherwise moved manually, periodically by the timer, automatically by the sensor, and the like.

As described hereinabove, the magnet member may have any number of magnets which may in turn define any number of poles in any arrangements. Such movements of the magnet, path, and/or shunt members may also be determined accordingly. For example, an angle of such movement of the magnet member may be determined whether the poles are defined axially or radially, a displacement of the movement may be determined by a distance between the poles of the magnet member, and so on

Configurational and/or operational variations and/or modifications of the above embodiments of the exemplary systems and various members thereof described in FIGS. 4A through 9H also fall within the scope of the present invention.

As described herein, at least portions of the path and/or shunt members may be permanently magnetized in order to generate the MFs therearound, which may increase an efficiency of attracting and accumulating the extrinsic and secondary MFs and MWs therein. In this context, such portions of the path and/or shunt members may be viewed as a portion of the magnet member which is extended from the magnet member or exposed through the path and/or shunt members.

When the path member may define multiple segments, the magnet member may be disposed in a center, along an edge, and/or on a border of at least one of such segments. At least two of those segments may also be arranged to define identical or different shapes and/or sizes. Such segments may further exhibit the same or different magnetic permeabilities, saturation, and the like. In addition, at least two of the segments may couple with the same or different number of magnets and/or magnet members, with the same or different number of poles with the same or different polarities, and the like. When desirable, at least one of the segments may be arranged to not directly couple with the magnet member. In addition, at least one segment may be arranged to couple with multiple magnet members or multiple poles of a single magnet member. Such segments may also be defined contiguously along an unitary article, demarcated by the filler or magnet member, and the like. It is appreciated that the path assembly including multiple path members may be similarly treated as the path member having multiple segments such that that each path member of such an assembly may be regarded as each segment of such a member.

Various path members of the present invention may be characterized to have larger or wider areas than the magnet members in order to maximize their efficiency of attracting and/or accumulating as much MFs and MWs as possible. For example, the path member of this invention may be arranged to define a cross-section area which may be greater than another cross-sectional area of the magnet member, where such areas are to be defined on the surfaces onto which the extrinsic MFs and MWs impinge and where a ratio of the area of the path member to that of the magnet member may be equal to or greater than, e.g., 2,000, 1,000, 500, 300, 200, 100, 90, 80, 70, 60, 50, 40, 30, 25, 20, 15, 10, 5, 1, 0.5. 0.1, and the like.

The path members defining the elongated, fiber or strand structures of FIGS. 6A to 6H may be arranged to have various cross-sections which may be uniform therealong or may vary along its axial and/or transaxial directions. Such path members may be provided by an article defining preset length or as a spool of the fiber or strand. In addition, the path members having the interwoven structure of FIGS. 6G and 6H may include two or more strands where such strands may be disposed parallel to each other or woven in a conventional fashion. Such path members may also couple with the magnet member or may be coupled thereto after such path members may be woven or otherwise arranged into another article.

It is appreciated that multiple magnet members may also be incorporated into the path member according to a preset pattern such that cutaway portions of the path member may include at least one magnet member therein. For example, the path member having the shape of a curvilinear planar sheet may include a strip-shaped magnet member along its length such that any portion of the path member cut in a direction transverse to the length may include at least a minimal length of the magnet member. In another example, the path member defining multiple openings thereon may include multiple beads of magnet members which may be incorporated into strategic locations of the path member in a repeated manner such that any cutaway portion of the path member may include at least one magnet member therein. Other examples have been provided in the co-pending Application.

It is also appreciated that the magnet-shunted system of the present invention may not include any shunt member. More specifically, as long as the strength of the magnet member measured on its exterior surface may be less than, e.g., ten times of the static MFs of the Earth (or 5 G), it may not be necessary to confine the intrinsic MFs generated by the magnet member by such a shunt member. In particular, when multiple small magnet members which generate only weak MFs are incorporated into the strategic positions of the path member, such magnet members may not have to be enclosed by the shunt members or their equivalents. In addition, when such strategic locations of the path member are permanently magnetized, there may not be any need to shunt such magnetized locations by permeable materials as far as the strengths of such locations may be within the above range. When the magnet members with weak strengths may be incorporated proximate to the delicate devices or instruments, however, such magnet members or magnetized portions may also be enclosed by the shunt members or other magnetically permeable materials.

Unless otherwise specified, various features of one embodiment of one aspect of the present invention may apply interchangeably to other embodiments of the same aspect of this invention and/or embodiments of one or more of other aspects of this invention. Therefore, the system of FIG. 3A may couple with any other path members of FIGS. 4A to 6X as far as such path members may absorb and accumulate the extrinsic and secondary MFs and MWs. In another example, the path member of FIG. 5N may be processed to have a preset contour and then paired to form the path assembly of FIG. 8H. In another example, the coupling mechanism of FIG. 9F may be applied to any of the systems of FIGS. 3A to 3C in order to prevent or at least minimize permanent magnetization of the path members. Other combinations are also possible as long as the resulting magnet-shunted system may accomplish one or more of the above objectives of this invention.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

1. A magnet-shunted system for rerouting extrinsic magnetic fields and waves propagating to a target away therefrom and also for rerouting device magnetic fields and waves generated by one of an electric, electronic, and magnetic device away from said target comprising:
at least one magnet member having at least one of a permanent magnet and an electromagnet each of which is configured to define at least one one N pole and S pole therein; and
at least one path member which is configured to be magnetically permeable, to be magnetically coupled to said magnet member, to absorb thereinto at least one of said extrinsic and device magnetic fields and waves, and to reroute said one of said extrinsic and device magnetic fields and waves to at least one of said poles of said magnet member,
whereby said one of said fields and waves are absorbed by said path member, to be rerouted toward said magnet member, and eliminated by at least one of said poles of said magnet member.

2. The system of claim 1, wherein at least a substantial portion of said path member is configured to exhibit a relative magnetic permeability greater than a preset value.

3. The system of claim 2, wherein said preset value of said relative magnetic permeability is one of 100, 200, 300, 500, 1,000, 2,000, 3,000, 5,000, 10,000, 20,000, 30,000, 50,000, 100,000, 200,000, 300,000, 500,000, and 1,000,000.

4. The system of claim 1, wherein said magnet member is configured to consist of at least one of a plurality of pellets, particles, granules, powders, filings, fibers, filaments, flakes, and fragments each having a dimension ranging from one nanometer to one millimeter.

5. The system of claim 4, wherein said magnet member is configured to define a shape of one of a sphere, an ellipsoid, a cylinder, a filament, a fiber, a flake, a strip, and a slab.

6. The system of claim 1, wherein said path member is configured to form a phase of at least one of a liquid, a gel, and a powder.

7. The system of claim 6, wherein said path member is configured to have shapes of at least one of a sphere, an ellipsoid, a cylinder, a filament, a fiber, a flake, a strip, a sheet, a foil, a slab, a mesh, a screen, a yarn, a filing, and a fabric.

8. The system of claim 6, wherein said magnet and path members are configured to be mixed and to form a mixture which is capable of being in a phase of at least one of a solution, a gel, an emulsion, a suspension, a slurry, and a powder.

9. The system of claim 8, wherein said mixture is configured to be coated over at least a portion of said device.

10. The system of claim 8, wherein said mixture is configured to be fabricated into at least one of a sheet, a foil, a tape, a mesh, and a screen, and to be disposed over at least a portion of said device.

11. The system of claim 8, wherein said magnet member is configured to be greater than said path member, wherein said device is configured to include a casing which defines at least one indentation thereon, wherein said path member is configured to be coated over at least a portion of said casing, and wherein said magnet member is configured to be disposed in said indentation and to magnetically couple with said path member.

12. The system of claim 8 further comprising at least one base, wherein said base is configured to be less magnetically permeable than said path member and to then be incorporated into at least one of said magnet and path members.

13. A magnet-shunted system forming a preset number of portions each of which includes at least one magnetically permeable material for rerouting magnetic fields and waves emitted from a source of electromagnetic waves away from a target comprising:
at least one path member which is configured to define said preset number of said portions, to include said material, and to absorb said magnetic fields and waves thereinto; and
at least one magnet member which is configured to have at least one permanent magnet which is configured to define at least one N pole and S pole thereon, and to magnetically couple with at least two of said portions of said path member,
whereby said at least two of said portions of said path member is configured to be separated away from the rest of said path member while including at least a portion of said magnet member, to receive said magnetic fields and waves from said path member, and to eliminate said magnetic fields and waves in at least one of said poles of said at least a portion of said magnet member.

14. The system of claim 13, wherein at least a portion of said magnet member is also configured to extend along at least one dimension of said path member and to magnetically couple with said at least two of said portions thereof, whereby each of said at least two of said portions of said path member is configured to be separated away from the rest of said path member while including therein at least a portion of said magnet member, to receive said magnetic fields and waves from said path member, and to eliminate said magnetic fields and waves in at least one of said poles of said at least a portion of said magnet member.

15. The system of claim 13 further comprising at least one shunt member which is configured to be magnetically permeable, to enclose at least a portion of said magnet member, and to allow said path member to magnetically couple with said magnet member one of directly and indirectly therethrough.

16. The system of claim 15, wherein said magnet member is configured to generate therearound primary magnetic fields and wherein said shunt member is configured to confine a preset portion of said primary magnetic fields within a preset distance therefrom.

17. The system of claim 13, wherein at least a portion of said path member is configured to include a plurality of openings and wherein a ratio of a total area of said openings to a total area of the rest of said path member is configured to be in the range of about 1,000, 100, 10, and 1.0.

18. The system of claim 13, wherein said members are configured in such a way that a ratio of an area of said path member to an area of said magnet member in each separated portions is configured to be greater than one of about 100, 10, 5, and 1.

19. A method of minimizing permanent magnetization of a magnetically permeable path member for rerouting extrinsic magnetic fields and waves propagating to a target away therefrom comprising the steps of:
disposing at least one magnetically permeable path member between a source of said waves and said target;
magnetically coupling said path member with one polarity of a magnet member;
absorbing said fields and waves with said path member;
rerouting said magnetic fields and waves to one of said poles of said magnet member, thereby eliminating said waves in said magnet member; and
moving at least one of said magnet and path members with respect to the other thereof so as to couple said path member to an opposite pole of said magnet member, thereby preventing said path member from being permanently magnetized into a polarity of said one of said poles.

20. The method of claim 19, wherein said moving comprising at least one of the steps of:
translating said at least one of said members over the other thereof;
pivoting said at least one of said members about the other thereof; and
rotating said at least one of said members around the other thereof.
